(19) United States
(12) Patent Application Publication
(10) Pub. No.: US 2014/0170479 A1
(43) Pub. Date: Jun. 19, 2014

(54) SALINE BATTERY

(71) Applicant: Bill Todorof, Laguna Beach, CA (US)

(72) Inventor: Bill Todorof, Laguna Beach, CA (US)

(21) Appl. No.: 13/842,736

(22) Filed: Mar. 15, 2013

Related U.S. Application Data
(60) Provisional application No. 61/737,256, filed on Dec. 14, 2012.

(51) Int. Cl. H01M 10/36; H01M 4/62; H01M 4/38; H01M 4/36

(52) U.S. Cl. CPC H01M 10/36; H01M 4/366; H01M 4/62; H01M 4/386
USPC 429/199; 29/623.1

(57) ABSTRACT

Saline battery concepts and method of fabrication are disclosed. The battery includes a base structure having electrode alloys. An inter-connective matrix is formed between the electrode alloys. The cathode and anode side are integrated within the base structure to exhibit a voltage pyramid. A high amperage output is configured to have a low gain in resistance and to have a minimized loss across the inter-connective matrix between the electrode alloys to provide a synergistic gain in excess of entropic losses.

### CROSS-REFERENCE TO RELATED APPLICATIONS

This application claims priority under 35 U.S.C. §119 to provisional application Ser. No. 61/449,792 filed Mar. 7, 2011, herein incorporated by reference in its entirety.

### BACKGROUND OF THE INVENTION

Saline batteries have evolved since their inception. Use of new materials and methods of manufacture that can increase energy storage and delivery characteristics and capabilities of electrical storage batteries using saline-based electrolytes are of great interest.

### SUMMARY OF THE INVENTION

Therefore, one object of the disclosure is to provide a saline battery. The battery includes a base structure having electrode alloys. An inter-connective matrix is formed between the electrode alloys. The cathode and anode side are integrated within the base structure to exhibit a voltage pyramid. A high amperage output is configured to have a low gain in resistance and to have a minimized loss across the inter-connective matrix between the electrode alloys to provide a synergistic gain in excess of entropic losses.

According to another object of the disclosure, a method of fabricating a saline battery is disclosed. The method includes providing a base structure having electrode alloys and forming an inter-connective matrix between the electrode alloys. A cathode side and an anode side are integrated within the base structure to exhibit a voltage pyramid. And, by configuring a high amperage output to have a low gain in resistance and to have a minimized loss across the inter-connective matrix between the electrode alloys a synergistic reduction in excess of entropic losses is exhibited.

### BRIEF DESCRIPTION OF THE DRAWINGS

While the specification concludes with claims particularly pointing out and distinctly claiming the invention, it is believed that the various exemplary aspects of the invention will be better understood from the following description taken in conjunction with the accompanying drawings, in which:

FIG. 1 is pictorial representation of a configuration of core types and supporting data in accordance with an illustrative embodiment;

FIG. 2 is a chart representation of a cathode configuration in accordance with a datastrative embodiment of the invention;

FIG. 3 is a chart representation of a anode configuration in accordance with a datastrative embodiment of the invention;

FIG. 4 is a pictorial representation of a battery configuration in accordance with an illustrative embodiment of the invention;

FIG. 5 is a chart representation of various parameters for the battery configuration shown in FIG. 4;

FIG. 6 is another pictorial representation of a battery configuration in accordance with an illustrative embodiment of the invention;

FIG. 7 is another pictorial representation of a battery configuration with supporting data in accordance with an illustrative embodiment of the invention;

FIG. 8 is another pictorial representation of a battery configuration with supporting data in accordance with an illustrative embodiment of the invention;

FIG. 9 is a pair of pictorial representations of an electrode stacking configuration with supporting data in accordance with an illustrative embodiment of the invention;

FIG. 10 is a pictorial representation of an electrode configuration with supporting data in accordance with an illustrative embodiment of the invention;

FIG. 11 is another pictorial representation of an electrode stacking configuration with supporting data in accordance with an illustrative embodiment;

FIGS. 12-13 are pictorial representations of electrode stacking and configurations in accordance with both an illustrative and datastrative embodiment of the invention;

FIGS. 14-15 are pictorial representations of an electrode stacking of a battery according to both illustrative and datastrative embodiments of the invention;

FIGS. 16-17 are pictorial representations presented as top views of cathode electrodes in accordance with an illustrative embodiment;

FIGS. 18-17 are pictorial representations presented as top views of cathode electrodes in accordance with an illustrative embodiment;

FIGS. 18-23 are pictorial representations of both cathode and anodes configurations in accordance with an illustrative embodiment of the invention;

FIGS. 24-28 are pictorial representations of multi-layer cathode and electrode loops in accordance with both illustrative and datastrative embodiments of the invention;

FIGS. 29-31 are pictorial representations of a battery configuration in accordance with both illustrative and datastrative embodiments;

FIG. 32 is a pictorial representation of a gradient coupling layer for both cathodes and electrodes in accordance with an illustrative embodiment;

FIGS. 33-34 are pictorial representations of stacked electrode spiraling in accordance with illustrative and datastrative embodiments of the invention;

FIGS. 35-41 are pictorial representations of stacked electrode configurations in accordance with illustrative and datastrative embodiments of the invention;

FIG. 42 is a datastrative representation of one or more materials of a battery in accordance with an illustrative embodiment;

FIGS. 43-45 are pictorial representations presented as top views of cathode electrodes and a datastrative representation in accordance with an illustrative embodiment;

FIGS. 46-49 are pictorial representations of both cathode and anodes configurations in accordance with an illustrative embodiment of the invention;

FIG. 50 is another pictorial representation of a battery configuration in accordance with an illustrative embodiment of the invention;

FIGS. 51-52 are pictorial representations of parabolic shaped electrodes in accordance with an illustrative embodiment of the invention;

FIGS. 53-68 are pictorial representations of a battery configuration in accordance with both illustrative and datastrative embodiments of the invention;

FIGS. 69-78 are pictorial representations of a battery configuration in accordance with both illustrative and datastrative embodiments of the invention; and

FIGS. 79-85 are pictorial representations of a battery configuration in accordance with both illustrative and datastrative embodiments of the invention

### DETAILED DESCRIPTION

Aluminium is abundantly available at less than $2.00 per Kg. and Lithium is in a very short supply as well as being more than 15 times more expensive. Based upon cost and availability, the decision was made to Alloy Aluminium with other high energy potential materials to achieve an Alloyed material with an over 1900 Watt Hour energy density metal alloy. These electrodes have a fast charge & discharge cycle lifetime of over 25,000 cycles, and the resultant battery is re-chargeable and will have approximately 35% of the power storage capacity (˜1900 kWh) that an aluminium air battery (5500 kWhr) has. The Saline based electrolyte battery is designed to be 90% recyclable and to provide a large quantity of energy per Kg of weight, it is inexpensive to produce, as the readily commercially available material costs for the electrode formulations are less than US $2.00/kg (2.2 lb).

This leads to a new paradigm in Battery design to replace lithium-ion batteries, which presently dominate the rechargeable, high-energy battery market. These high density Low Corrosion Ceramic Metal Glass electrodes materials combined with a non-toxic safe and non-flammable Saline based electrolyte batteries are very environmentally friendly. Saline battery that is 5 times less expensive than current batteries based, upon lithium and provide equivalent or better electrical power generation storage, 24 hr./7 days for renewable energy technologies, we developed Saline based electrolyte batteries with Long Lifetime, High Conductivity, Low Corrosion, Ceramic Metal and Glass materials that are intermixed and infused with a high temperature ceramic flux, and fired at 1150* C, in a roller tile kiln to create “hot stamped” electrodes The Ceramic Metal Glass Alloy breakthrough performance enhancements were achieved by adding a mix of Proprietary Materials A and Materials B, at 1150*C+, into the batteries 11 element material electrodes thereby creating an unprecedented synergistic event that increased the electrode's conductivity by as much as 160% and extended the battery electrode lifetime to over 25,000 cycle electrode lifetimes. As a second generation step the electrodes may be ink jet printed on ultra-thin 1.72 mm thick SIALON ceramic tiles. Which may significantly drive costs down to the affordable market price of $80 per kWh for these Saline based electrolyte batteries.

What is being presented herein is a saline-based electrolyte for use in Electrical Storage Batteries, which is in its most basic form, (i.e. the most basic formulation), is relatively benign and non-toxic. It is also non-flammable, as well as being, an extension of approximately six, sevenths of this planet's surface composition and in that context it is again, the most ubiquitous and Earth friendly of all preceding battery electrolyte's. Therefore, according to one exemplary aspect, different battery styles are disclosed all sharing a Saline Electrolyte as the conductive fluid.

After more than 20 years of steady Electrical battery research, Saline based Electrolyte's are still a preferred choice, as well as being the most plentiful resource on this planet. Therefore, the present disclosure proposes the use of a saline electrolyte given that it is the most natural and prevalent planetary resource material as well as most easily replaceable electrical storage battery electrolyte base. Albeit Saline Solutions and Atmospheres are mostly corrosive to many commonly used metals, saline electrolytes function as an electron carrier fluid as well as being electrically conductive and capable of very rapid ion exchange before they reach their highest level of exhaustion, and their evaporation limit, by boiling away, into a vapor. The most basic premises, for example, for choosing a saline-based electrical storage battery electrolyte are provided to define one or more exemplary constructs of the present disclosure.

1. Most plentiful of all natural resources; 2. Most readily accessible electrolyte; 3. Essential for human and animal health and well-being; 4. An essential component of our operating fluids (blood stream); 5. Most closely related to our being-ness; 6. Least toxic of all Storage Battery Electrolytes; 7. Least Flammable (i.e., it is a flame suppressant); 8. Least costly and most readily replaceable; 9. Human and animal friendly, we swim in it at times and places and it is the most ingestible electrolyte replacement in our bodies; 10. There is no requirement for special protective gear nor any required breathing apparatus, and long exposure is not toxic, (i.e. swimming in it); 11. We use it as an added flavor enhancement in our food preparations and it is also a food preservative; 12. The description could go on further, but it is a very good Electrical Storage Battery electrolyte choice, yet it suffers from low voltage enhancement; 13. Albeit, saline solutions are mostly corrosive to many commonly used metals, they function as an electron carrier fluid as well as being electrically conductive and capable of high current capacity and very rapid ion exchange before they reach their highest level of exhaustion, and their evaporation limit, by boiling away, into a vapor.

Yet, inspection of the above-described characteristics makes item 13 an option even though being corrosive to most commonly used metals could be a limitation, in that non-common metals costs more and common metals have (in a saline electrolyte) a shorter operational lifetime due essentially to corrosive degradation of the base metal electrodes as well as having a low voltage capability.

Therefore, a decision matrix providing, by way of example, a series of choices for an electrode material is hereafter-described. The electrode materials are provided as options and not to limit the disclosure to the application of one over another, whether described or incorporated herein by reference.

1. High Electrical conductivity commonly available, low cost metals such Copper, Aluminum, Zinc, Lead and Steel, also are very readily corroded by Saline atmospheres and electrolytes.

2. The suggestions in 1 can be coated with semi-conductive metallic alloys that will extend their operational lifetimes by 3 to 10 times, in a Saline environment, but that limits their electrical conductivity and adds a processing procedure and cost increase thereby becoming less efficient electrodes and costing more.

3. Metals such as, the Noble Metals, Gold, Palladium, Platinum and Titanium, all of which are significantly more resistant to corrosion in a Saline Based Environment, and may have a higher Electrical conductivity, may be used notwithstanding they all are far more expensive to find as well as produce.

4. Different raw Earth materials may be selected (and blended) to achieve a higher resistance for use as a semi-conductive electrode base, with a longer lifetime and a relatively high energy efficiency in Electrical Storage Battery electrodes in a Saline energy recovery environment.

5. A few blended semi-conductive electrode formulations, provided by way of example, are as follows:
a) Lithium, Alumina Silicates=Li/AL/Si in the rough blend of 20% Lithium, 20% Alumina and 60% Silica, leads to a very fast Electrical semi-conductor in thin cross sections that is very corrosive resistant in a Saline Environment, with a crystalline formulation temperature of around 1260-1320 degrees centigrade.
b) Lithium has become an expensive material due to its high demand and rare availability. Therefore modifying the semi-conductive Alloy to Ca 18%, Li 6%, AL 18%, Si 58%, reduces the cost by approximately 35% albeit it raises the crystalline formation temperature around 30 degrees C., it also makes it slightly less efficient Electrical semi-conductor, and conversely more corrosion resistant in a Saline Based Environment.
c) Eliminating Lithium Reduces the cost again by another 15%, or overall 50% less expensive than the first presented semi-conductive electrode alloy.
d) A less expensive alloy may have a basic formulation as follows; Ca 6%, Ba 7%, Bi 11%, AL 16% and Si 60%. This alloy may have a crystallization formation temperature of around 1220 to 1280 degrees C., and it may be a more efficient Electrical semi-conductor as well as being a more corrosion resistant alloy in a Saline Based Environment.
e) Adding a bit of Copper 2% (Cu) and 5% Iron (Fe) to the mix pushes that alloy to the edge of room temperature super-conductivity, in a below Zero temperature range, thereby making this semi-conductive alloy more electrically conductive than either Aluminum and Copper respective to the below zero temperature.
f) Adding Titanium (Ti) in the form of the low cost naturally occurring mineral Rutile which is approximately 93% Ti and 7% Fe (Iron) so the resultant formulation may be
   i) Ca 6%, Ba 7%, Bi 11%, AL 16% Rutile (Ti Fe) 11%, Cu 2% and Si 47%, by a molecular weight blend. We have here an extremely corrosion resistant (in a Saline Based Environment) semi-conductive electrode, whose electrical conductivity approaches that of 97% pure Aluminum and may have an operational lifetime with more than 75% efficiency in over 25,000 cycles (one Charge & one Discharge=1 cycle) in a Saline Based Electrical Storage Battery. At an electrode cost of less than Copper, it is 80% as conductive and will last 25 times longer than Copper in a Saline Based Electrical Storage Battery
g) Further additions of 15% Phosphorous (P) may extend the electron travel lifetime in the alloy by as much as 50%, and may increase the semi-conductive alloy to an electrical conductivity in between that of Aluminum and Copper while still maintaining an over 25,000 cycle lifetime (one Charge & one Discharge=1 cycle) in a Saline Based Electrical Storage Battery.
h) Crystalline formation temperature may be less than 1160 degrees C. Further hardening of the alloys corrosion resistance may be increased by adding up to 6% of Boron Trioxide (B2 O3) which addition may reduce the crystalline formation temperature another 25-30 degrees C.
i) A semi-conductive alloy of approximately this general formulation may include, for example:
   i) Ca 6%, Ba 7%, Bi 11%, AL 16% 16% Phosphorous (P), Rutile (Ti Fe) 11%, Cu 2%, 6% B2O3 and Si 25%, by a molecular weight blend.
j) Estimated to survive over 25,000 cycle lifetime (one Charge & one Discharge=1 cycle) at over 80% efficiency in a Saline Based Electrical Storage Battery. At a crystalline formation temperature of around 1120 degrees C., (99% Copper's crystalline metal formulation is 1084 degrees C.) which is more than of Copper and may be more conductive in a Saline Based Electrical Storage Battery

And the above semi-conductive alloy (Ca 6%, Ba 7%, Bi 11%, AL 16% 16% Phosphorous (P), Rutile 11%, Cu 2%, 6% B2O3 and Si 25%, by a molecular weight blend) in a Saline Based Electrical Storage Battery costs less, and requires less refinement, and less energy to produce and lasts as much as 25 to 35 times longer.

When electrodes are placed in an electrolyte and a voltage is applied, the electrolyte will conduct electricity. Lone electrons normally cannot pass through the electrolyte; instead, a chemical reaction occurs at the cathode consuming electrons from the anode. Another reaction occurs at the anode, producing electrons that are eventually transferred to the cathode. As a result, a negative charge cloud develops in the electrolyte around the cathode, and a positive charge develops around the anode. The ions in the electrolyte neutralize these charges, enabling the electrons to keep flowing and the reactions to continue.

The basic Saline Based battery design started 22 years ago in 1990 when a consortium of 18 automotive engineers and designers to develop a 140 MPG HyBrid Gas & Electric powered 6 passenger automobile. The automotive engineers and designers came from a background of having worked at different times (providing solutions for suspensions, steering, drive trains, engines, and fuel systems, as well as new designs) with BMW, Jaguar, Lotus, GM, Ford, Chrysler, Bombodier of Canada, Mercedes, Audi, VW Pugeot, Alstrom and other transportation manufacturers. A Saturn was used as the basic platform and a 40 HP electric motor was integrated into the drive train for constant speed highway driving on the stored energy of 14 advanced, light weight racing batteries, tucked into various accessible sections of the automobile. The batteries needed to be in a better and more flexible form factor, in order to fit the design constraints of the automobile, and at that time there were no viable candidates to choose from, other than 14 advanced Lead Acid Racing Batteries and or 42 motorcycle gel packs. Then there was the overall concern of passenger protection in an accident, from these batteries breaking loose and spilling small quantities of Sulphuric acid onto the ground and or pavement.
The Saline based battery concept poses no great ecological issues or dangerous chemical exposure to the vehicle occupants. The basic parameters, for example, that are considered, at least in the one application, is whether the design is lightweight, non-flammable, non-toxic, has a high power density, has a 5,000+ cycle lifetime, uses readily available low cost materials, and is configured into a flexible design format.
One of the basic issues in designing a battery with a useable lifetime beyond 10,000 cycles may require development, for example, of a series of non-corrosive electrodes that is capable of surviving 10,000 charge and discharge cycles and still have more than a 75% electrical storage efficiency.
The precursor of strong ceramic alloys exists in one form as SIALON, a ceramic composition alloy (Silicon, Alumina, Oxygen, Nitride). And, a second pre-cursor was the Li Al Si Alloy used in the Thin Film Multi junction PV Cell patents issued by the USPTO in 1983 (See Multi-layer thin-film, flexible silicon alloy photovoltaic cell, U.S. Pat. No. 4,479,027).
That alloy outperformed pure silicon in its operation as a PV cell and was formable at 1158° C. versus 1440° C. for Silicon. The Li AL Si alloy was also noteworthy for its increased current and Voltage characteristics as well as having a higher level of conductivity than either Si or Aluminum Gallium Nitride PV cells.
SIALON is a very good electrical insulator, and conversely the metals Copper and Aluminum are very good conductors of electricity. Therefore the challenge is to develop a low electrical resistance high-electrical conductivity semi-conductor alloy of Copper, Aluminum and SIALON, in the form of a Ceramic, Metal, Glass alloy. SIALON has a maturing formation temperature well above 1300° Centigrade, and Copper has a melting point at 1084° C. and Aluminum melts at 660° C., ordinary window glass softens at 575° C. The glass is the intermediate bonding and forming material which would allow a high production as well as a lower temperature formation of the proposed semi-conductor. Typical roller furnaces (300 feet in length) in Ceramic wall and floor tile factories produce 50,000,000 sq. feet of finished and glazed tiles per year in a firing cycle of less than 40 minutes, cold to cold and contain a center hot zone that operates around 1200° C. as shown in Table 1. This type of Ceramic Tile production facilities are the desired high volume manufacturing factories that the Ceramic Metal Glass electrodes may be produced in.

TABLE 1

| | | | | | | | | |
|---|---|---|---|---|---|---|---|---|
| 9) Saline Based | −40-+100 | 30%-50% | 1,000++ | 25,000+ | 3 | <$90 | 90% | New Paradigm |
| Electrolyte & | | | | | | | | Design 2012 |
| Ceramic/Glass | | | | | | | | |
| Metal Electrodes | | | | | | | | |

According to one embodiment as shown in the figures, each battery module (e.g., 750-800 Whr) contains approximately 480—2 pc (960 electrodes, 480 cathodes and 480 anodes) Ceramic Metal Glass Electrodes, with an overall area volume approximately equivalent to 50, −6 by 6 inch wall tiles=1 sq. ft of production per second, or 60 sq. ft. of ceramic tiles (240 6 by 6 inch wall tiles) per minute, =enough electrodes for 5-750 Whr. Batteries to be produced every minute or 300 Batteries rated at 9.25 kWhr. per hour production rate. At 20 hours per day production there are 6,000 9.25 kWhr batteries produced per day. That would become 250 Household battery power systems per day, for 300 production days the overall output per year would be over 75,000 home power systems. Exemplary details for one such household power storage battery system is provided in the figures. One of the key components of these electrodes is the center semi-conductive core which may be, for example, 12 mm in Diameter. And, has a semi-conductive area of 120 mm. sq. which is the area required to adequately carry a maximum current load of up to 450 amps without an overheating issue in very rapid charge and discharge cycles. The normal operating peak loads are 180 amperes at full load demand which is only 40% of the maximum current capacity of the center core semi-conductors. The maximum current capacity duty cycle of these electrodes is 250% of their normal operating cycle loads. The Anode as shown in the figures is in its operating form surrounded by an enhanced Saline Based Electrolyte, as is the Cathode as is also shown, albeit the electrolyte was not shown for the purpose of clarity and obvious electrode separation as well as the dimensional scalability provided by the background grid line pattern.
The figures contain an illustration of an exemplary fabrication type of the present disclosure. Quantum dots ink jet printed onto porous 4 stacked clusters of conductive variant SIALON in very thin layers are shown, by way of example, that are interleaved into a stack surrounded by electrolyte, produced with a totally automated production, yielding over 50,000 cycles without difficulty and densely populated with micro electrode Q dots that are self-organizing and self-packing, and most certainly, it may easily reach out beyond 1250 Whr. per Kg at minimal costs.
When determining the theoretical structures of the interfacial layers that connect the Anodes and Cathodes into a voltage and current building pyramid, one exemplary way to keep the cumulative stack ohmic resistance losses from overcoming the anticipated gains is to push the alloys into a room temperature super conductive state while extending the electron lifetime dwell state by creating barrier layers (electron dams to build electron reservoir pressure) onto an valance conducting zone (spillway). Ca, Ba, and Bi are known and well described super conductors and Li Al Si is a very fast semiconductor and Fe, Ti, and Cu trace alloys also approach those parameters (with the understanding that Strontium could be a valuable catalyst) and the Phosporous acts as the temperature lowering flux as well as the electron travel lifetime extender. Trial alloy calculations, in the above-described Figures, are provided with exemplary sketched electrode models.
Although there are more than 20 types of battery's available, the present disclosure focuses upon those types that are manufacture-able in large quantities and at a relatively low cost, with a long operable lifetime.
Below is a table and partial exemplary listing of 12 battery choices that meet all or most of the above criteria.

TABLE 2

| | Temp. Range | | kWhr | Lifetime | kWhr | Cost per | % | Total yrs | |
|---|---|---|---|---|---|---|---|---|---|
| Battery Type | * C. | Efficiency | Capacity | cycles | per Kg. | kWHR | Recycleable | in existence | Rechargeable |
| 1) Lead Acid | −20-+80 | 4%-6% | 1 | 200-300 | 0.1 | $40 | 95% | 100 | Yes |
| 2) Advanced | −20-+80 | 8%-10% | 1 to 2 | 300-500 | 0.2 | $60 | 95% | 50 | Yes |
| Lead Acid | | | | | | | | | |
| 3) Nickel/ | −20-+80 | 3%-5% | 1 to 2 | 10,000 | 0.05 | $400 | 90% | 120 | Yes |
| Iron Batteries | | | | | | | | | |
| 4) Aluminum | −20-+80 | 30%-50% | 5+ | 1000 | 3 | $200 | 90% | 50 | No |
| Air | | | | | | | | | |
| 5) Sodium | 300 | 25%+ | 100 | 2500 | 1.5 | $200 | 70% | 50 | Yes |
| Sulphur | | | | | | | | | |
| 6) Molten | 1200 | 30% | 100+ | 5000+ | 2 | $150 | 60% | 30 | Yes |
| Metal | | | | | | | | | |
| 7) Lithium | −20-+80 | 25%-35% | 100 | 2500 | 3 | $400 | 50% | 20 | Yes |
| Ion | | | | | | | | | |
| 8) Manganese | −20-+80 | 15%-18% | .25-2.5 | 3000 | 1 | $200 | 70% | 30 | Yes |
| Hydride | | | | | | | | | |
| 9) Saline Based | −40-+100 | 30%-50% | 1,000+ | 25,000+ | 3 | <$90 | 90% | New Paradigm | Yes |
| Electrolyte & | | | | | | | | Design 2012 | |
| Ceramic/ | | | | | | | | | |
| Glass Metal | | | | | | | | | |
| Electrodes | | | | | | | | | |
| 10) 2^{nd} | −40-+100 | 30%-50% | 1,250+ | 35,000+ | 4 | <$85 | 90% | New Paradigm | Yes |
| Generation | | | | | | | | Design 2012 | |
| Enhanced | | | | | | | | | |
| Saline Printed | | | | | | | | | |
| & Integral | | | | | | | | | |
| Electrode | | | | | | | | | |
| Coatings | | | | | | | | | |
| 11) 3^{rd} | −40-+100 | 35%-55% | 1,500+ | 45,000+ | 5 | <$80 | 90% | New Paradigm | Yes |
| Generation | | | | | | | | Design 2012 | |
| Ultra Thin | | | | | | | | | |
| Alloy Sialon | | | | | | | | | |
| Tile Printed | | | | | | | | | |
| Integral | | | | | | | | | |
| Electrodes | | | | | | | | | |
| 12) 4^{th} | −40-+100 | 40%-60% | 2,000+ | 55,000+ | 6 | <$75 | 90% | New Paradigm | Yes |
| Generation | | | | | | | | Design 2012 | |
| Ultra Thin | | | | | | | | | |
| Alloy Sialon | | | | | | | | | |
| Tile Printed | | | | | | | | | |
| Integral | | | | | | | | | |
| Electrodes & | | | | | | | | | |
| Enhanced | | | | | | | | | |
| Saline | | | | | | | | | |
| Electrolyte | | | | | | | | | |
| Battery Type | Temp. Range | Efficiency | kWhr | Lifetime | kWhr | Cost per | % | Total yrs | Rechargeable |
| | * C. | | Capacity | cycles | per Kg. | kWHR | Recycleable | in existence | |

### Saline Based Electrolyte & Ceramic/Glass Metal Electrodes

The present disclosure addresses in, at least several exemplary aspects, the best inter-connective between the electrode alloys, integrating the cathode and the anode to build the voltage pyramid, while maintain a high amperage connection with a very low gain in resistance and minimizing the overall losses between the interconnected electrodes almost leading to synergistic gains versus entropic losses as illustrated by the conceptualization provided, at least, in the figures.

### Enhanced Saline Printed & Integral Electrode Coatings

The figures provide exemplary illustrations of a printed Cathodes and Anodes onto a very thin Sialon tile. Examples of the characteristics and performance parameters associated with such a design are shown at row 10 in Table 2 above and in the figures. The second generation enhanced saline-based electrolyte, in one aspect, may be configured as an 11.25 kW·hr battery, which holds a 25% reserve capacity of 2.75 kW·hr that may be accessed as described below. It may also be configured as the same overall size as the #9 first generation model, but achieves a 22% higher voltage through the use of a more reactive enhanced saline electrolyte. Yet, the current which is determined by the number of ceramic electrode plates, in one embodiment, remains the same.

### Saline Based Electrolyte & Ceramic/Glass Metal Electrodes

The figures provide exemplary illustrations of a printed Cathodes and Anodes onto a very thin Sialon tile. Examples of the characteristics and performance parameters associated with such a design are shown at row 9 in Table 2 above and in the figures. The saline-based electrolyte, in one aspect, may be configured as a 9.25 kW·hr battery, which holds a 25% reserve capacity (2.25 kW·hr) that can be used in an emergency by pressing the power saver, override button on a touch screen display, for example, for 5 seconds. Otherwise the maximum power drain is may be limited to 7.00 kW·hr, to protect the 25% reserve capacity, for emergency use only.

The figures provide exemplary illustrations of electron micrographs of loose as-grown SiC whiskers, planar defects perpendicular to the length of a single SiC whisker, and a whisker cross-section showing partial dislocations and core cavities. Sources: (a) the Greenleaf Corporation and (b & c) S. R. Nutt, 1988; John Wiley & Sons, with permission.

### Ultra-Thin Alloy Sialon Tile Printed Integral Electrodes

The figures provide exemplary illustrations of a printed Cathodes and Anodes onto an ultra-thin Sialon tile. Examples of the characteristics and performance parameters associated with such a design are shown at row 11 in Table 2 above and in the figures. The third generation #11 enhanced saline-based electrolyte, in one aspect, may be configured as a 14.00 kW·hr battery, which holds a 25% reserve capacity of 3.5 kW·hr that may be accessed as set forth above. It has the same overall size as the #9 first generation model, but achieves a 25% higher voltage with the use of a more reactive enhanced saline electrolyte. And, the current increases may exceed 25% by the use of 4 more ultra-thin Sialon tiles supporting the electrodes which are integrated onto the ultra-thin Sialon tiles by, according to one aspect of the disclosure, a high speed ink jet printer.

### Ultra-Thin Alloy Sialon Tile Printed Integral Electrodes & Enhanced Saline Electrolyte

The figures provide exemplary illustrations of a printed Cathodes and Anodes onto an ultra-thin alloy Sialon tile. Examples of the characteristics and performance parameters associated with such a design are shown at row 12 in Table 2 above and in the figures. The fourth generation #12 configuration of an enhanced saline-based electrolyte is estimated to be an over 17.50 kW·hr battery, which holds a 25% reserve capacity of 4.25 kW·hr that may be accessed as set forth above. It is generally the same overall size as the #9 first generation battery but achieves a 25% higher voltage than #9, with the use of a more reactive enhanced saline electrolyte. Plus, the current increases 45% by the use of 4 more ultra-thin Sialon tiles with the electrodes printed by, for example, a multi-pass high speed ink jet printer, with 16 overlapping gradiated layers for each cathode and anode which may raise, the overall speed and volumetric increase of the ion exchange rate, by more than 30% to achieve an over 17.5 kW·hr configuration.

The figures provide additional disclosure regarding one or more exemplary aspects of the invention.

The figures provide an exemplary plot of % of energy available in 7 different common batteries as calculated from a maximum capacity of 6,000 kWhr. The plot assumes that the batteries are 100% efficient.

The present disclosure contemplates one or more methods of manufacturing standard ceramic hotel dinnerware production Facility/and or a ceramic wall tile and floor tile manufacturing facility capable of 50,000,000 sq. ft. production capacity per year. According to one aspect of the disclosure, an electrolyte composition of enhanced sea water is disclosed. In another aspect is an electrolyte containment system that uses recycled Poly Carbonate. Charge capacity for exemplary configurations of the battery may be 75% rechargeable in less than 20 minutes and have a discharge capacity of 75% dischargeable in less than 20 minutes. Beneficially, the electrolyte is safe, non-explosive, and may be used as a fire suppressant. Materials for one or more configurations of the battery include the use of safe and non-toxic materials by using enhanced sea water electrolyte, and non-corrosive semi-conductive ceramic alloy-based electrodes. Advantageously, charge cycle time may be <20 minutes to full charge at a maximum charge rate and a discharge cycle time of roughly +20 minutes to 75% discharge at a maximum discharge. The configurations of the disclosure also exhibit substantially lower cost at about ⅕th the cost of equal capacity Li Ion batteries. They also have a higher power density equivalent and/or better than Li Ion batteries. Embodiments of the designs have energy efficiencies ranging from 25% thru 45%. According to one aspect, an anode composition porous ceramic alloy Ca, Ba, Bi, AL, Si, S+ modifier alloy with a 0.5 mm thick OA Electron barrier using a very fast switching high amperage semi-conductor is disclosed. One method of anode manufacture is shown in the figures, which is hot stamped from a 5 alloy layer anode structure. The figures provide an exemplary illustration of a cathode composition, cathode structure, cathode method of manufacture. Using these exemplary structures, a high Speed production system that uses spray dried and hot stamped tiles may be used. In another application, ink jet printed electrode compositions may be formed on SIALON tiles. These compositions generally have an 85% or greater recyclability, higher power to weight density (e.g., 792 Whr/Kg), wide temperature operating range (e.g., −28° F. thru 188° F.), and high capacity to weight structure (e.g., 9.25 kWhr per 11.4 Kg). Contemplated methods of assembly include but are not limited to, robotically and/or machine assembled. Operational life expectancy for such may extend beyond 25 years. Other manufacturing considerations contemplate non-vacuum manufacturing operation (e.g., positive pressurized neutral gas chambers) using new alloy material configurations & utilization with anodes and cathodes. Materials for the battery are selected, for example, from mostly abundantly available low cost materials (e.g., ceramic materials <$2/lb). The methods and structure of electrical contacts and SIALON Plate electrically active interconnects are generally of low corrosion metal alloys. In another beneficial aspect of the disclosure, a battery containment structure may be formed from a recycled Poly Carbonate case. Beneficially, embodiments of the designs of the disclosure have low long term degradation (e.g., less than 15% at 12,500 cycles), low self-discharge capabilities (e.g., less than 1% per month), and high chemical-to-electrical conversion efficiencies (e.g., 25%-45%). In another embodiment, an integrated battery charge and discharge control system being configured to charge and discharge one or more of the disclosed batteries is contemplated.

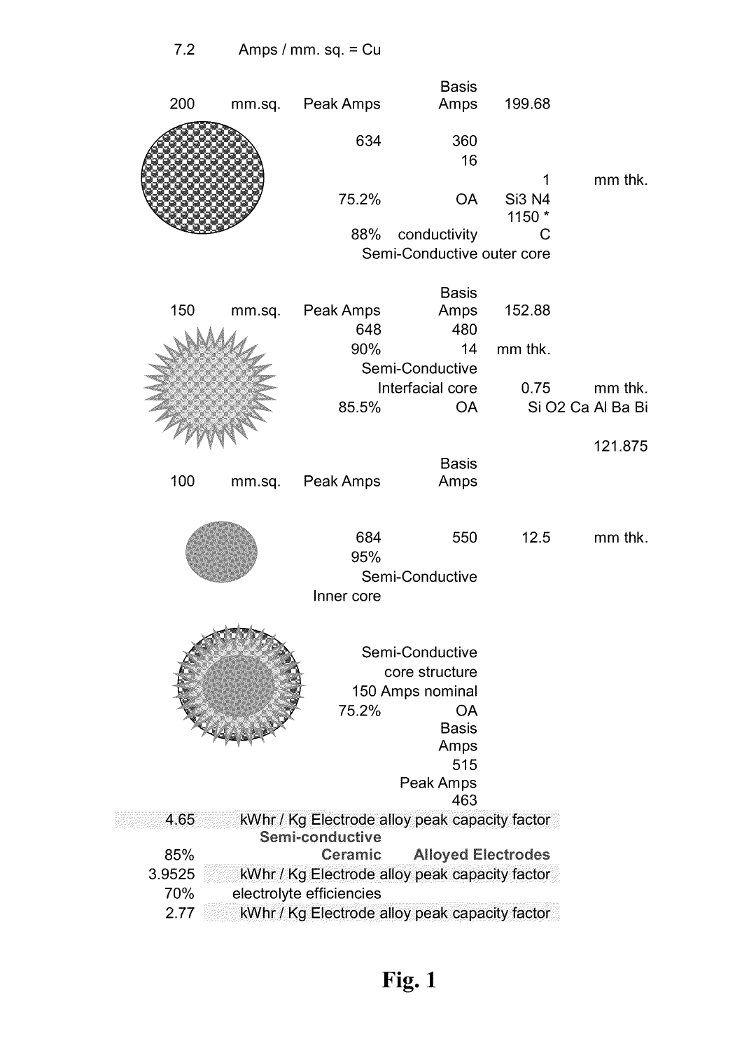

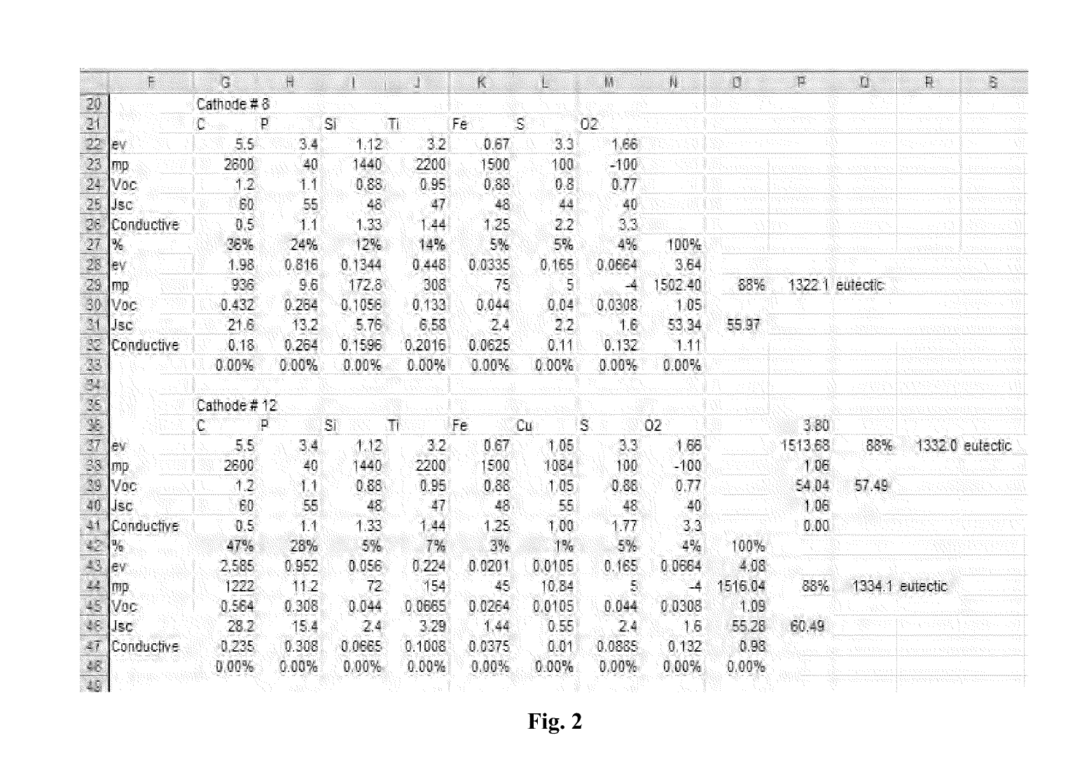

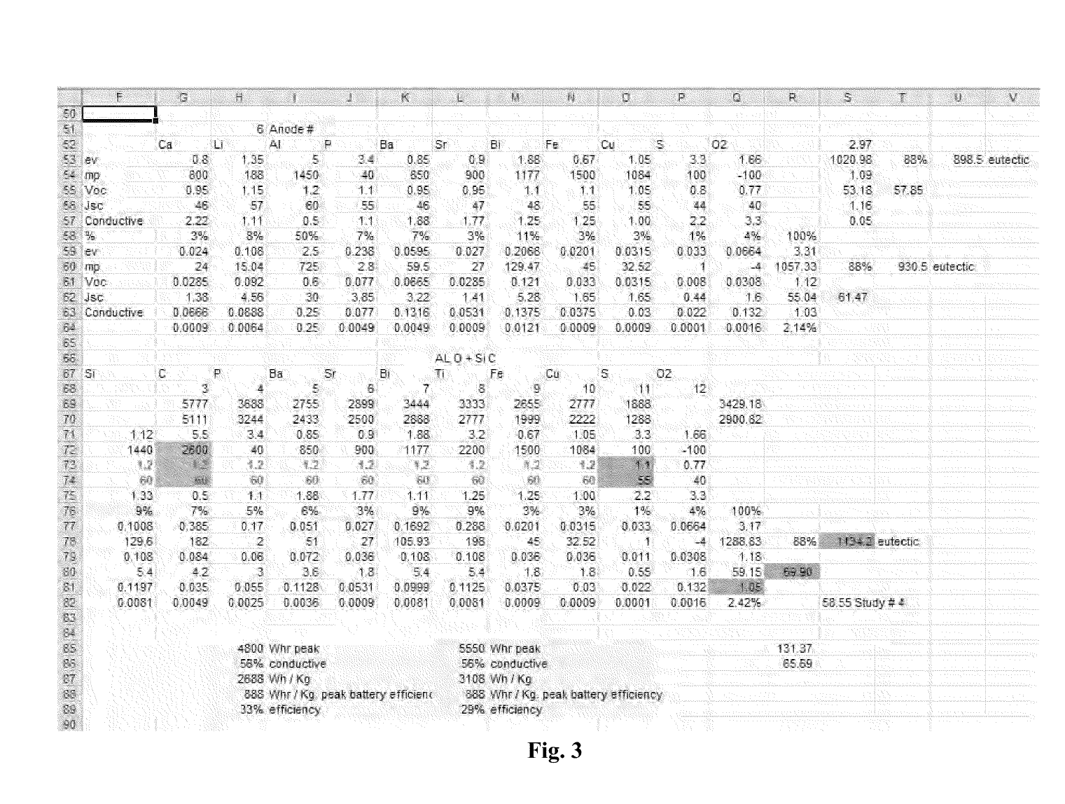

FIG. 1 is a pictorial and datastrative representation for cathode concepts according to embodiments of the present invention. Various parameters and constituent elements are set forth to identify one or more optimal configurations for a cathode. One particular version having a protected output of 7.2 amps per millimeter squared is comprised of the materials and material structure and configuration illustrated pictorially in FIG. 1. Constituent information is provided and datastratively illustrated in FIG. 2. A resulting kilowatt hour per kilogram electrode alloy peak capacity factor is also shown in the chart in FIG. 1 for a semi-conductive ceramic and alloyed electrodes. The various layers of the core structure of a cathode are provided for purposes of illustration only along with the metrics for measuring performance. One specific example resulted in a nine millimeter wide strip of dense Fe2 O3 and Ti O2 crystallites with a 5% Fe2 O3 and 4% TI O2 crystal matrix structural acid resistive coating. A conductivity results and other examples are contemplated, such as, constituents, namely 8% Fe2 O3 and 14% TI O2 as well as 46% SiC configured at a formation temperature of 1328° C. According to one aspect of the invention, an algorithm, formula or theoretical rationale is used for determining the relative amounts for the constituents included in the formation of one or more of the cathode layers or structures. Outputs of such a theoretical rationale are datastratively illustrated in the table shown in FIG. 1. Various cathode embodiments of the invention and their respective constituents are provided in table form also in FIGS. 2 and 3 respectively. FIG. 3 also includes tabulated information for parameters of a cathode of the invention, namely watt hour peak parameters, conductive parameters, watt hour per kilogram parameters, watt hour per kilogram peak battery parameters and efficiency parameters for the illustrative embodiments in FIGS. 1-3.

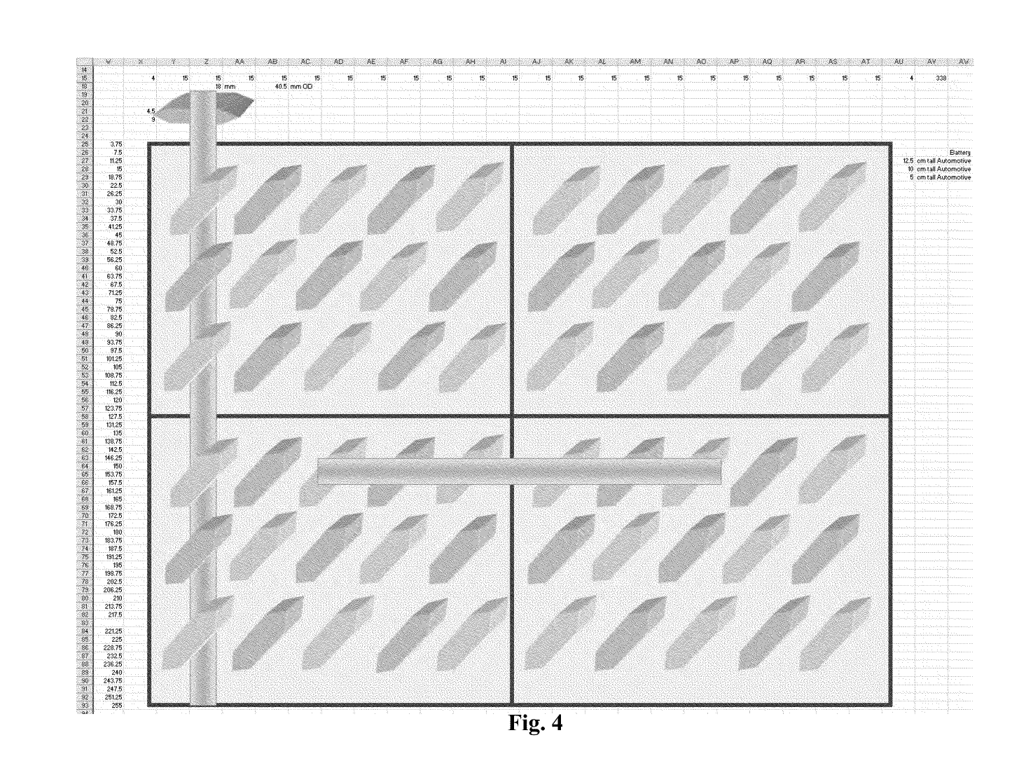

FIG. 4 is a pictorial representation of a battery configuration according to an illustrative embodiment of the present invention. The battery includes a plurality of cathodes arranged and connected as illustrated. Separate arrays within the battery, as shown, may also be connected as illustrated. An array of cathodes or a configuration of an array of cathodes within the battery may be connected together to form one layer of cathode elements within the body of the battery. These layers may be interdigitated for building the capacity of the battery in accordance with the illustrative embodiments. Also included in the aforementioned figures are information, data, configurations, constituents, parameters for each associated with one or more anode configurations according to illustrative embodiments of the present invention. Together they form an electrode according exemplary aspects of the invention.

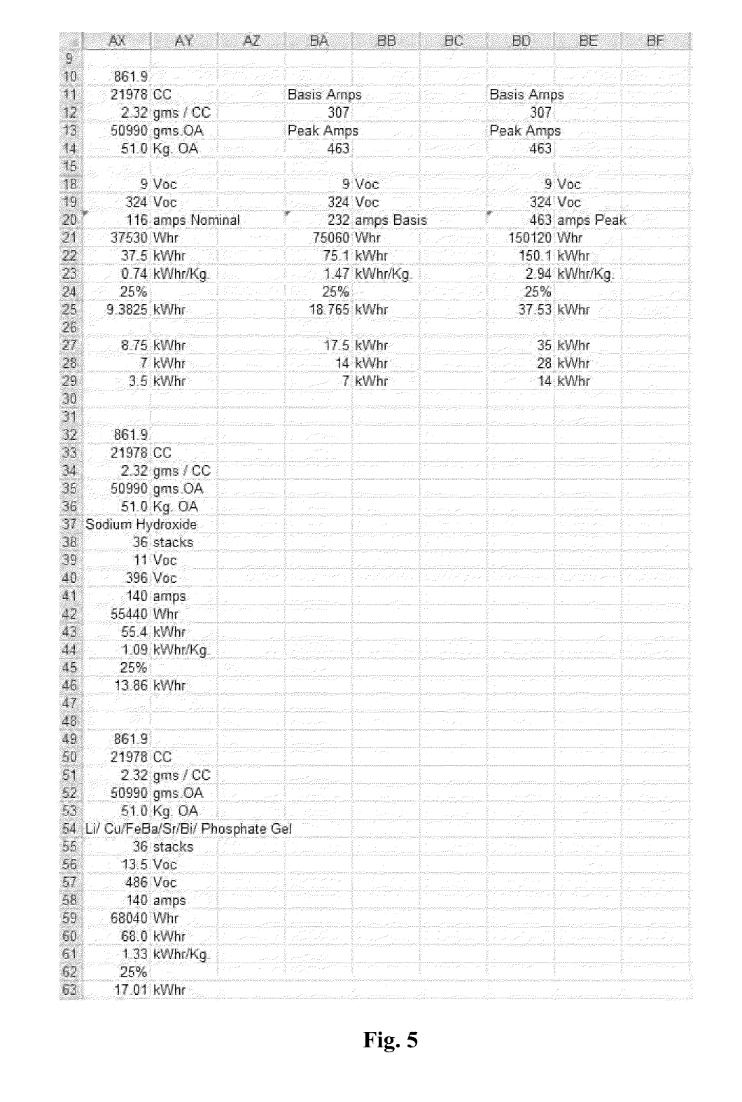

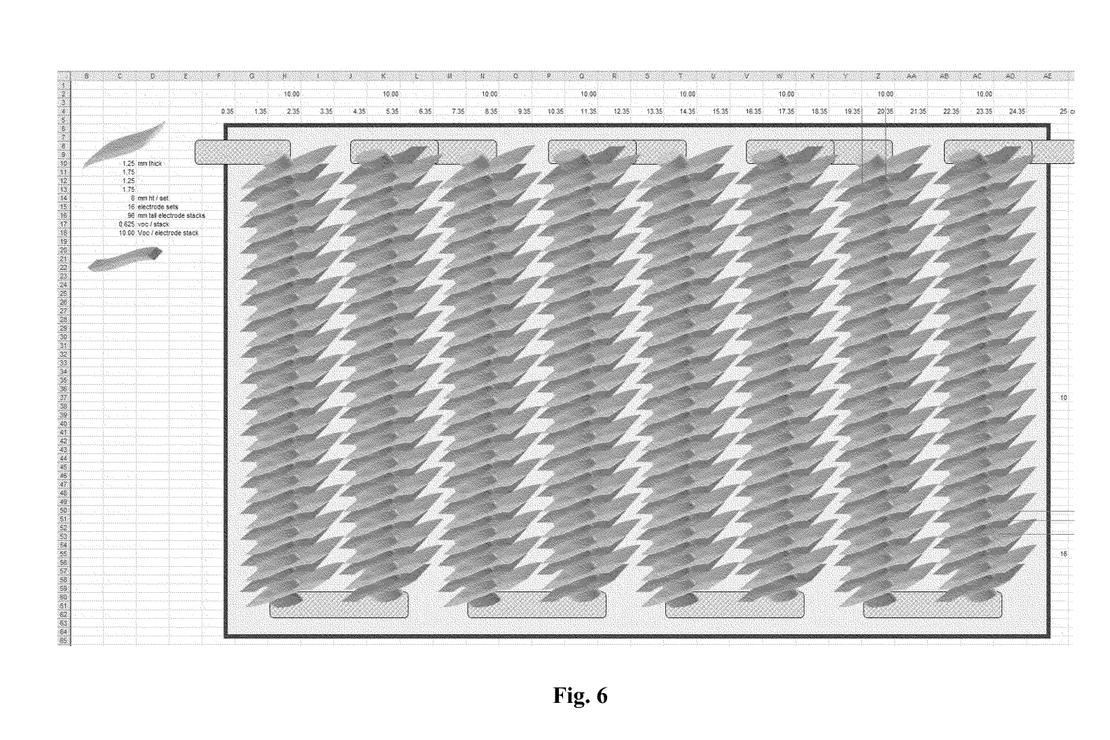

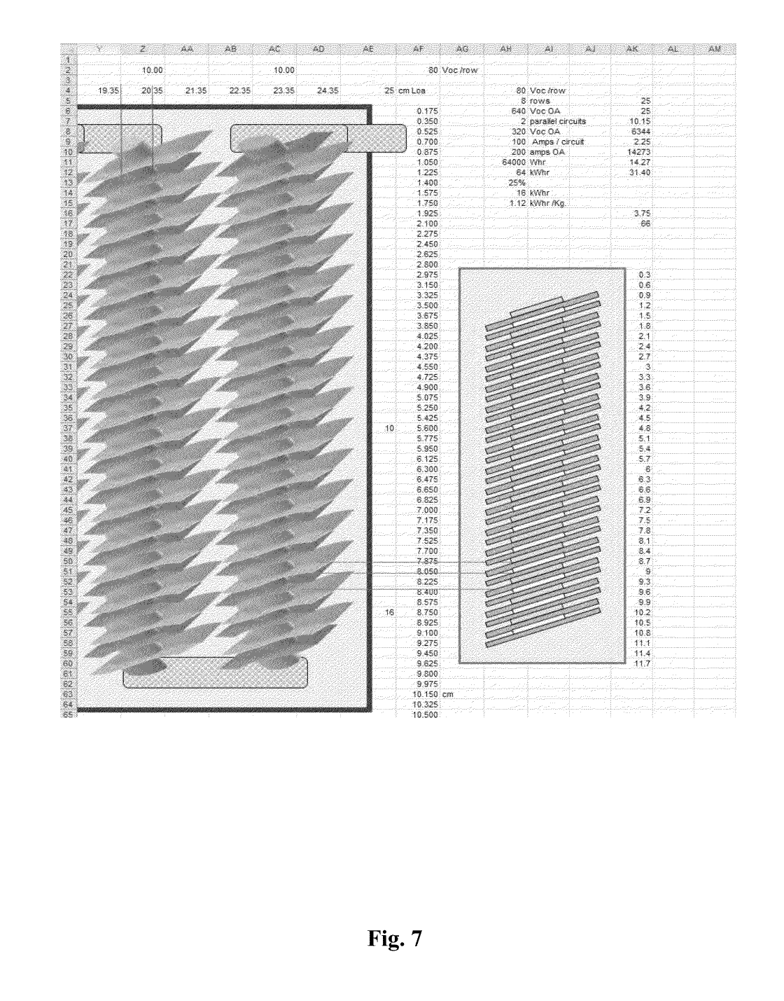

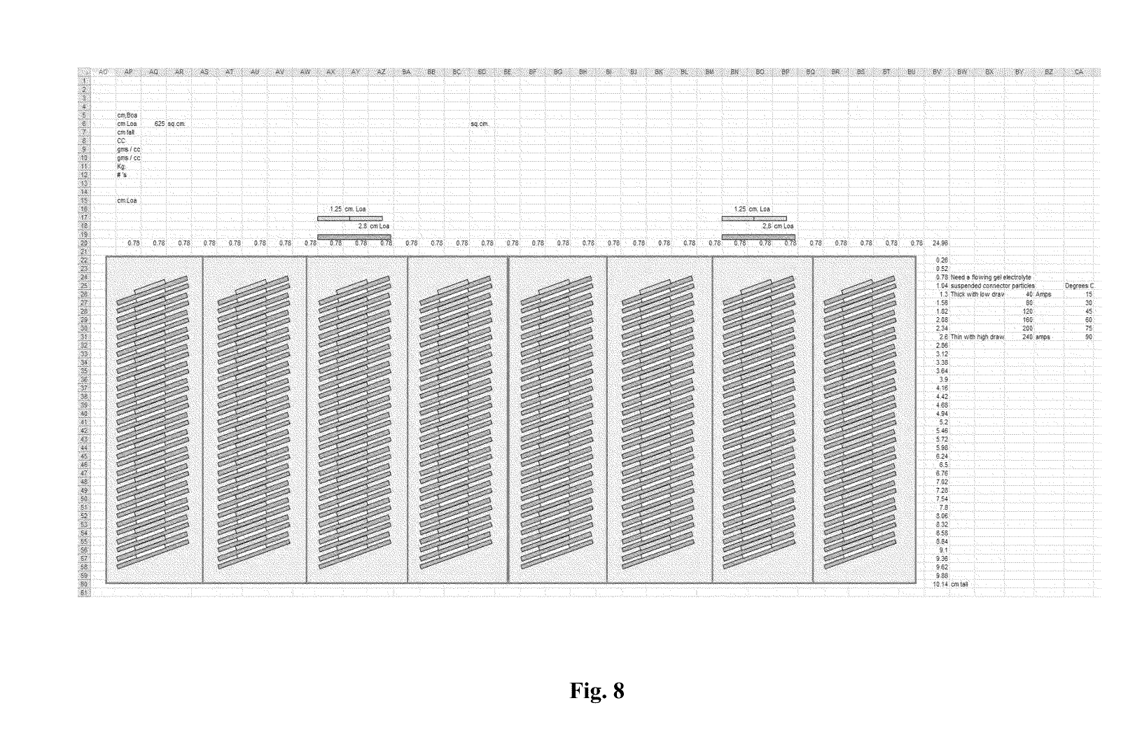

FIG. 5 is a datastrative representation of calculated parameters for the battery configuration shown in FIG. 4 according to the various constituents used for the one or more embodiments. These parameters are representative of exemplary embodiments for a stack of electrodes configured according to illustrative embodiments of the invention, such as the illustration provided in FIG. 4. Specifically, FIGS. 6-8 provide pictorial representations of various electrodes stacking configurations of the present invention. In FIG. 6, interconnected electrodes are stacked together in generally vertical profiles or horizontal profiles having for example parameter and constituent properties provided datastratively. Each of the electrode stacks may be connected in series as illustrated, other connective configurations are contemplated such as a parallel configuration. Also provided are representative numbers for the parameters of the electrode stacks and sets of electrode within a layer or within a configuration of the battery of the invention. For example, a set of electrode stacks may have a height of less than 6 millimeters or between 7-10 millimeters resulting for example in an output of 8-10 kilowatt hours. FIG. 7 provides a continuation of the pictorial representation provided in FIG. 6 along with a sectional view of an electrode stack showing the relative position and angle of each of the electrodes within the stack, and further the interconnectivity of each of the electrodes. The illustrative representation of an electrode stack include, for example eight rows having a pair of parallel circuits; the parallel circuits interconnected by one or more connective elements. Each row may for example be configured as pictorially represented, have an output such as 80 volts open circuit per row or per stack. FIG. 8 provides a pictorial representation of a cross-section for eight rows of stacked electrode columns or rows in datastratively one or more parameters inputs or outputs associated with the illustrative configuration. FIGS. 6-8 provide pictorially a representation of how an electrolyte might flow having, for example suspended connector particles, for operation of a battery.

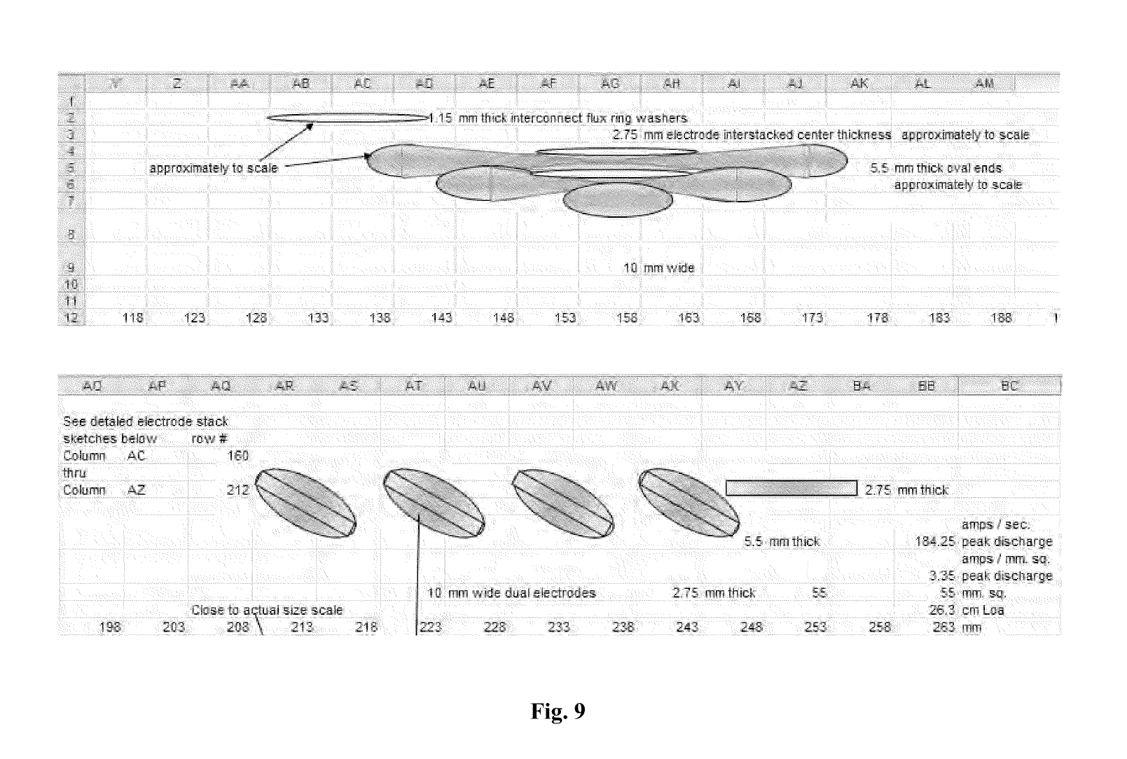

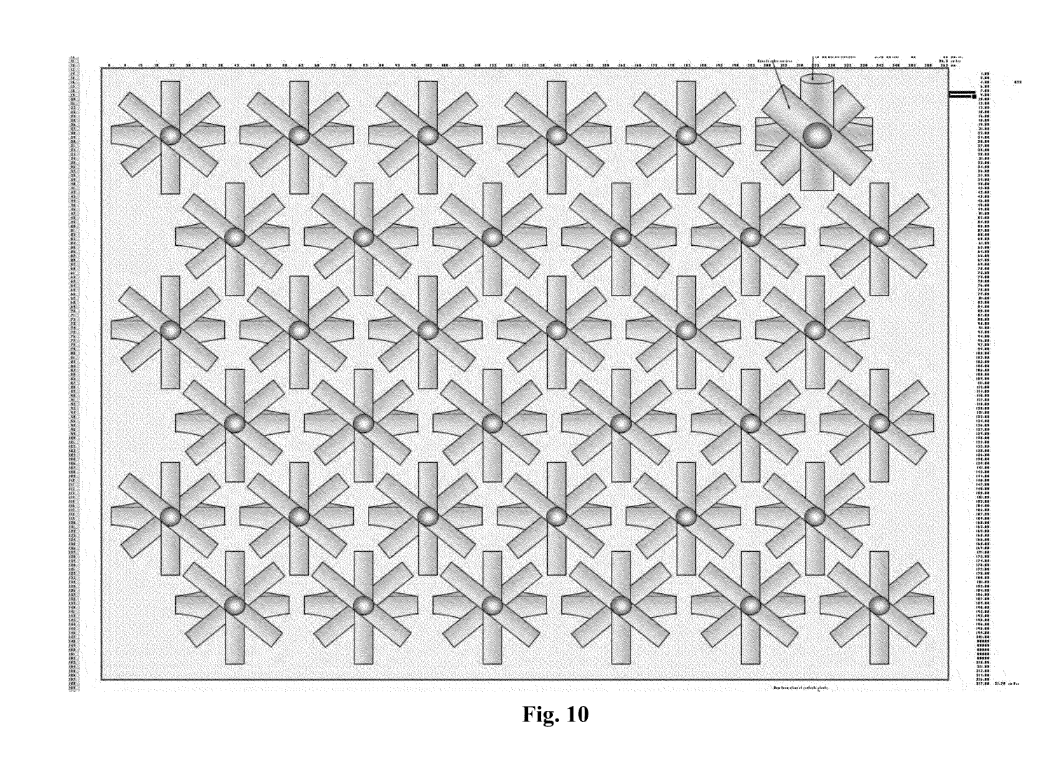

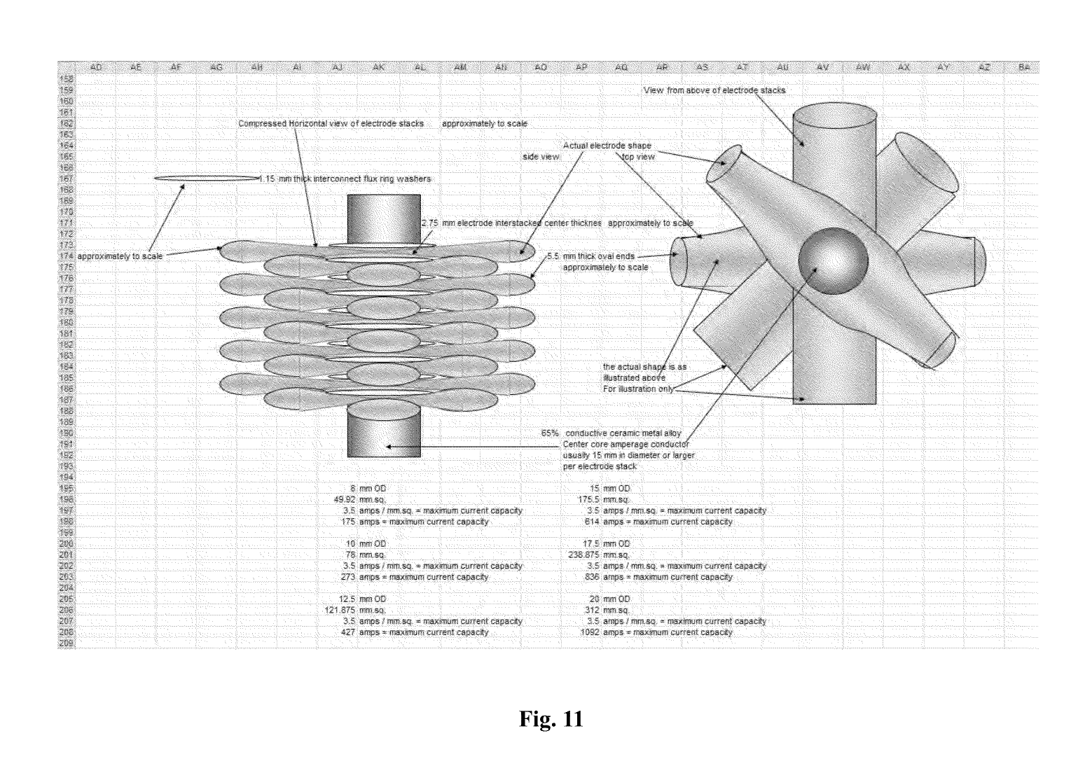

FIGS. 9-11 provide pictorially, illustrations or representative embodiments for octagonal electrode stack sequences according to an exemplary aspect of the invention. A diagram for one octagonal shaped electrode is provided in FIG. 9. The constituents making up the octagonal electrode are also provided. An electrode stack, or an octagonal electrode stack sequence, may be configured as illustratively provided in FIG. 9. Electrodes interstacked may be operatively connected by one or more interconnect flux ring washers or like interconnective member. Illustrative parameters for an exemplary octagonal electrode stack are also provided for purposes of demonstration and function, however not to limit the scope of application of the octagonal electrode stack sequence or other electrode configurations of the present invention. Representative parameters are also provided in FIG. 9 for each of the constituents of an octagonal electrode stack sequence, such as illustrated in the top portion of FIG. 9. For example, input, output and operational parameters for configurations of the octagonal electrode stack constituents are datastratively represented in FIG. 9. FIG. 10 provides an overview for a battery configuration of the invention comprising a plurality of octagonal electrode stacked sequences. The stacking of the octagonal electrode sequences may be in rows or columns and may be staggered or spaced so as to occupy as much dead space within a compartment or housing of the battery. Further illustration of a stack sequence for the octagonal electrode is provided in FIG. 11. One view provides a compressed horizontal perspective of the electrode stacks and another view provides a plan view of the compressed horizontal view. Datastrative properties for an electrode stacked sequence such as shown are also provided in FIG. 11. For example, one configuration of an octagonal electrode stacked sequence may include the datastrative parameters provided in FIG. 11 for each of the electrode shapes forming the stacked sequence. Each of the representative components of an octagonal electrode stacked sequence may be connected together, for example, by a conductive ceramic metal alloy acting as a center core amperage conductor for each respective electrode stack.

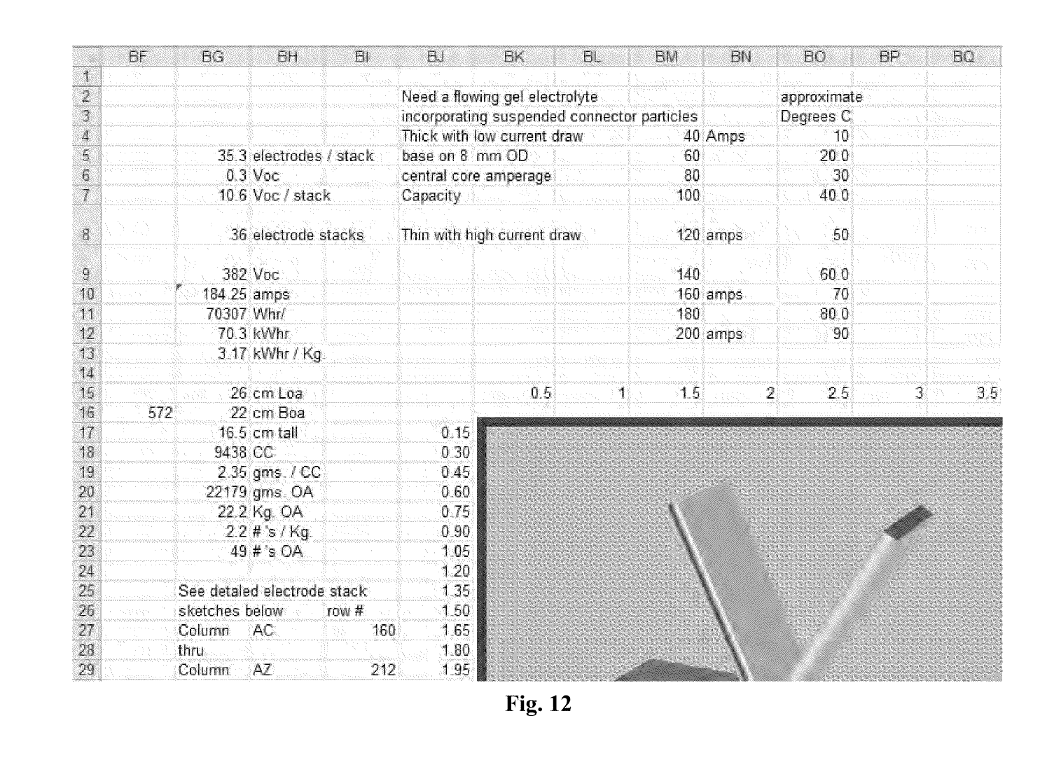

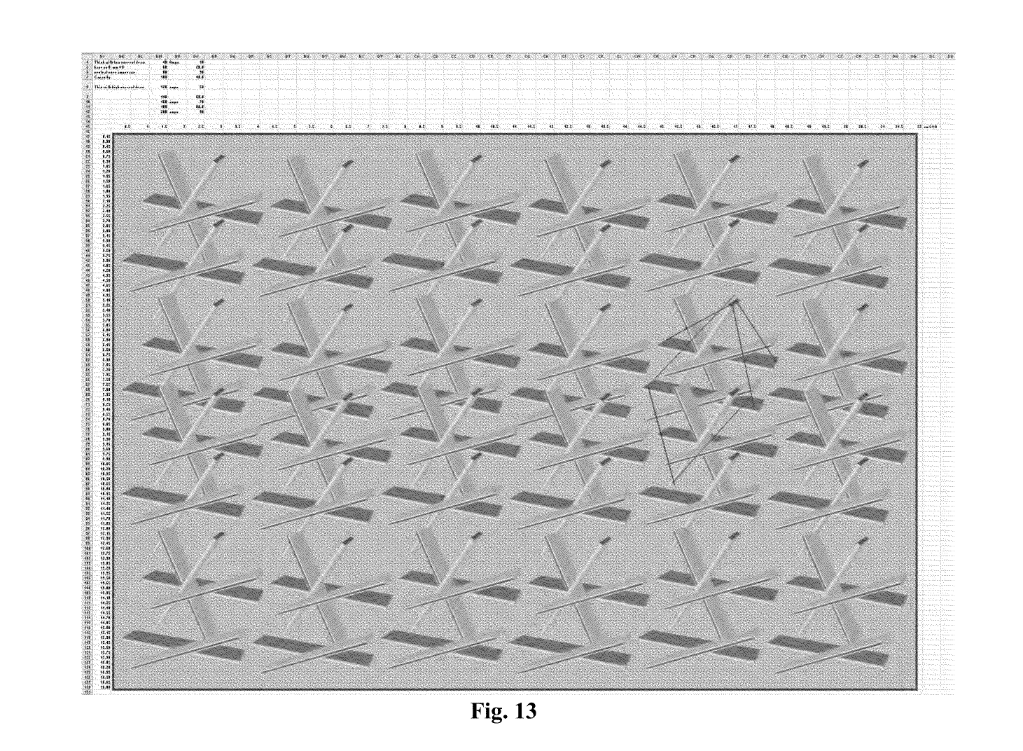

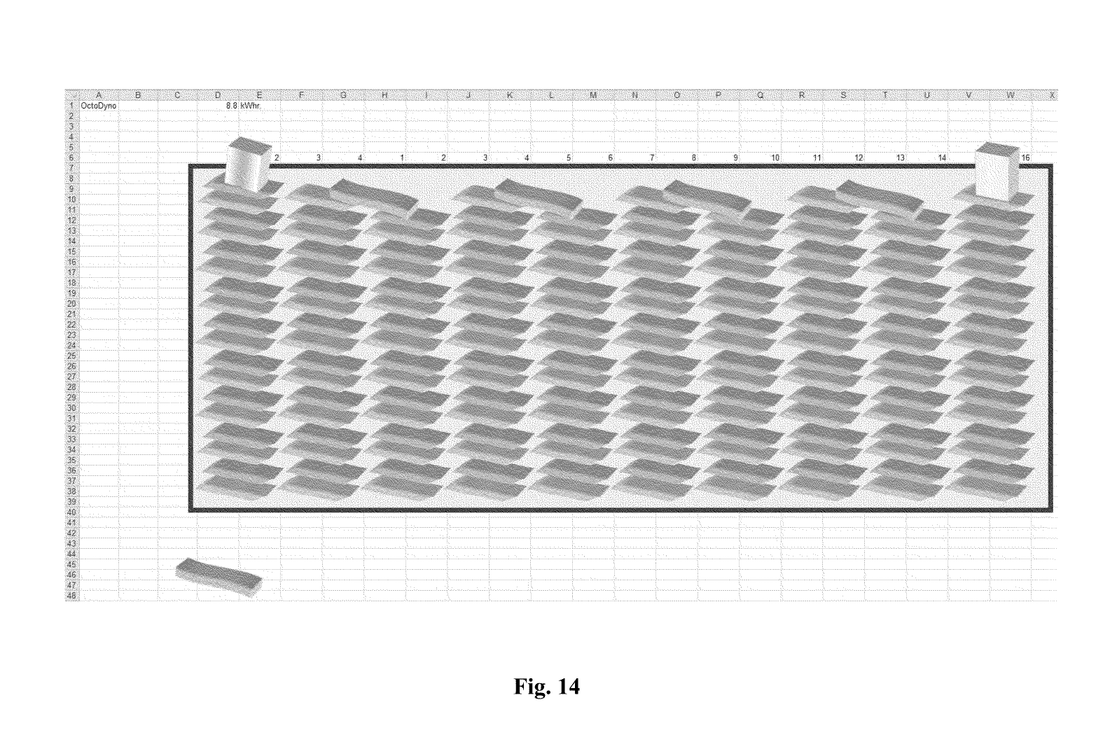

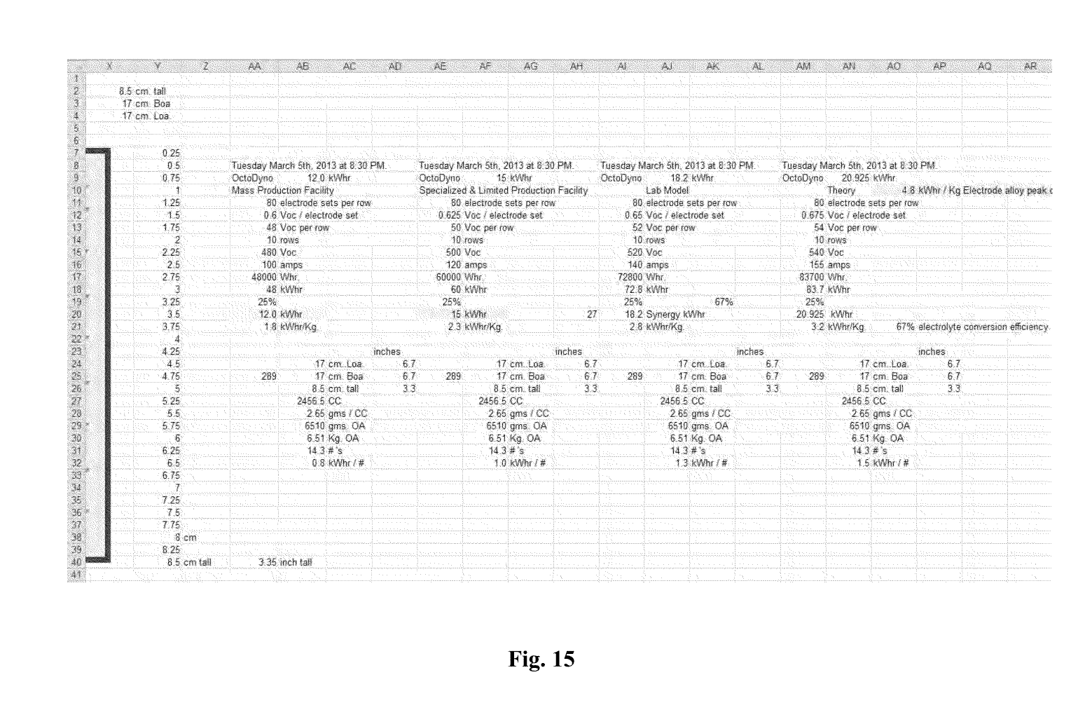

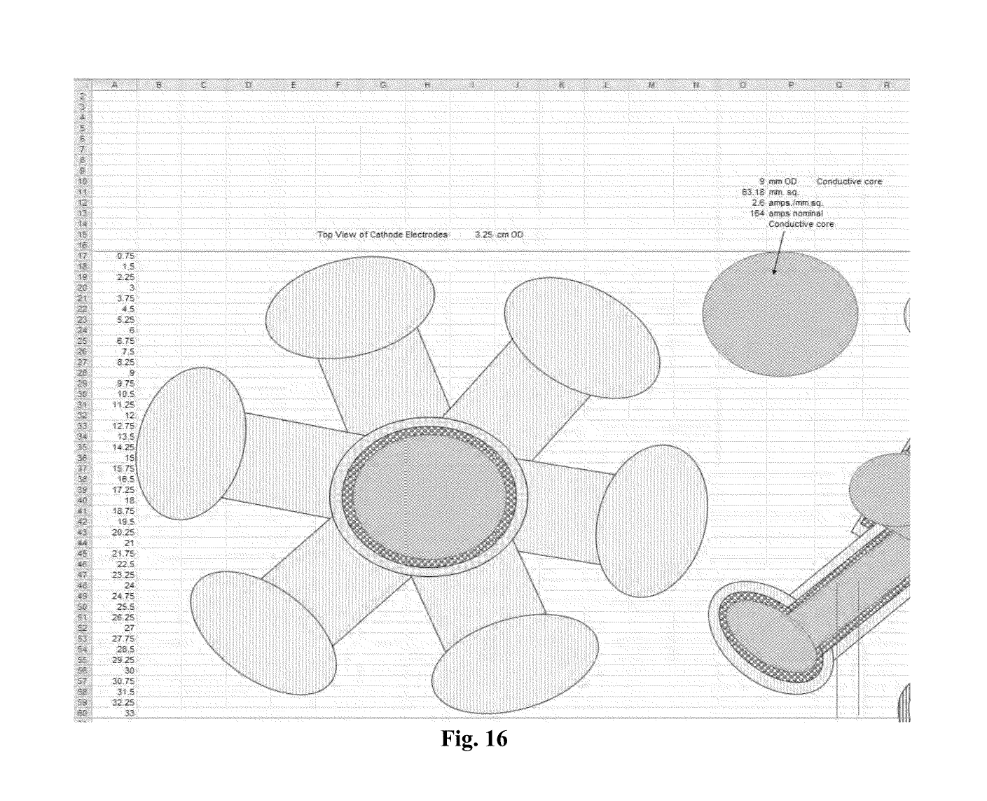

FIGS. 12-13 provide both pictorial and datastrative representations for suspended connector particles incorporated into and occupying interspacing between a plurality of octagonal electrode stacked sequences. Exemplary parameters for connector particles are provided in FIG. 12 with reference to illustrative embodiments of the connector particles provided in FIG. 13. The connector particles are preferably suspended in a fluid body such as an electrolyte occupying the interspacing between the octagonal electrode stack sequences illustrated for example, in FIG. 10. The connector particles may also be used in any other illustrative embodiments for the one or more electrode stack and battery configurations of the present invention. FIGS. 14-15 provide both illustrative and datastrative representations for octagonal shaped electrodes stacking sets. FIG. 14 is representative of a 10 row 80 electrode stack configuration according to an exemplary aspect of the invention. Adjacent rows may be interconnected by one or more connector elements. Fluid suspended connectors may also be used such as previously described and illustrated. Operative parameters for various configurations of illustrative embodiments shown in FIG. 14 are provided in FIG. 15. According to one configuration, electrode stacks are configured and include operating parameters and constituent configurations resulting in an electrolyte conversion efficiency in excess of 50%. FIGS. 16-23 provide both pictorial and datastrative representations of an interconnected electrode structure configured according to an exemplary aspect of the invention. FIG. 16 is a pictorial representation of a 6 axis electrode shown from the perspective of a top view. Also illustrated are exemplary parameters for a conductive core of the cathode of the 6 axis electrode. Each of the six representative fingers of the 6 axis electrode extend generally outwardly from the conductive core as pictorially represented in FIG. 16.

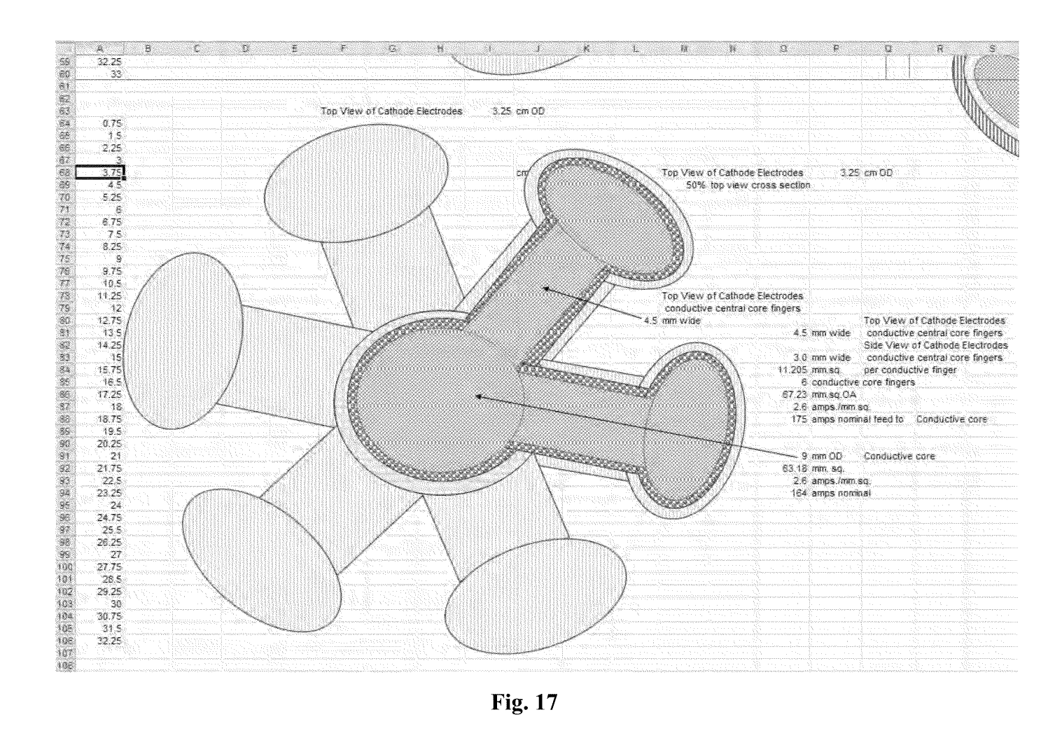

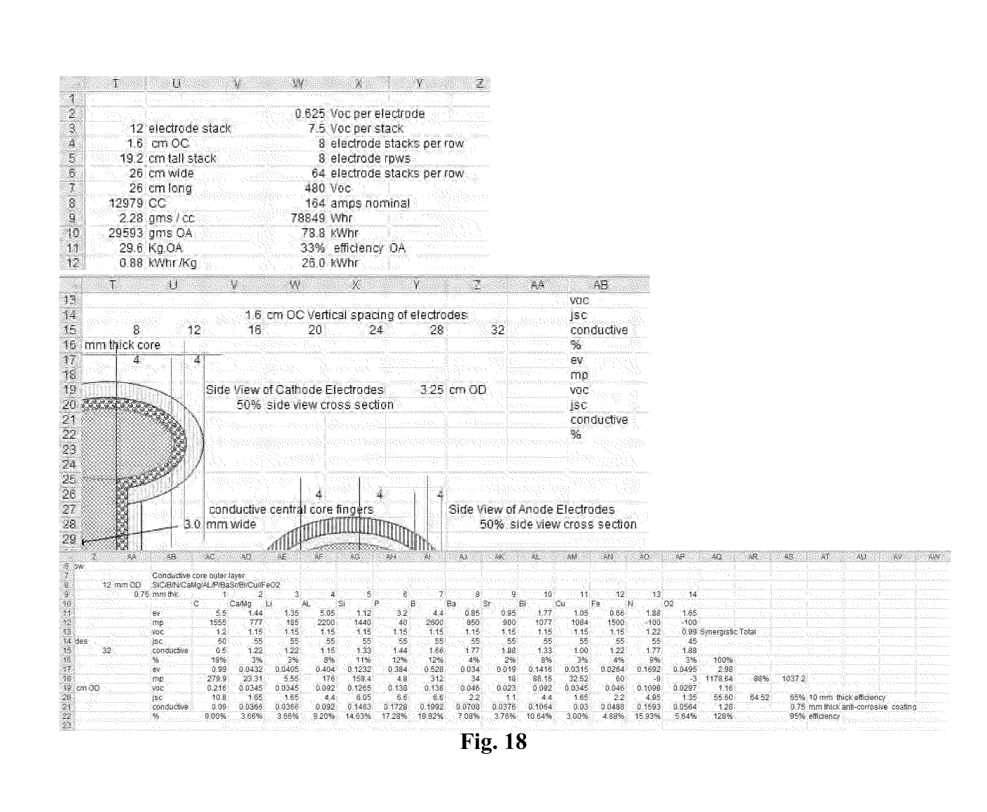

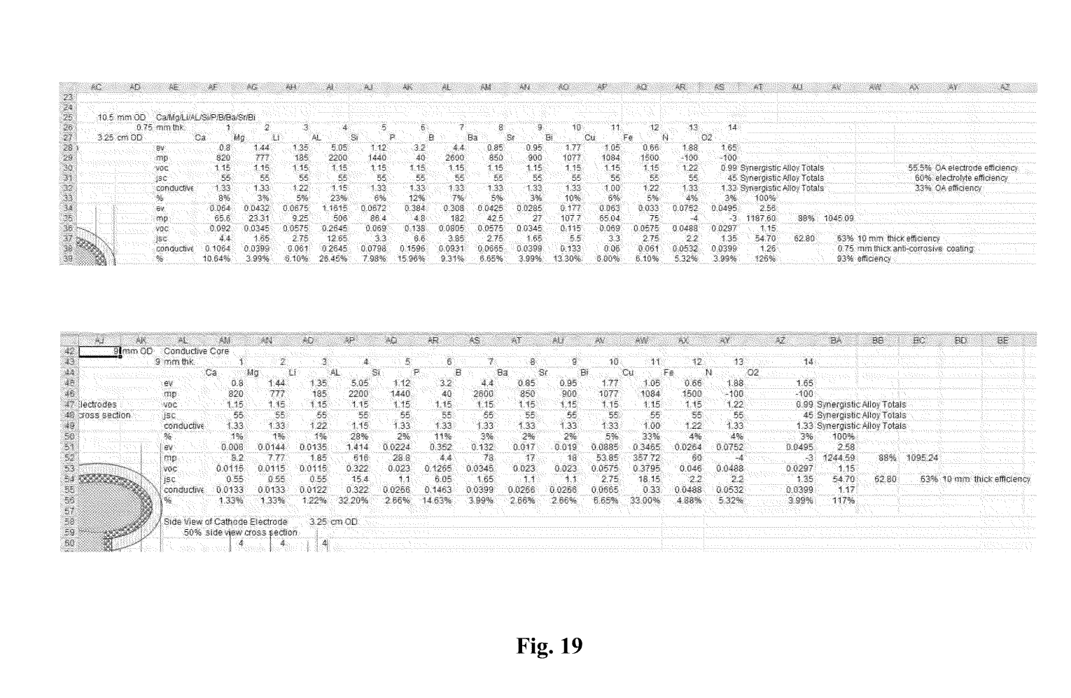

FIG. 17 provides a pictorial representation of the conductive core connecting each of the fingers extending generally outwardly from the conductive core as illustrated by the top view of the cathode electrode shown in FIG. 17. According to one aspect, a conductive central core is enclosed within each of the fingers extending outwardly from the center of the 6 axis electrode structure. Together the core and finger represent a conductive element or a conductive axis of the interconnected electrode structure. Datastrative properties according to exemplary embodiment of the interconnected electrode structure are also provided in FIG. 17. These properties are merely for purposes of setting forth exemplary embodiments, but not for the purpose of limiting the applications of the various concepts of the invention. Further exemplary properties of the interconnected electrode structure pictorially represented in FIGS. 16 and 17 are provided in datastrative representations in FIG. 18. Covering each of the conductive figures is a conductive core outer layer having properties, for example, as datastratively represented in FIG. 18. An anti-corrosive coating may also be included as an outer layer covering each of the conductive core fingers. Examples of an anti-corrosive coating and conductive core outer layer are provided illustratively and datastratively in FIGS. 18-19.

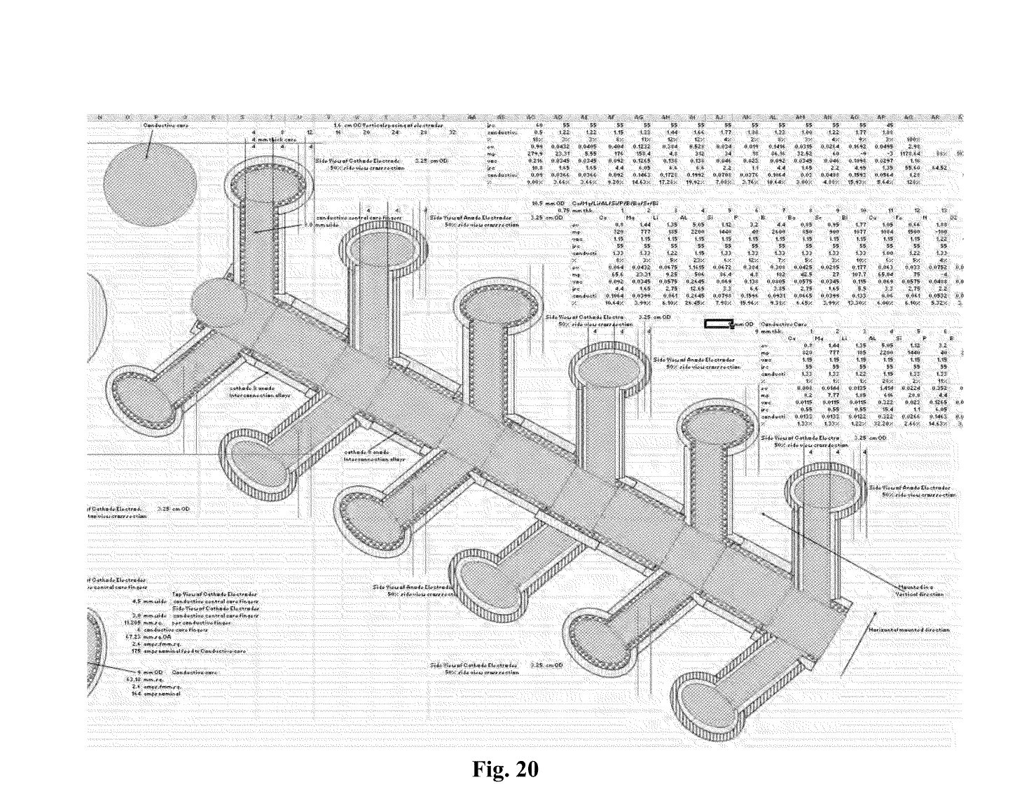

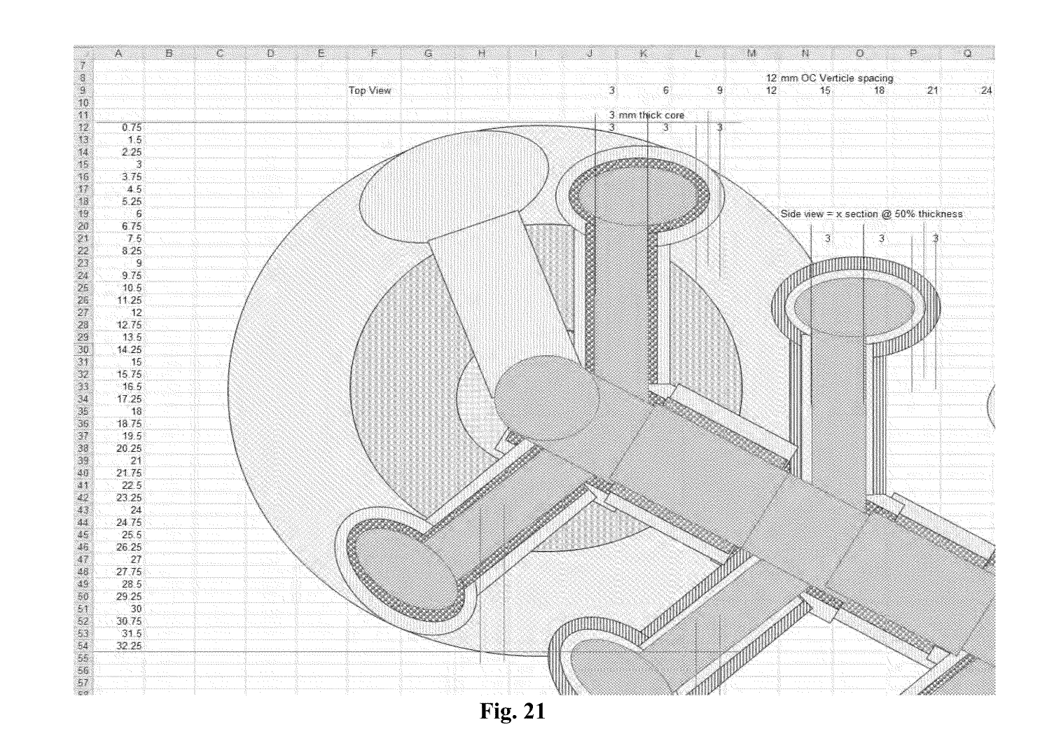

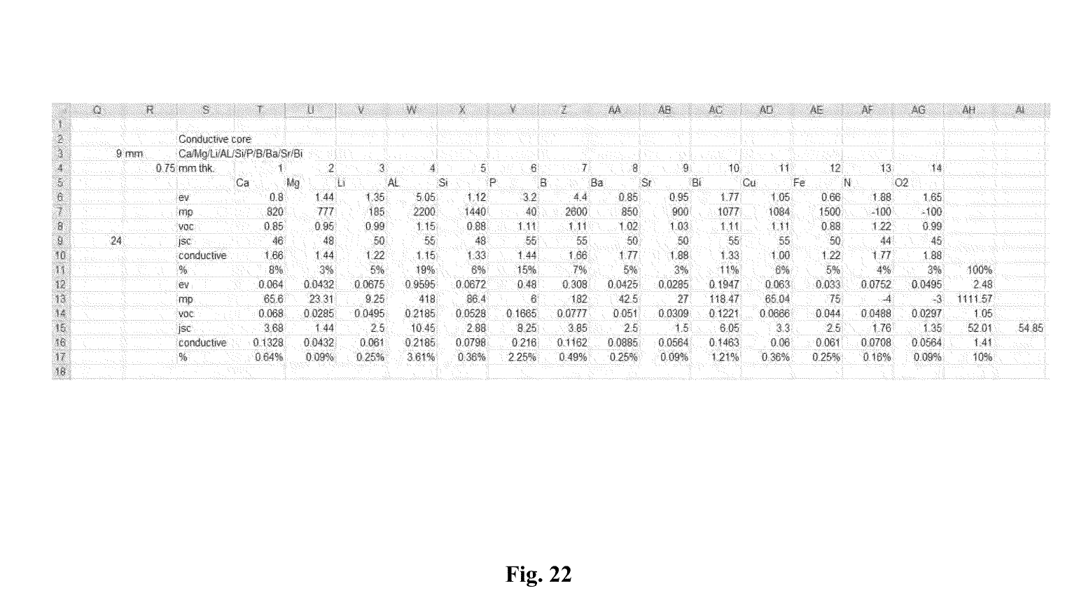

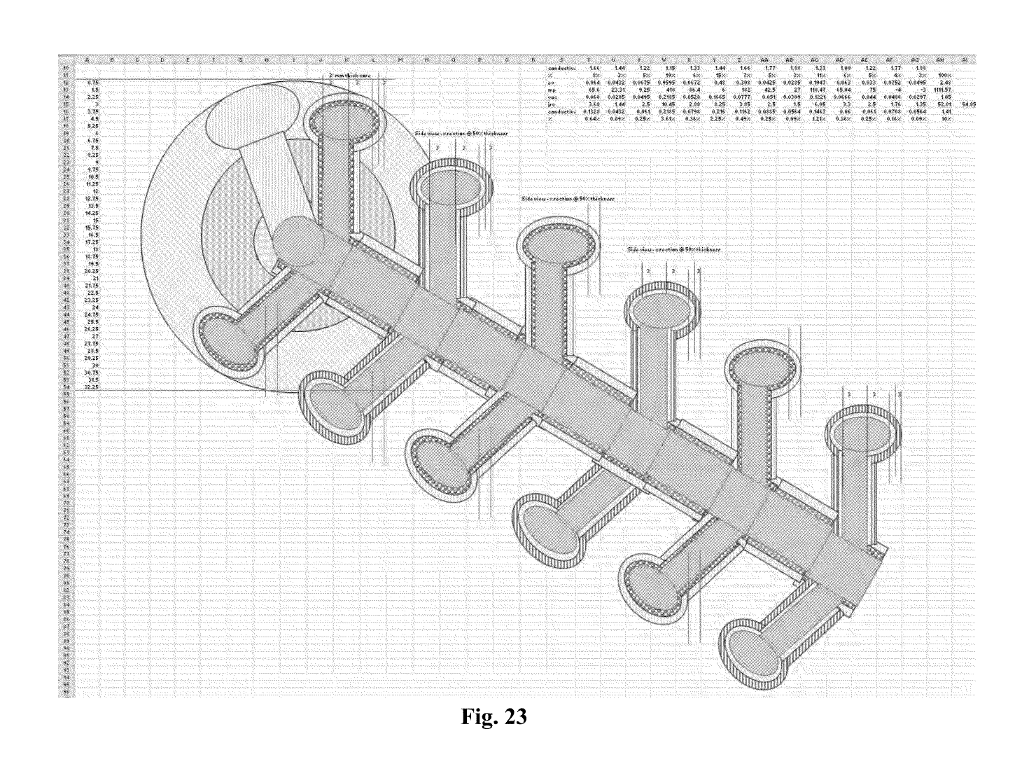

FIG. 20 is an overview illustration for a single interconnected electrode structure configured according to an exemplary and provided as an illustrative embodiment of the invention. Specifically, FIG. 20 provides a sectional view of an interconnected electrode structure for pictorially representing connectivity of the conductive core with a plurality of conductive central core fingers covered at least partially by a conductive core outer layer and optionally an anti-corrosive coating. FIG. 20 also illustrates the cathode and anode interconnection alloys or elements used to interconnect the cathode and anode elements of the interconnected electrode structure. The present invention contemplates that the conductive core outer layer and even optionally the anti-corrosive coating may be configured differently between the anode and cathode conductive central core fingers as pictorially represented in FIG. 20. Optional constituents comprising the aforementioned elements of the electrode structure are datastratively represented in FIG. 20 for providing exemplary configurations and material combinations for embodiments of the anode and cathode electrode elements of the interconnected electrode structure. An optional embodiment of the cathode electrode structure is pictorially represented in FIGS. 21-23. For example, it is best illustrated in FIGS. 21 and 23 an extended service configuration of the interconnected electrode structure is provided. Datastrative properties of the extended service interconnected electrode structure are provided in part in FIG. 23 and largely represented in FIG. 22. For example, selected constituents of the conductive core are represented in a chart in FIG. 22. Test parameters for each of the selected constituents according to an applied theoretical rationale of the present invention are also datastratively illustrated. Further considerations include altering the thickness of an outer layer such as the anti-corrosive coating or the conductive core outer layer as pictorially and datastratively represented in FIG. 18. Further, the conductive central core fingers may be optimized to provide and meet one or more of the objectives of the present invention.

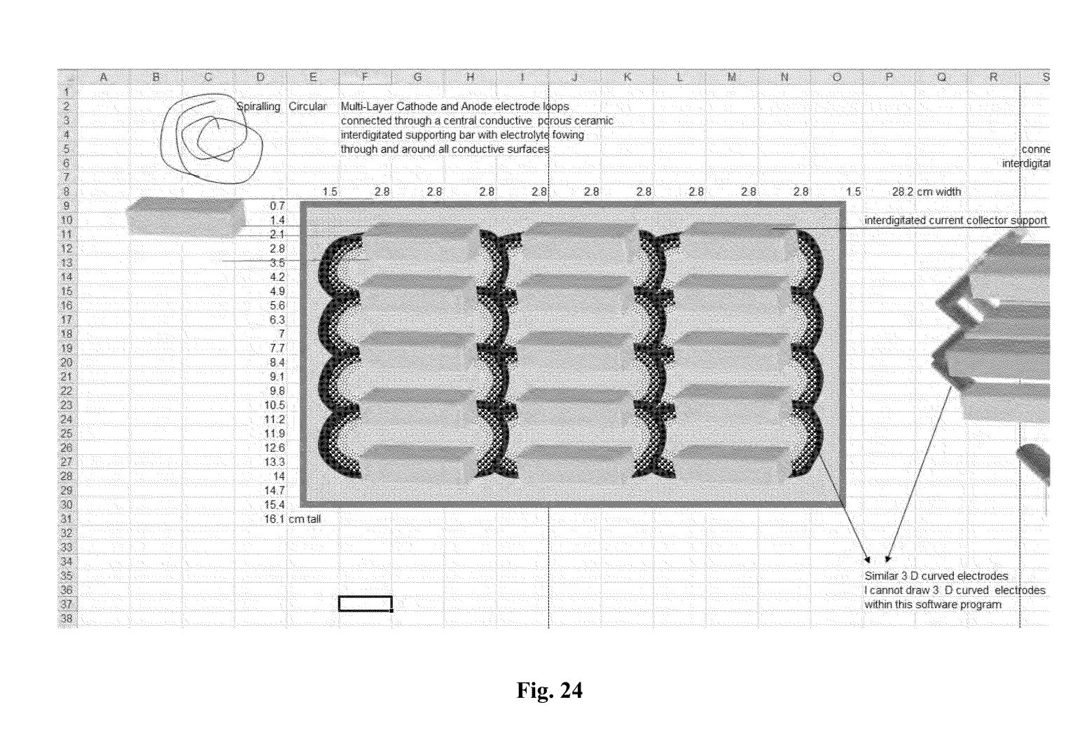

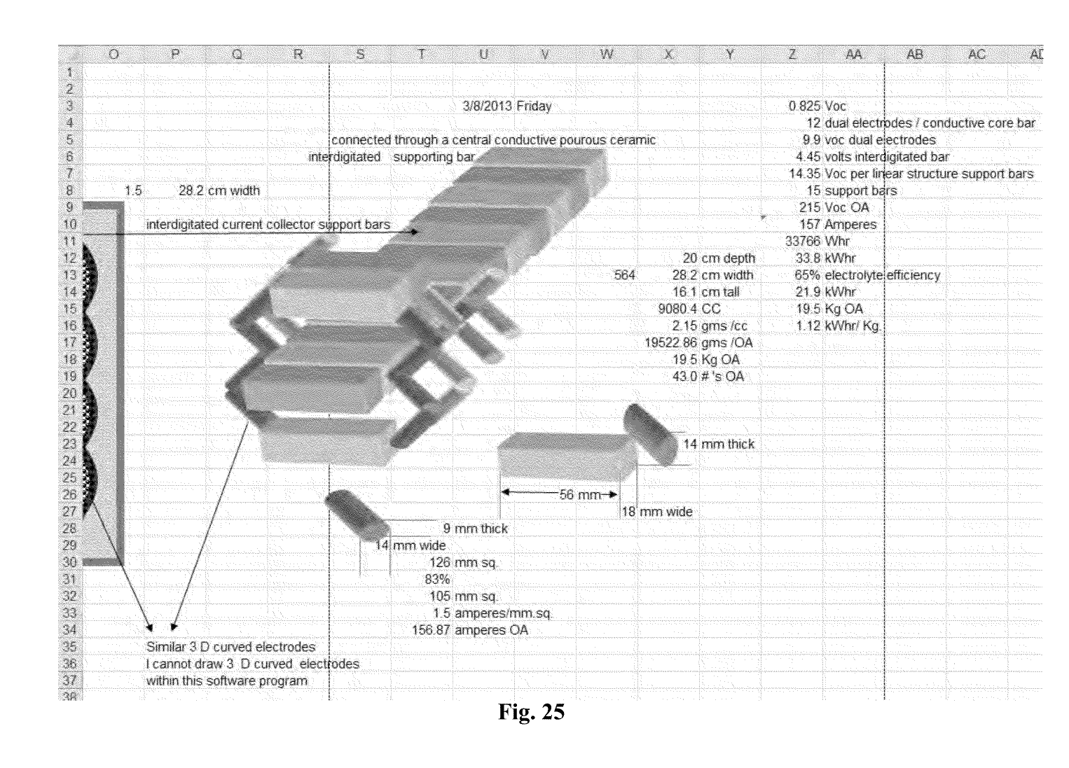

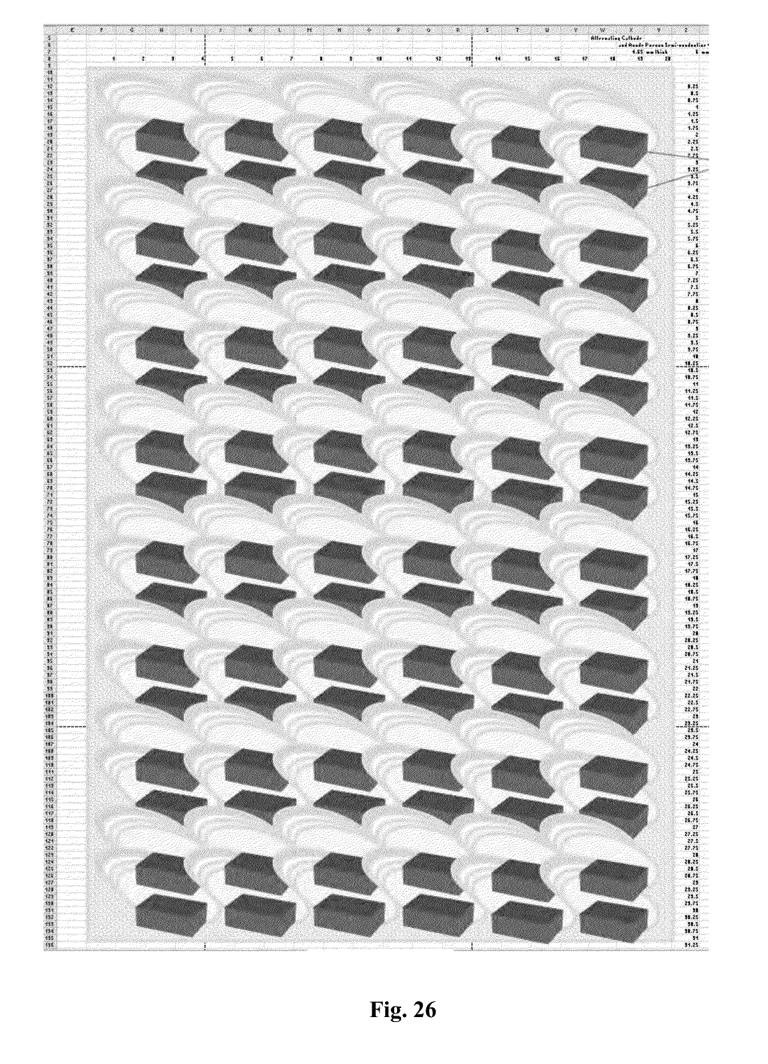

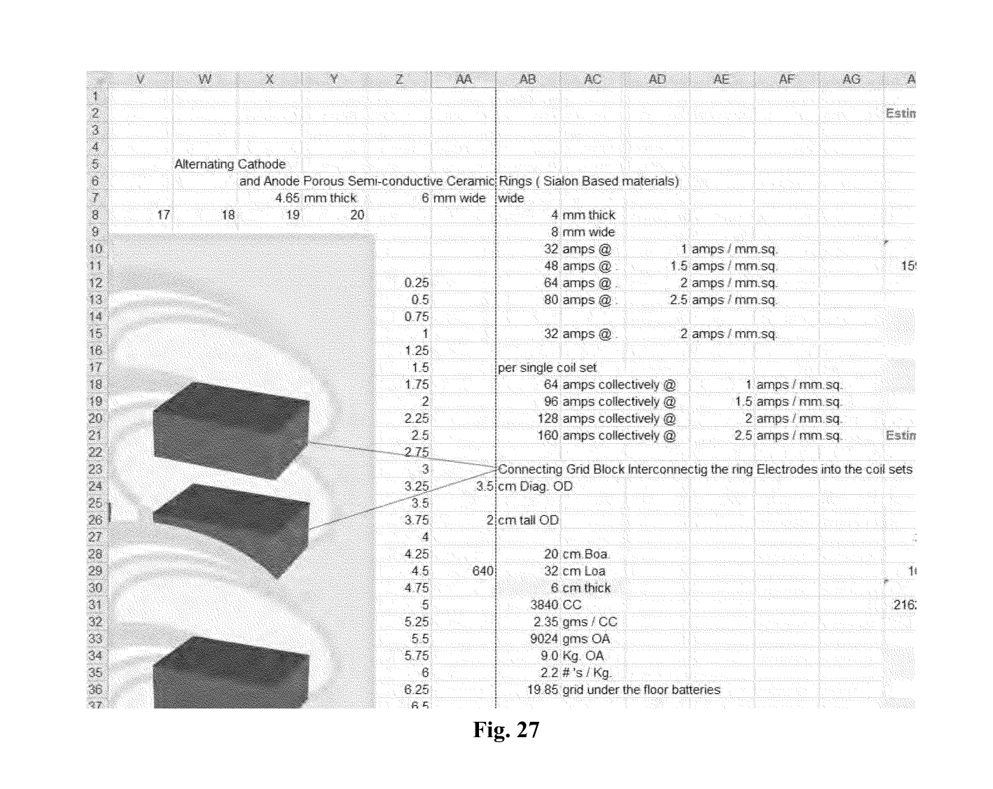

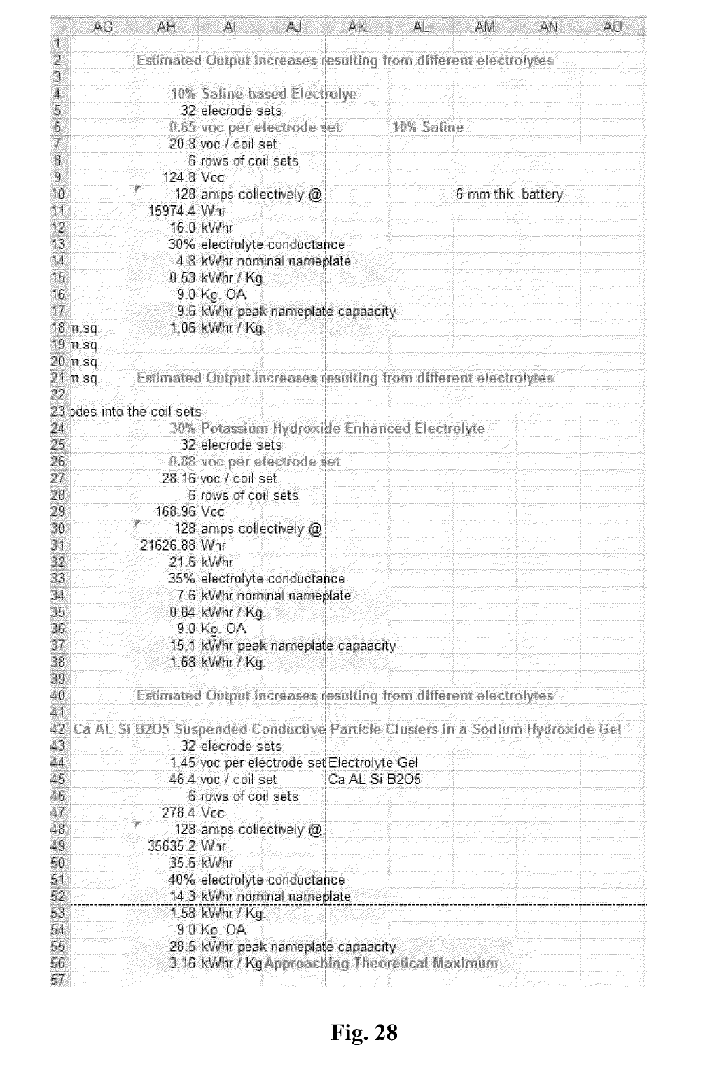

FIGS. 24-28 provide both pictorial and datastrative representations for multi-layer cathode and anode electrode loops representative of an exemplary aspect of the present invention. As shown in FIG. 24, the electrode loops are connected through a central conductive porous ceramic interdigitated supporting bar with electrolyte flowing through and around the conductive surfaces. Each collector is supported at least in part by an interdigitated current collector support. The interdigitated current collector supports may be curved, rounded, elliptical, square, arcuate or any like shape. One example of the interdigitated current collector support bars is pictorially represented in FIG. 25. Operating parameters relating to the interdigitated collector support bars is also datastratively illustrated in FIG. 25. The electrodes are represented by a rectangular block shape but may be shaped in any manner as shown and described herein or like geometry. FIGS. 26 and 27 illustrate pictorially another exemplary configuration for multi-layer cathode and anode electrode loops. FIG. 26 provides a representation of a number of cathodes and anodes connected by the electrode loops, such as how a plurality of these may be configured within a battery or the like. A detailed view of the connecting electrode loops is represented pictorially and datastratively in FIG. 27. The loops may comprise alternating cathode and anode porous semi-conductive ceramic rings. One exemplary constituent for fabricating these ceramic rings may include, for example, sialon-based materials. The alternating cathode and anode porous semi-conductive ceramic rings form a connecting grid block interconnecting the ring electrodes into the coil sets as illustrated. Operating parameters are provided datastratively in FIG. 28 for exhibit exemplary properties, such as estimated output, for different electrolytes used in a multi-layer cathode and anode electro loop formed by alternating cathode and anode porous semi-conductive ceramic rings. This may include, in addition to the electro loops including suspended conductive particle clusters in the fluid body such as datastratively represented in FIG. 28.

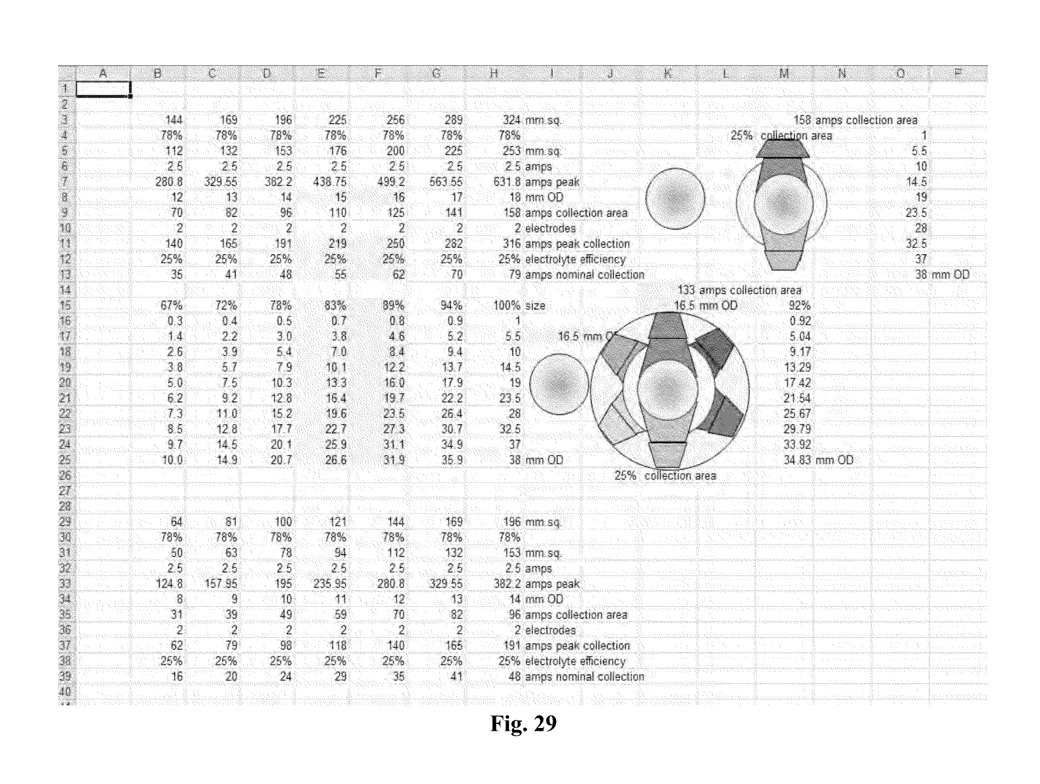

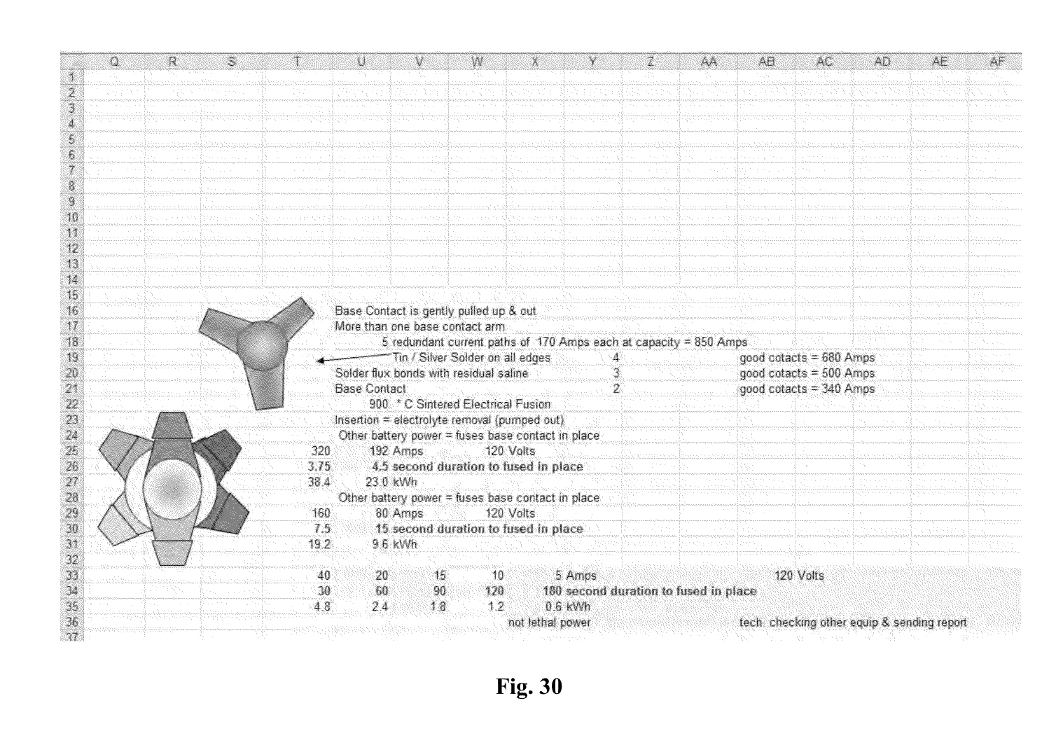

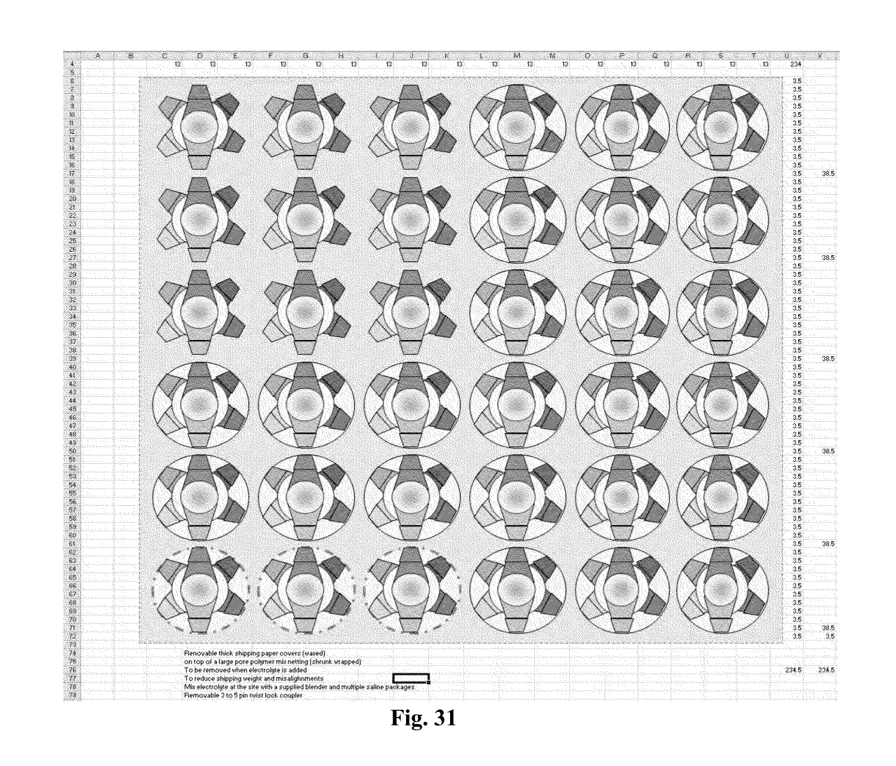

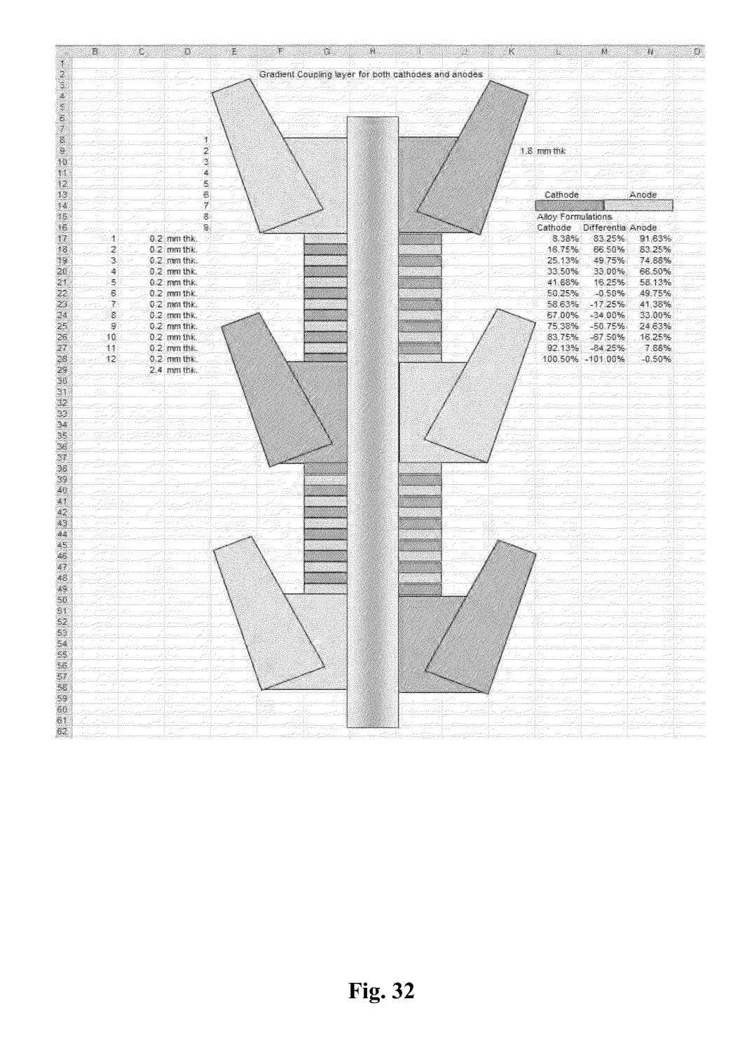

FIGS. 29-32 provide pictorially and datastratively representations of stacked electrode replaceable type packs with LED's for each stack. A representative version of a stack is shown in FIG. 29 and FIG. 32 and supported datastratively by representations of parameters for providing the same. Each or a plurality of each of the stacked electrodes may be configured for transportation to a point of assembly and/or use. Packs of the replaceable stacked electrodes may be assembled as pictorially represented in FIG. 31. A gradient coupling layer for both cathodes and anodes is pictorially represented in FIG. 32. Layers are stacked one on top another and interconnected by a conductive element or rod. Outwardly extending fingers are connected with the core or the rod and spaced apart by coupling layers for both cathodes and anodes.

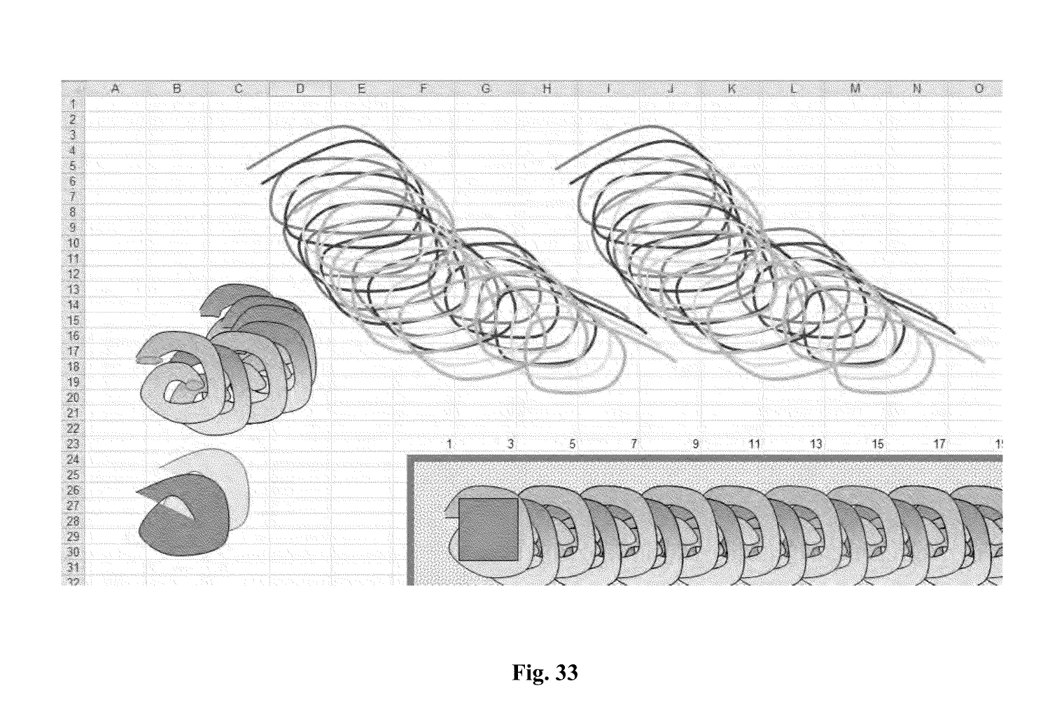

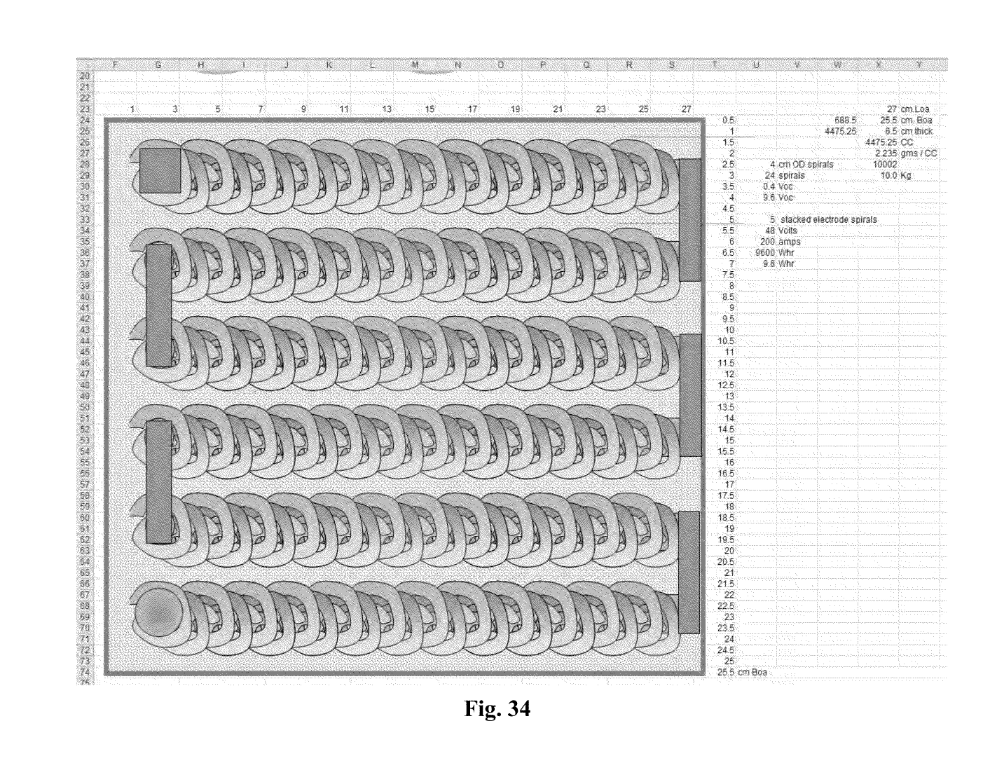

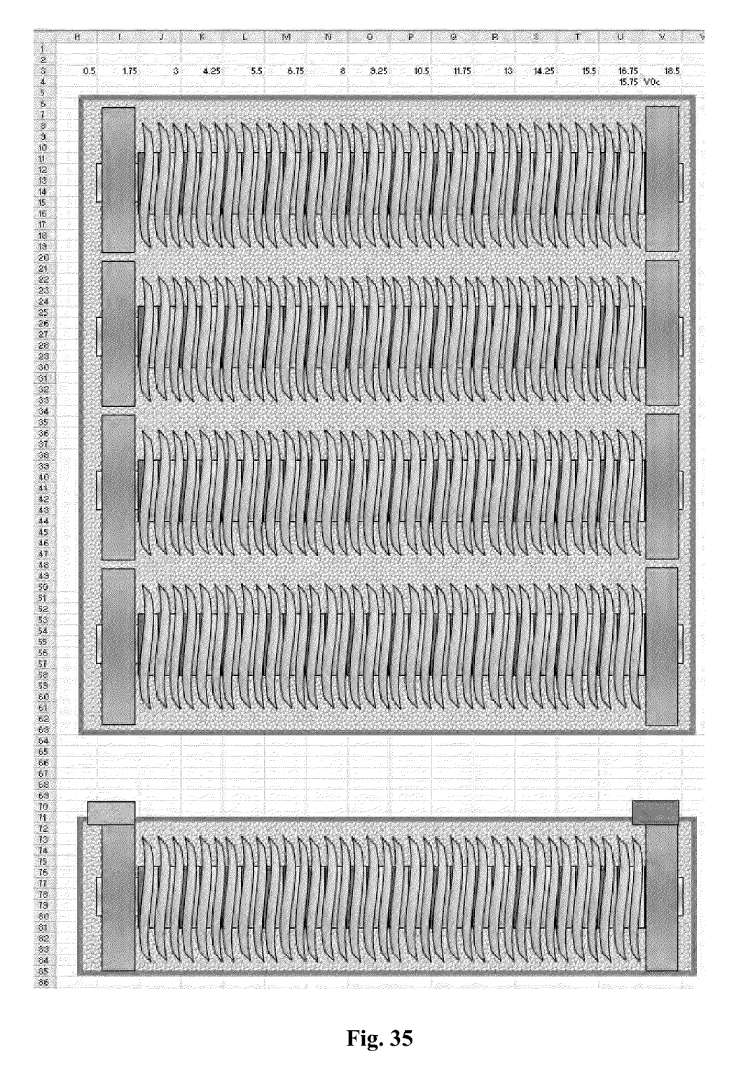

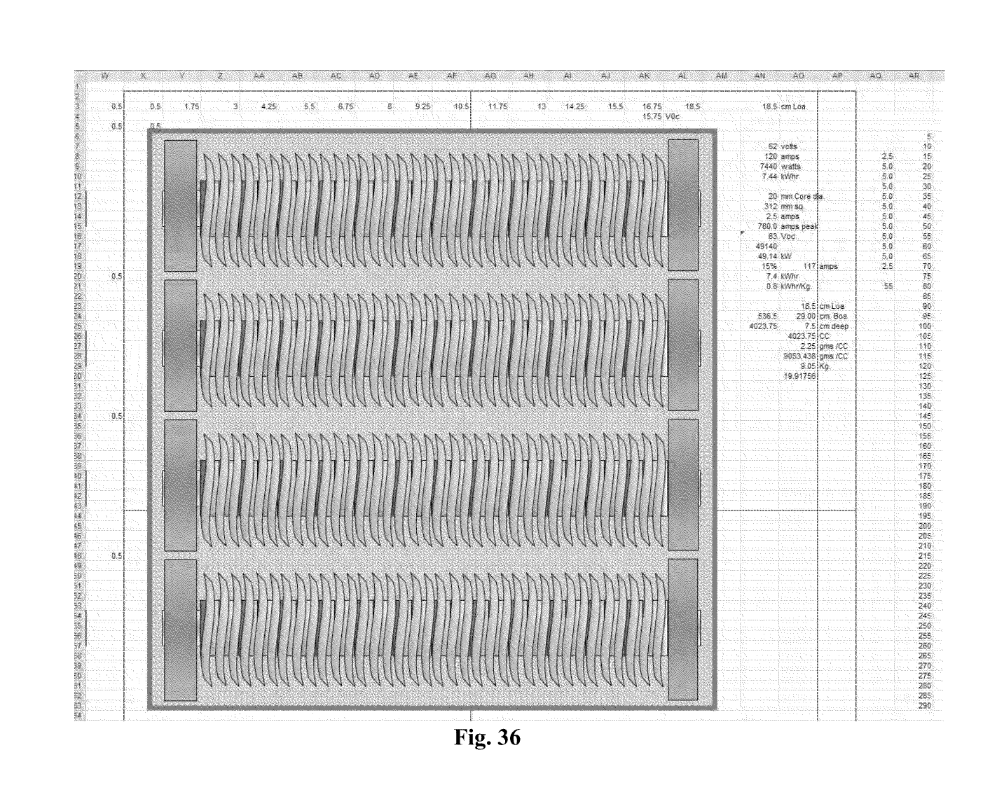

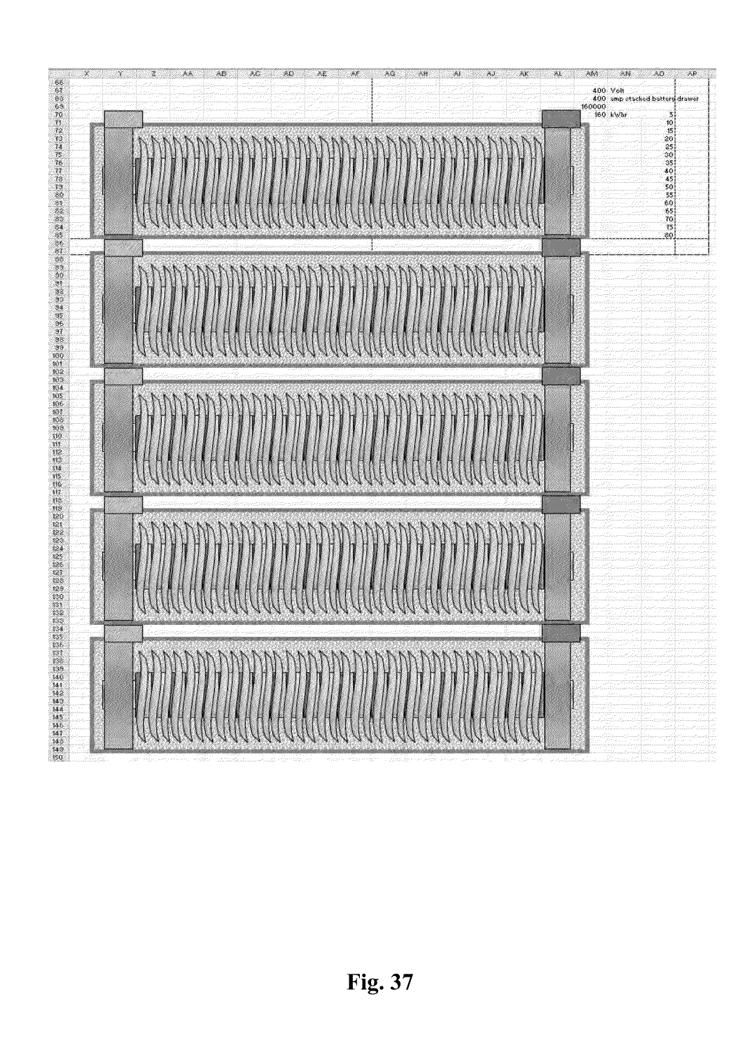

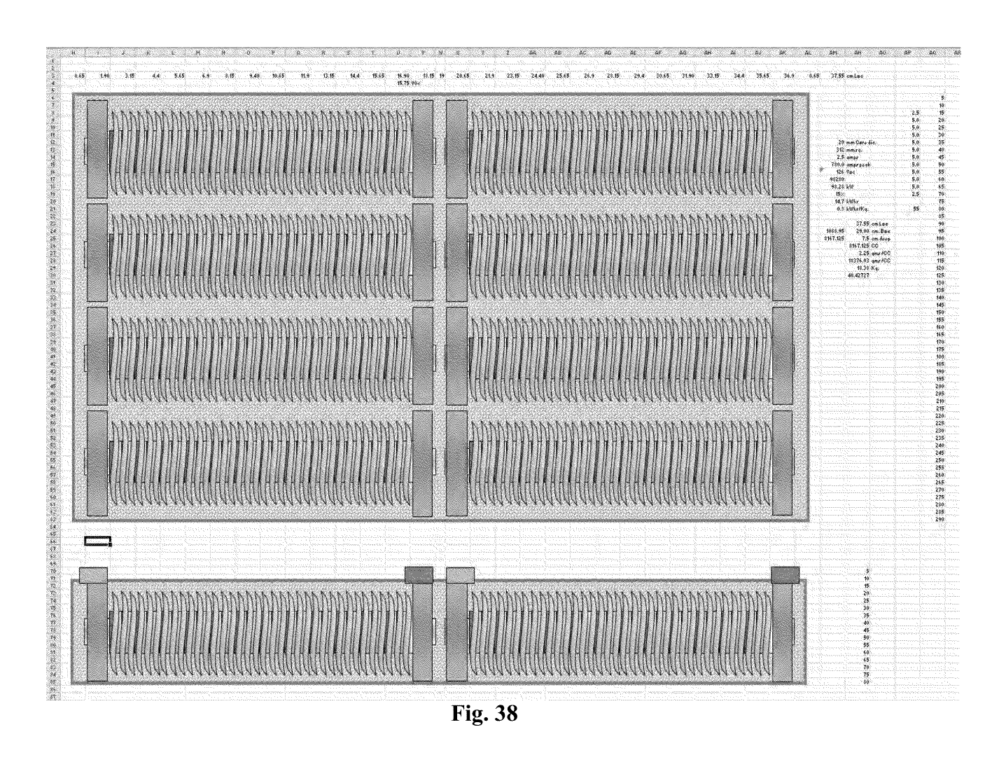

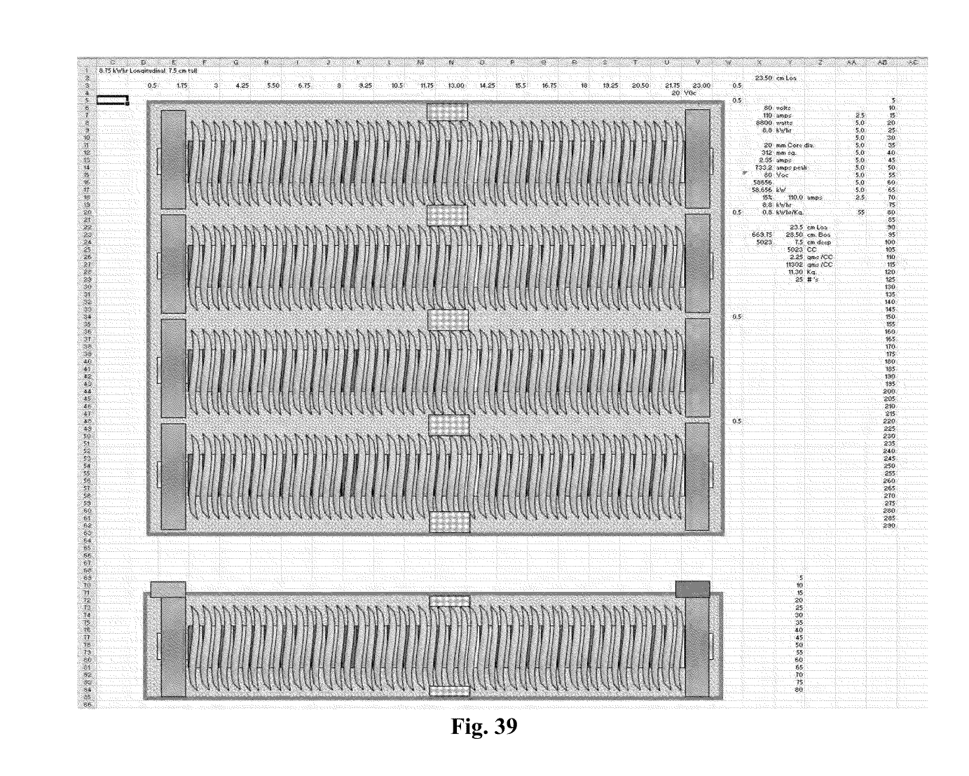

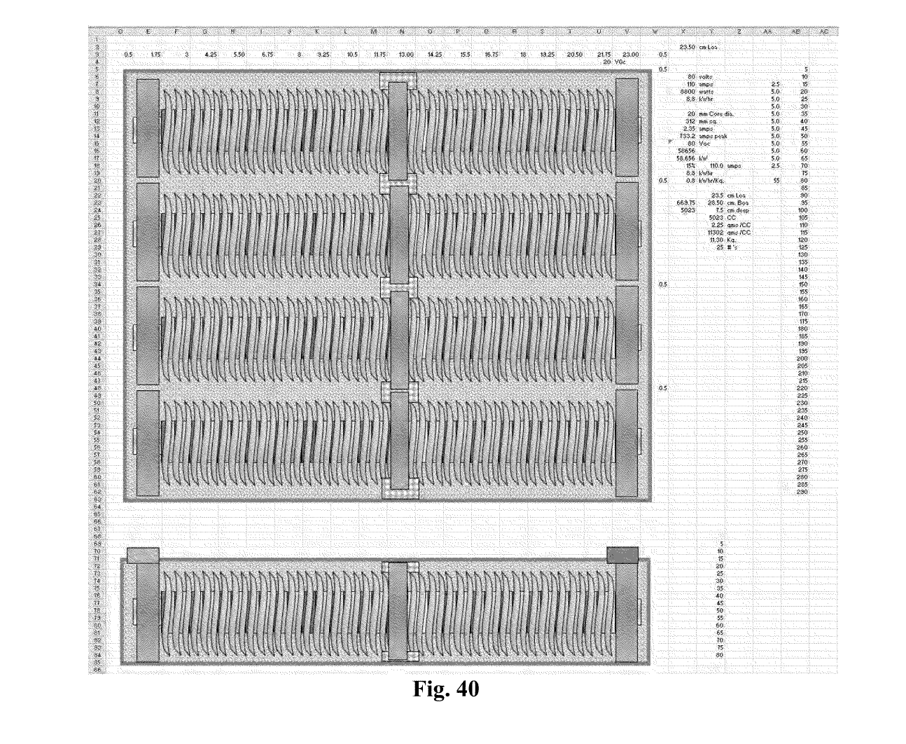

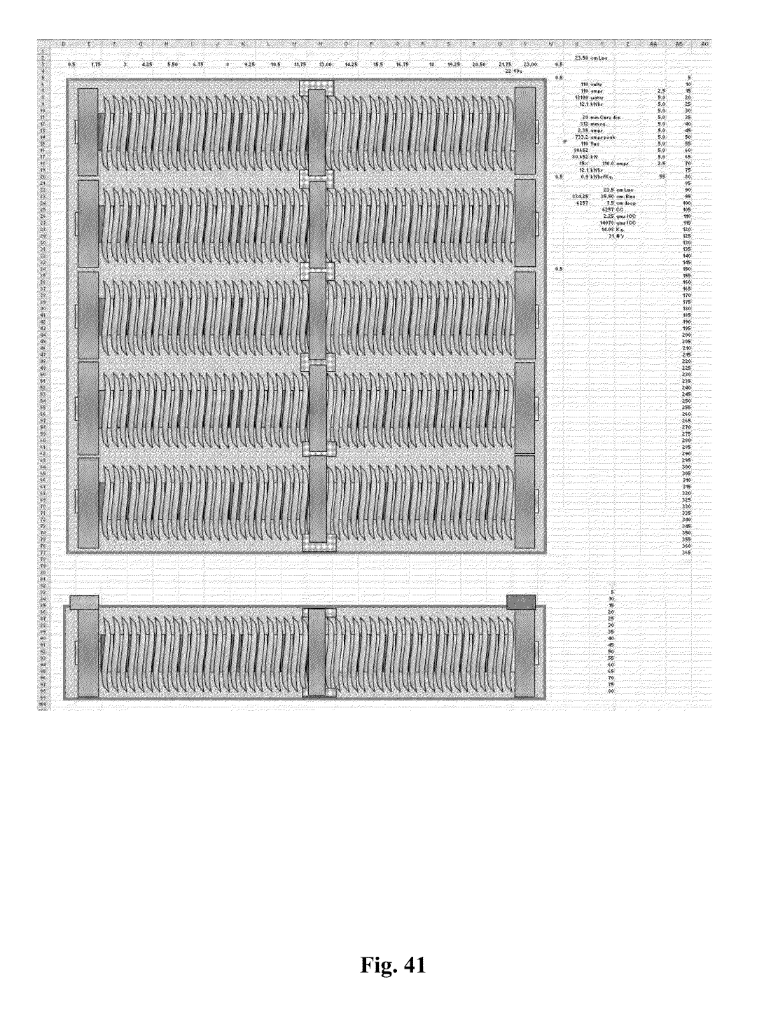

FIGS. 33-34 provide pictorial representations of spiral oval coil electrodes according to an exemplary aspect of the invention. The stacked electrode spirals are interconnected by a connector element for connecting each of the stacked electrode spirals in series with each other. These spirals may also be connected in parallel with each other depending upon the desired configuration and orientation of the electrode spirals. The stacked electrode spirals are placed within a fluid body, such as an electrolyte fluid body, that may include one or more conductive particles suspended in the fluid bed or body. The electrode spirals or coils may represent one or more cathodes or one or more anodes spun together along an electrode spiral creating a stack spaced between interconnective elements. Datastrative properties and parameters are provided in FIG. 34 for an embodiment of a five stack electrode spiral of the present invention. FIGS. 35-41 provide pictorial representations of a stacked electrode configuration of the present invention. A plurality of electrodes are stacked along a column or row and interconnected by a connective element. The stacked elements are designed, according to one aspect of the invention to be portable, assembled and operable to replace, for example, a stacked electrode set that needs repaired or its service life is expired. Pictorial representations of the stacked electrodes configured within a housing such as a battery housing and immersed in a fluid body such as an electrolytic solution are shown. The solution may include for example conductive particle clusters suspended in the fluid body. Each stacked electrode may terminate in a connector whereby stacked electrodes are connected in series or parallel, in rows or in columns. Datastrative properties for each of the stacked electrodes and configurations are provided and represented in each of the figures. The battery housing may be configured with features such as connectors shaped to receive one or more of the electrode replacements. Upon expiration of the service life of the one of the electrodes, it may be replaced with one of the stacked electrode embodiments pictorially represented in the figures. Furthermore, a battery of varying size of capacity may be assembled onsite by shipping the components separately and having certain components at the onsite location be added at the time of assembly. For example, an electrolytic solution may be added to the assembled battery having the stacked electrode replacements or stacked electrode components assembled and placed within the cavity of the battery housing. Stacked electrodes are connected together with connective elements and submersed in an electrolytic solution. Other components such as those previously described may also be packaged and sent to the assembly site for inclusion in one or more designs of a battery.

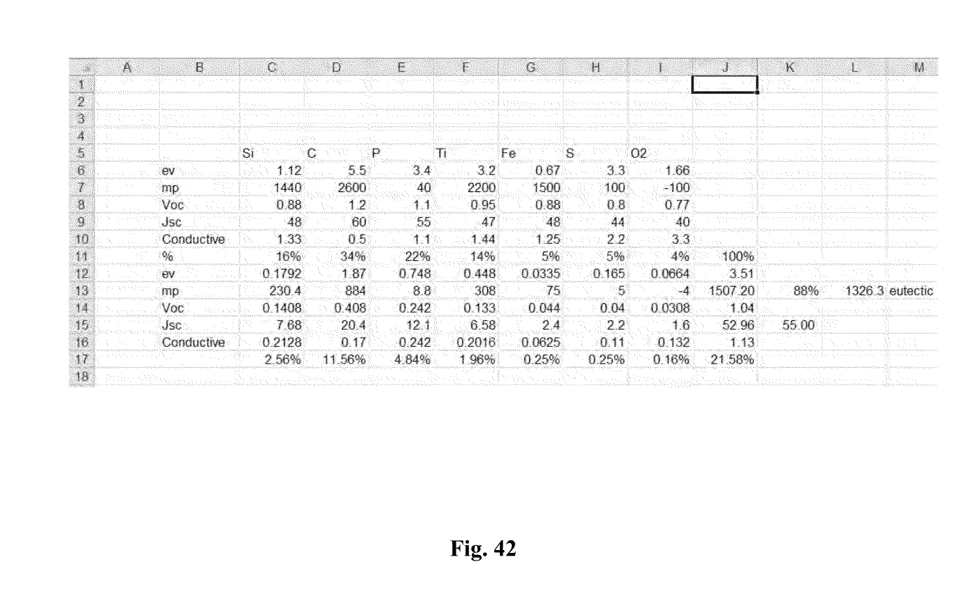

FIG. 42 provides a datastrative representation of properties for various elements and components of a design of the present invention.

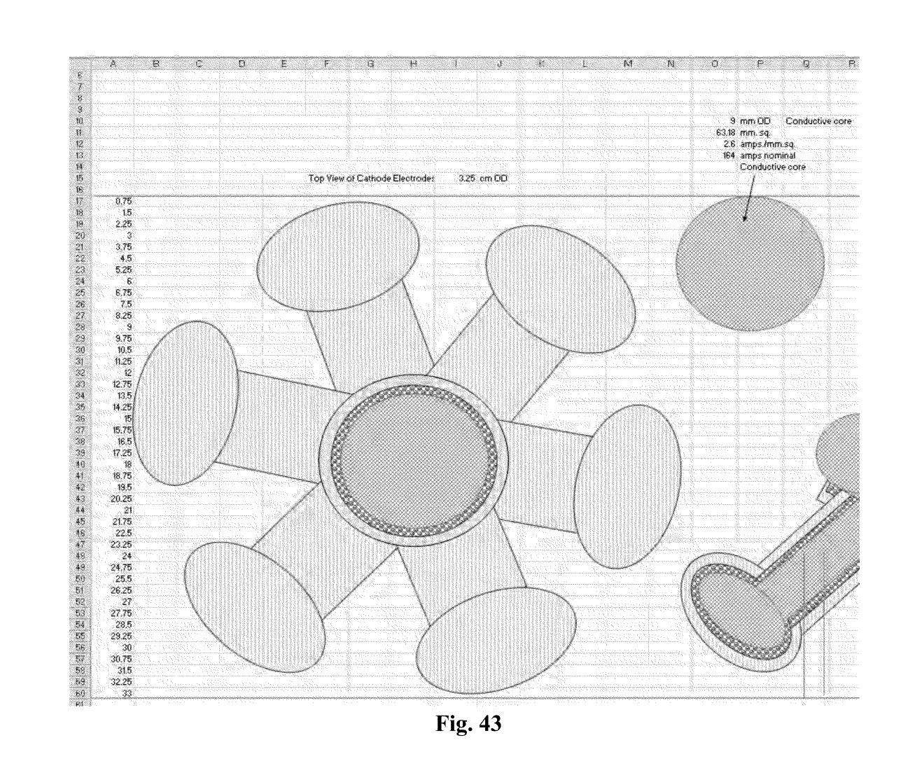

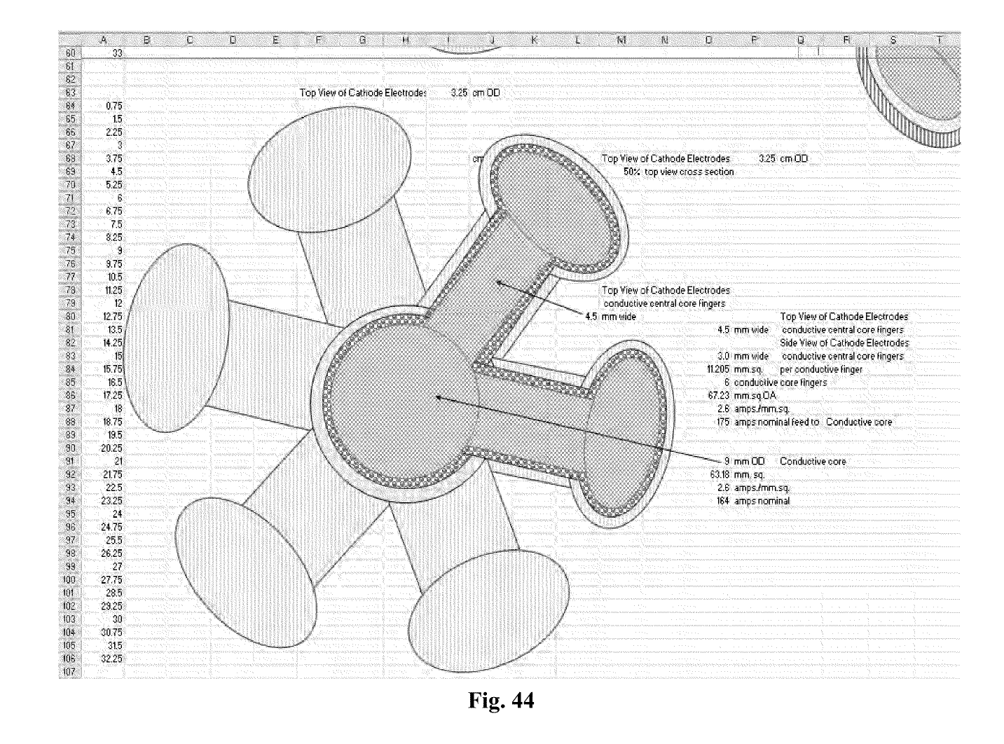

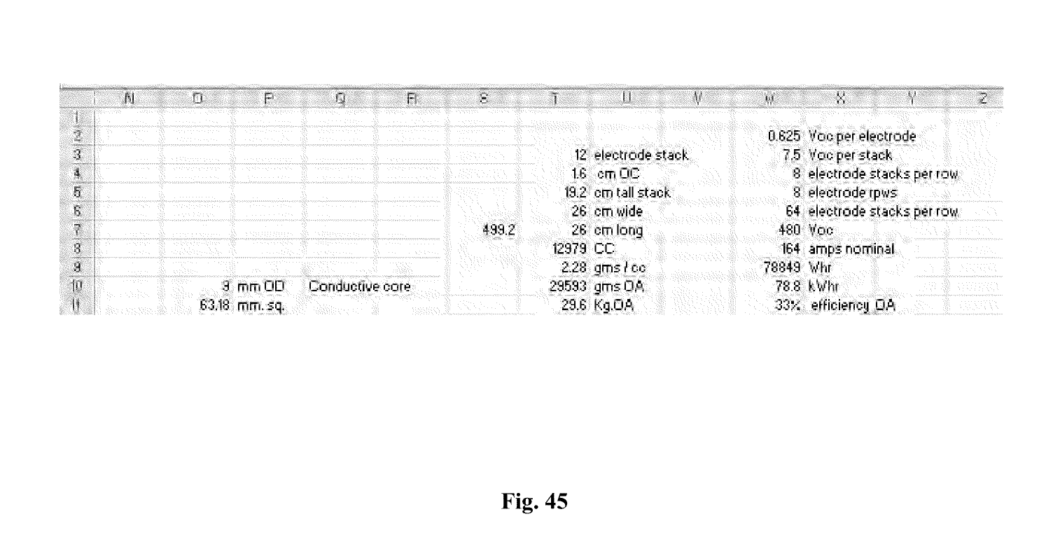

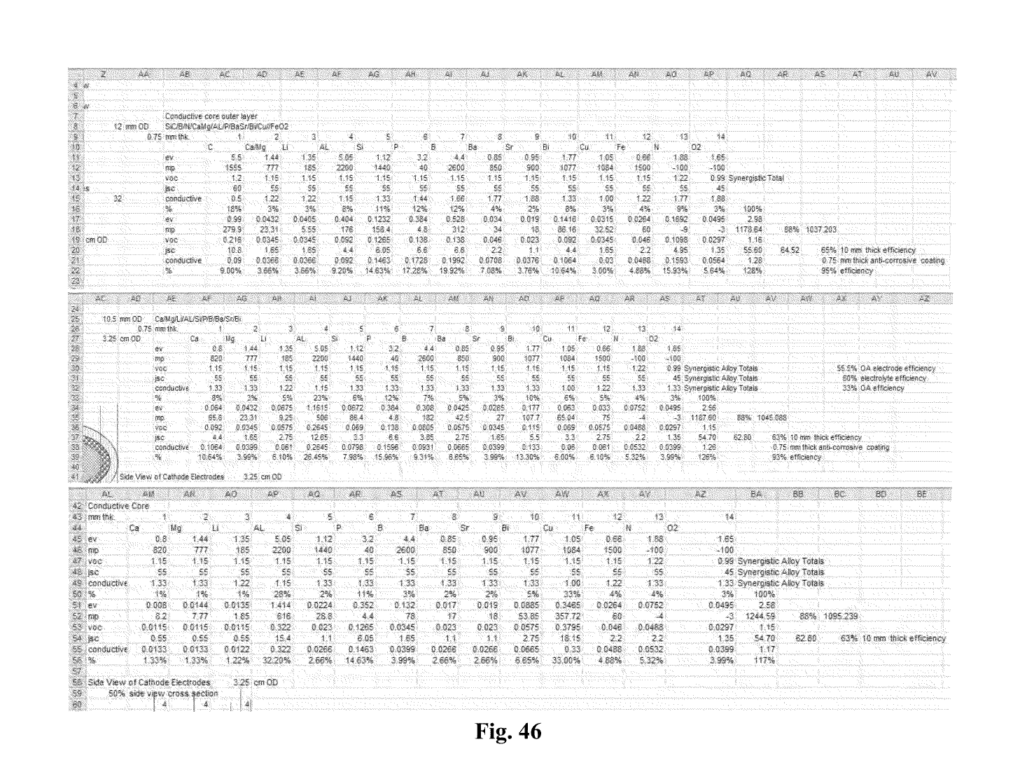

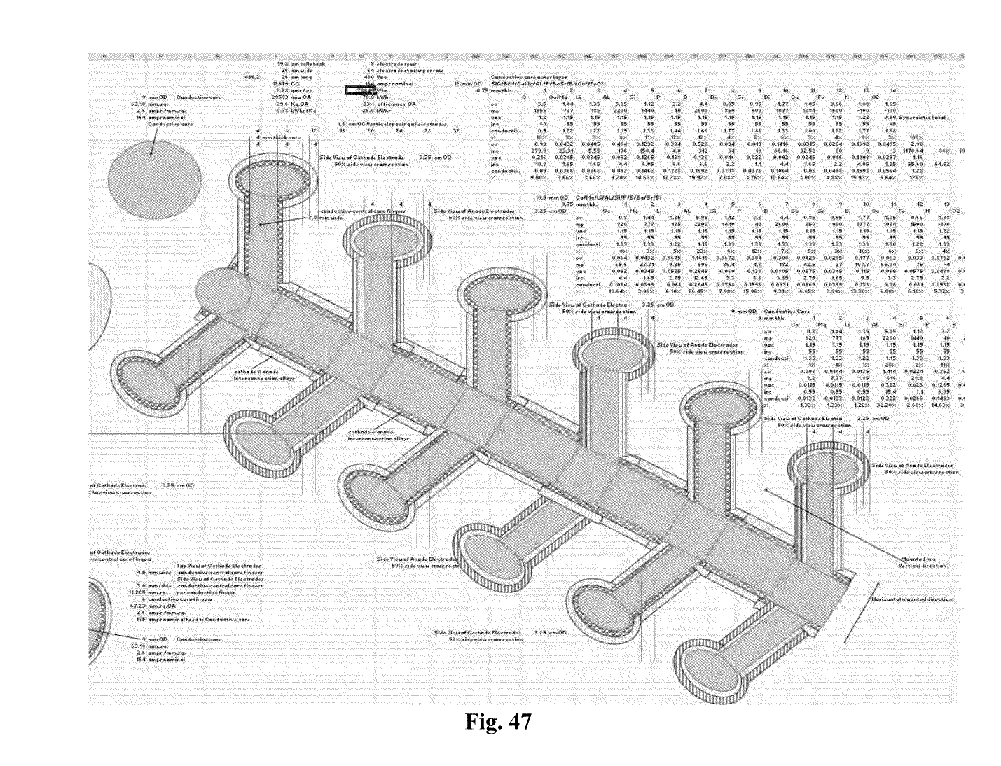

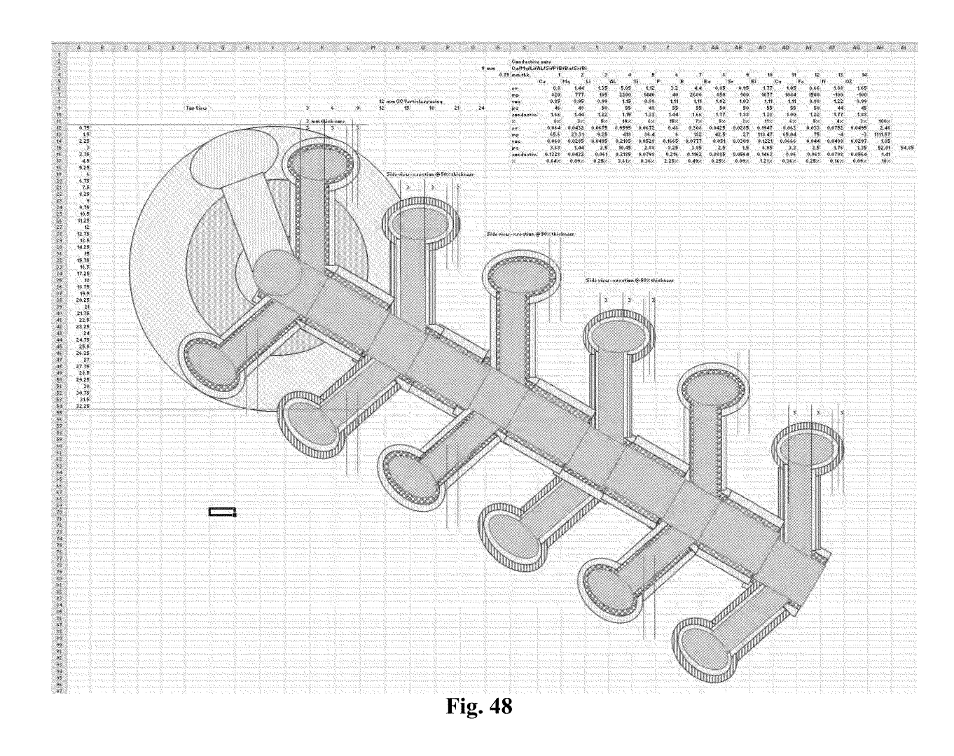

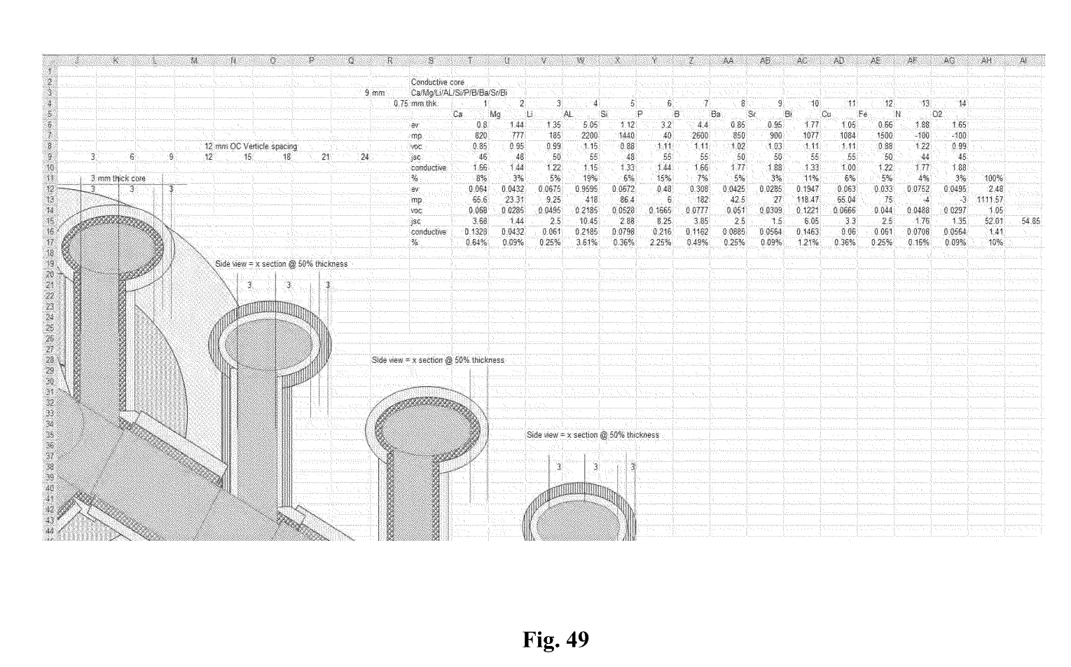

FIGS. 43-49 are pictorial and datastrative representations of a 6 axis electrode structure configured according to an embodiment and configuration of the 6 axis electrode configuration shown for example both pictorially and datastratively in FIGS. 16-21. The figures illustrate both pictorial and datastrative representations of an interconnected electrode structure configured according to an exemplary aspect of the invention. The figures illustrate a pictorial representation of a six-axis electrode shown from the perspective of a top view. Also illustrated are exemplary parameters for a conductive core of the cathode of the six-axis electrode. Each of the six representative fingers of the six-axis electrode extend generally outwardly from the conductive core as pictorially represented in the figures. The figures illustrate a pictorial representation of the conductive core connecting each of the fingers extending generally outwardly from the conductive core as illustrated by the top view of the cathode electrode shown in the figures. According to one aspect, a conductive central core is enclosed within each of the fingers extending outwardly from the center of the six-axis electrode structure. Together the core and finger represent a conductive element or a conductive axis of the interconnected electrode structure. Datastrative properties according to exemplary embodiment of the interconnected electrode structure are also provided in the figures. These properties are merely for purposes of setting forth exemplary embodiments, but not for the purpose of limiting the applications of the various concepts of the invention. Further exemplary properties of the interconnected electrode structure pictorially represented in the figures are provided in datastrative representations in the figures. Covering each of the conductive figures is a conductive core outer layer having properties, for example, as datastratively represented in the figures. An anti-corrosive coating may also be included as an outer layer covering each of the conductive core fingers. Examples of an anti-corrosive coating and conductive core outer layer are provided illustratively and datastratively in the figures. The figures illustrate an overview illustration for a single interconnected electrode structure configured according to an exemplary and provided as an illustrative embodiment of the invention. Specifically, the figures provides a sectional view of an interconnected electrode structure for pictorially representing connectivity of the conductive core with a plurality of conductive central core fingers covered at least partially by a conductive core outer layer and optionally an anti-corrosive coating. The figures also illustrate the cathode and anode interconnection alloys or elements used to interconnect the cathode and anode elements of the interconnected electrode structure. The present invention contemplates that the conductive core outer layer and even optionally the anti-corrosive coating may be configured differently between the anode and cathode conductive central core fingers as pictorially represented in the figures. Optional constituents comprising the aforementioned elements of the electrode structure are datastratively represented in the figures for providing exemplary configurations and material combinations for embodiments of the anode and cathode electrode elements of the interconnected electrode structure. An optional embodiment of the cathode electrode structure is pictorially represented in the figures. For example, it is best illustrated in the figures an extended service configuration of the interconnected electrode structure is provided. Datastrative properties of the extended service interconnected electrode structure are provided in part in the figures and largely represented in the figures. For example, selected constituents of the conductive core are represented in a chart in the figures. Test parameters for each of the selected constituents according to an applied theoretical rationale of the present invention are also datastratively illustrated. Further considerations include altering the thickness of an outer layer such as the anti-corrosive coating or the conductive core outer layer as pictorially and datastratively represented in the figures. Further, the conductive central core fingers may be optimized to provide and meet one or more of the objectives of the present invention.

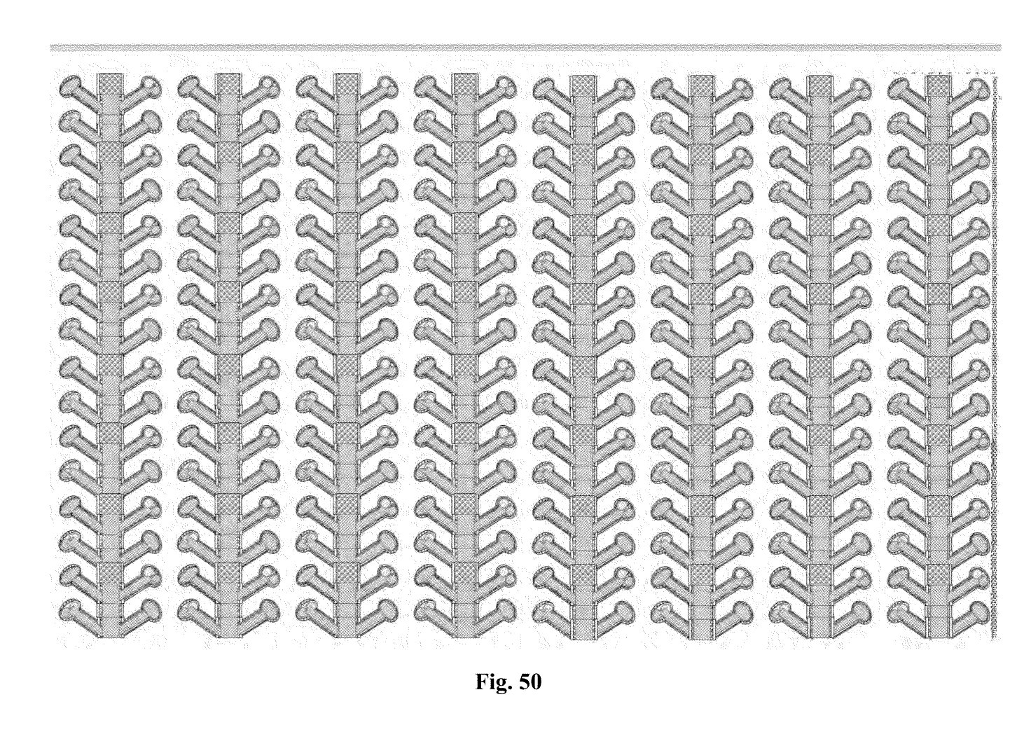

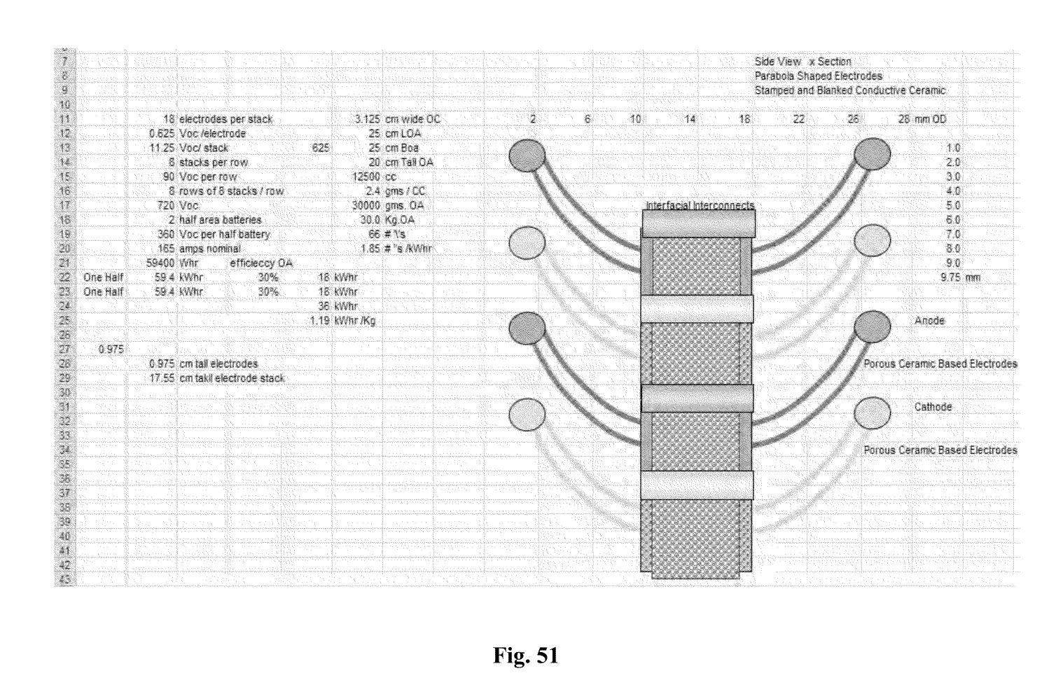

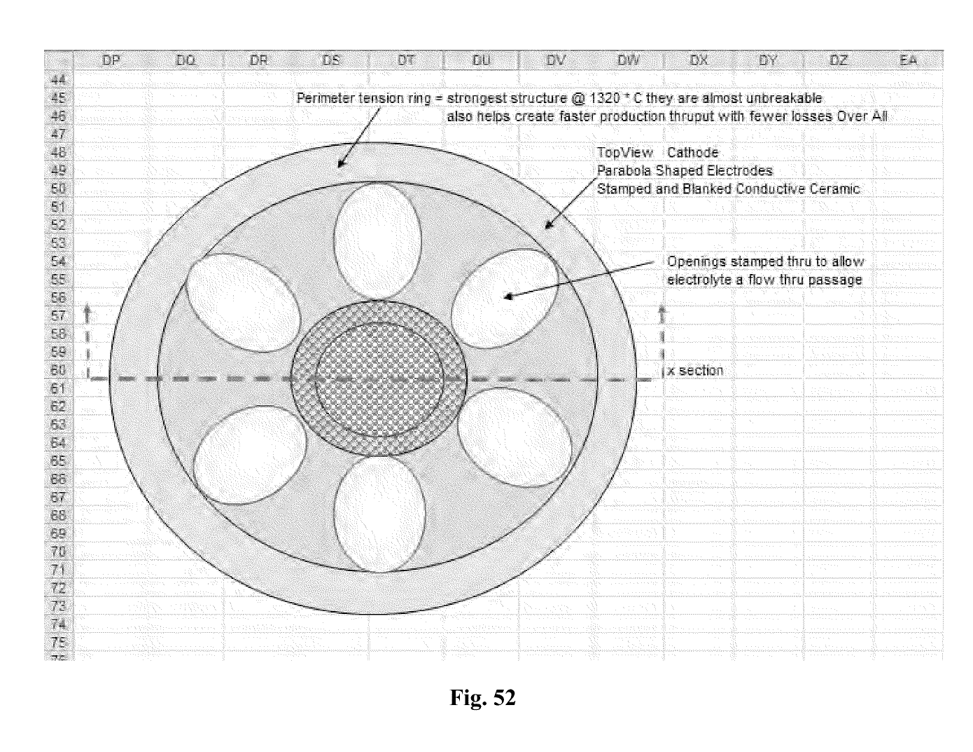

FIGS. 50-52 provide an optimal configuration of electrode structures provided by pictorial representation and supported in part by datastrative information. FIG. 50 is an overview of an 8 row six-axis stacked electrode configuration. The stacked electrode configuration may include one or more or all of the features of the aforementioned six-axis stacked electrode configuration. FIG. 51 is a pictorial representation of a side view of a parabola-shaped electrode that may be, for example, manufactured from a stamped and blanked conductive ceramic material. The parabolic-shaped electrodes are connected by interfacial interconnects. In one example of the invention, the parabolic-shaped electrodes are porous ceramic based electrodes for forming a cathode or porous ceramic based electrodes for forming an anode. Cathodes and anodes are interspaced and connected to the interfacial interconnects forming an electrode stack of a plurality of parabolic-shaped electrodes. Datastrative parameters representing operational outputs for an embodiment of the parabolic-shaped electrodes are also provided in FIG. 51. The interfacial interconnects may be supported by a conductive core, a conductive core outer layer, an optionally an anti-corrosive coating as previously discussed and described above. FIG. 52 is a section view of the electrode illustrated in FIG. 51. The section view pictorially illustrates a perimeter tensioning ring that helps create faster production throughput and fewer losses overall for the operation of the electrode. The cathode may include a parabolic-shaped electrode that stamped and blanked from a conductive ceramic material. The conductive core may include openings stamped through to allow electrolyte to flow through the passages formed by the openings in the conductive core.

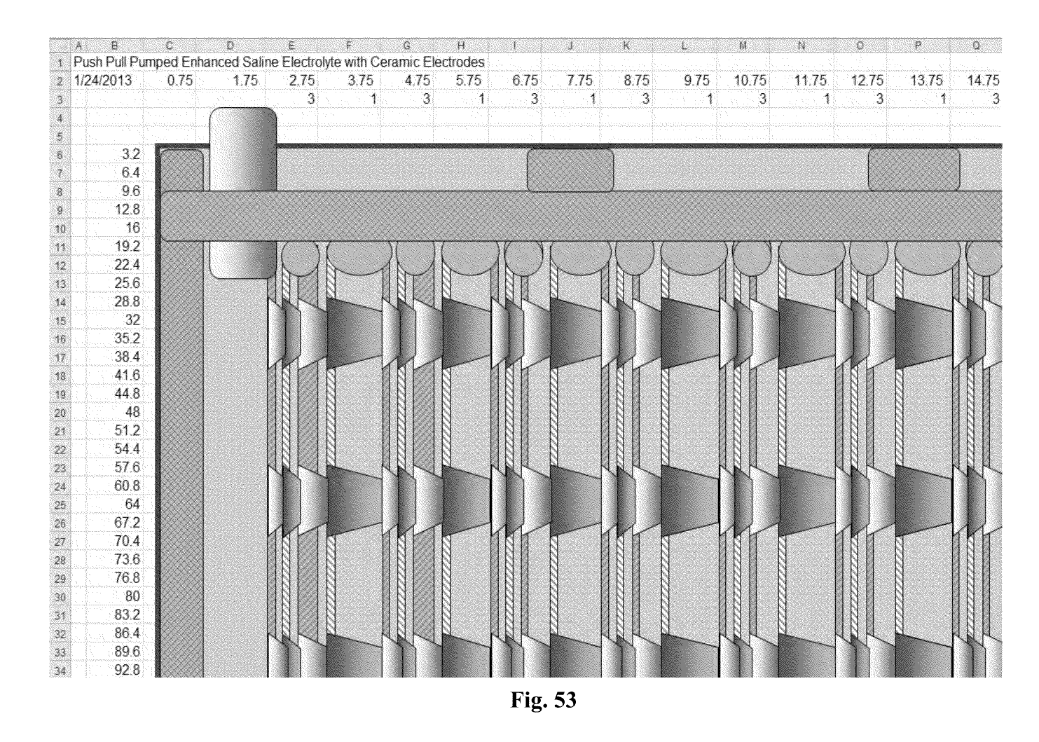

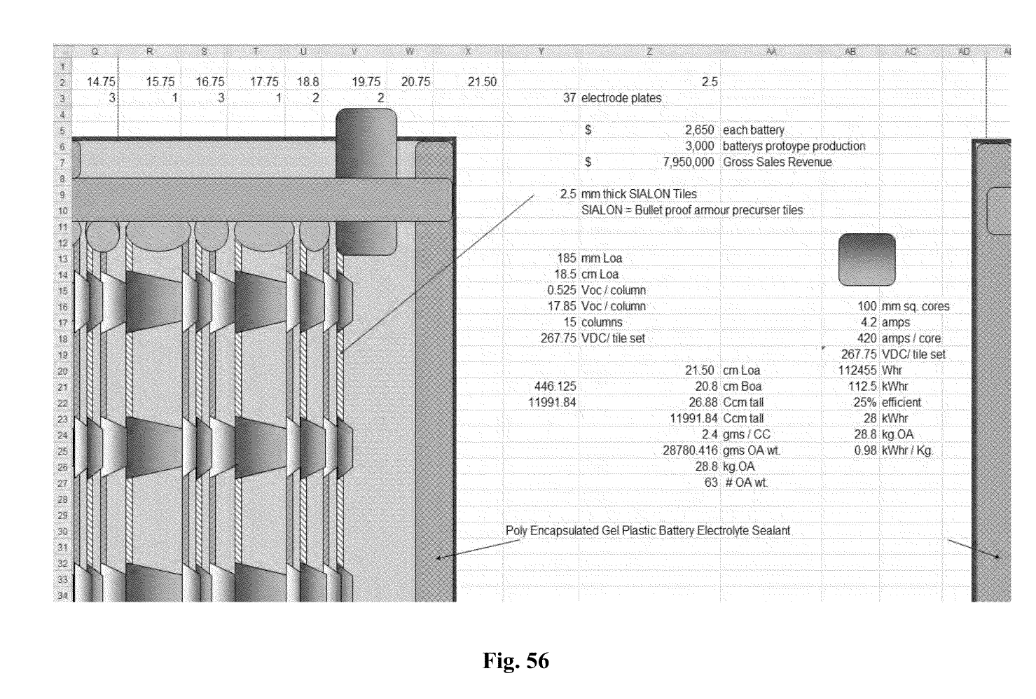

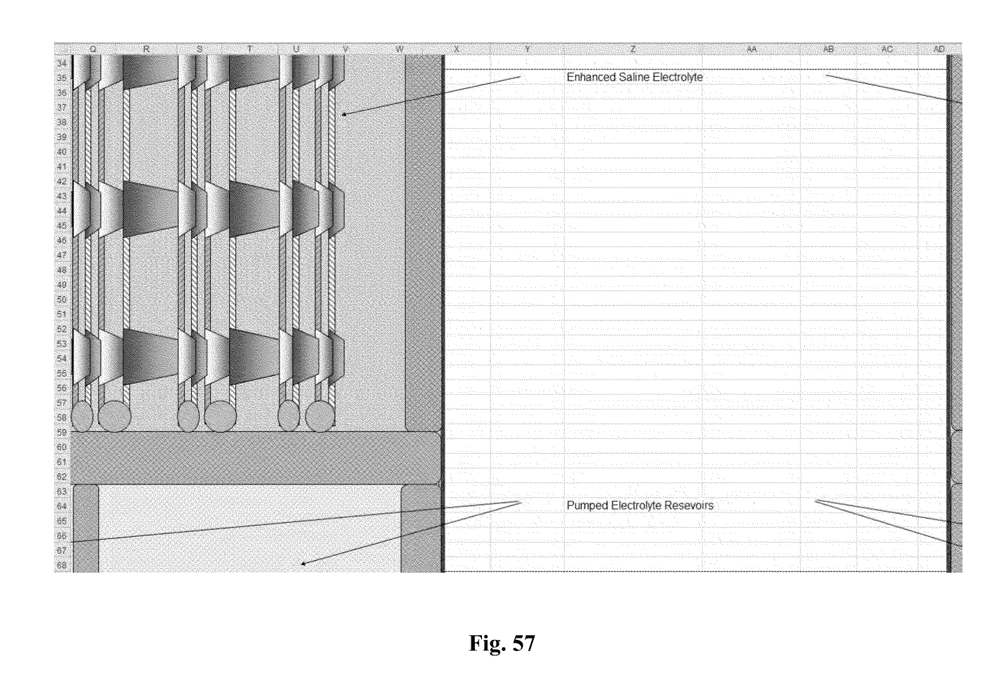

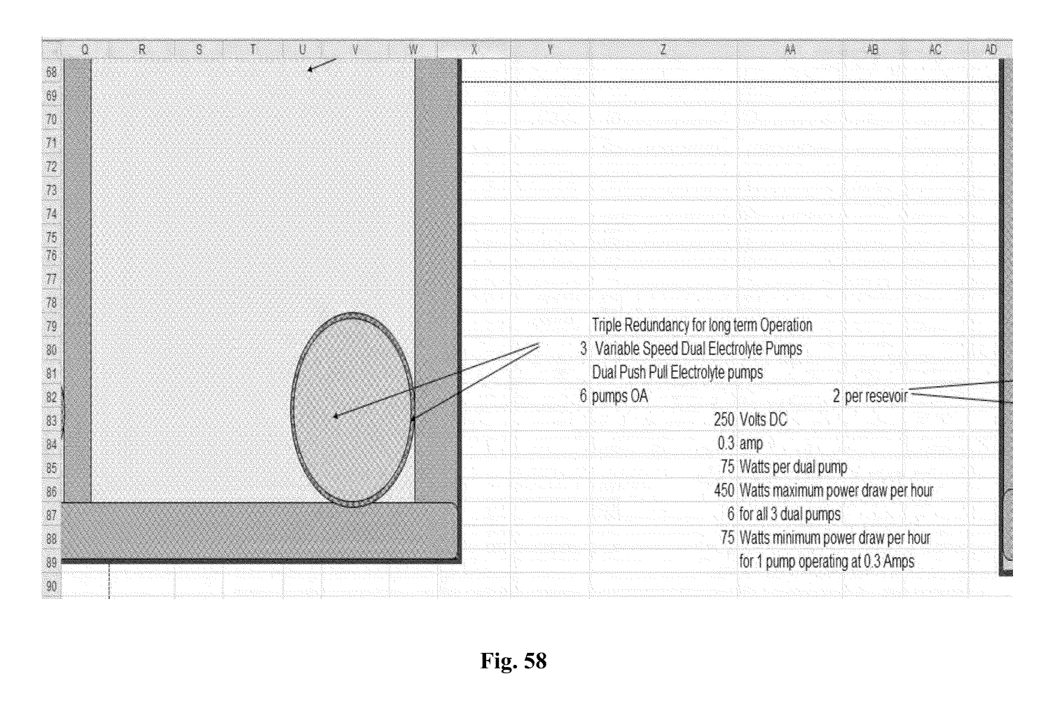

FIG. 53 is a section view of the electrode illustrated in FIG. 51. The section view pictorially illustrates a perimeter tensioning ring that helps create faster production through input and fewer losses overall for the operation of the electrode. The cathode may include a parabolic-shaped electrode that stamped and blanked from a conductive ceramic material. The conductive core may include openings stamped through to allow electrolyte to flow through the passages formed by the openings in the conductive core. FIG. 56 provides a datastrative representation of one or more properties for an embodiment of Sialon tiles (i.e., silicon-aluminum-oxygen-nitrogen (SiAlON)) ceramics incorporated into the body of the battery along a column or row of the stacked electrode plates for providing protection against case piercing projectiles such as bullets or shrapnel. The casing may include a poly incapsulated gel plastic battery electrolyte sealant for sealing the solution (e.g. electrolytic solution) within the battery housing or casing. One or more pumped electrolyte reservoirs may also be included for supplying electrolyte to the main body of the battery as shown in FIG. 57. As illustrated pictorially in FIG. 58, a pump may be included in one of the reservoirs for pumping electrolytic fluid to the battery, for example, for recirculating the electrolytic fluid from the reservoir to the battery whereby a fresh batch of electrolytic solution is circulated to the battery simultaneously or in batches or in desired volumes and at a desired rate. The pump may include a triple redundancy configured pump such as a variable speed dual electrolyte pump or a dual push pull electrolyte pump. The battery may be configured with one, two, or two or more reservoirs for storing an enhanced saline electrolyte.

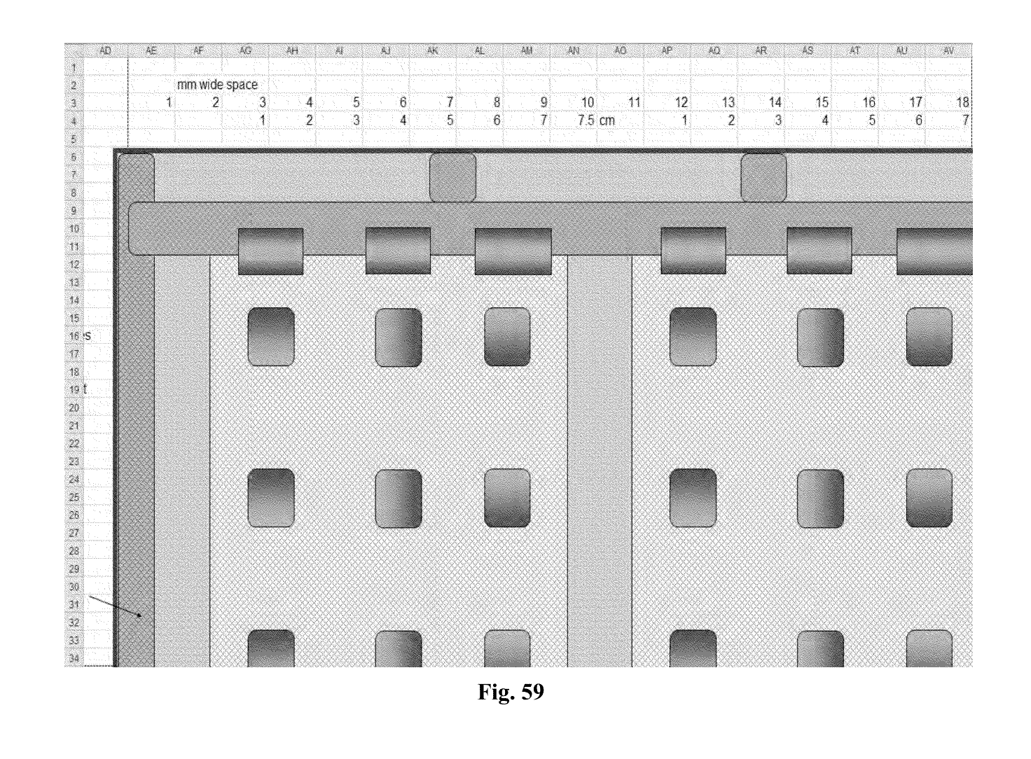

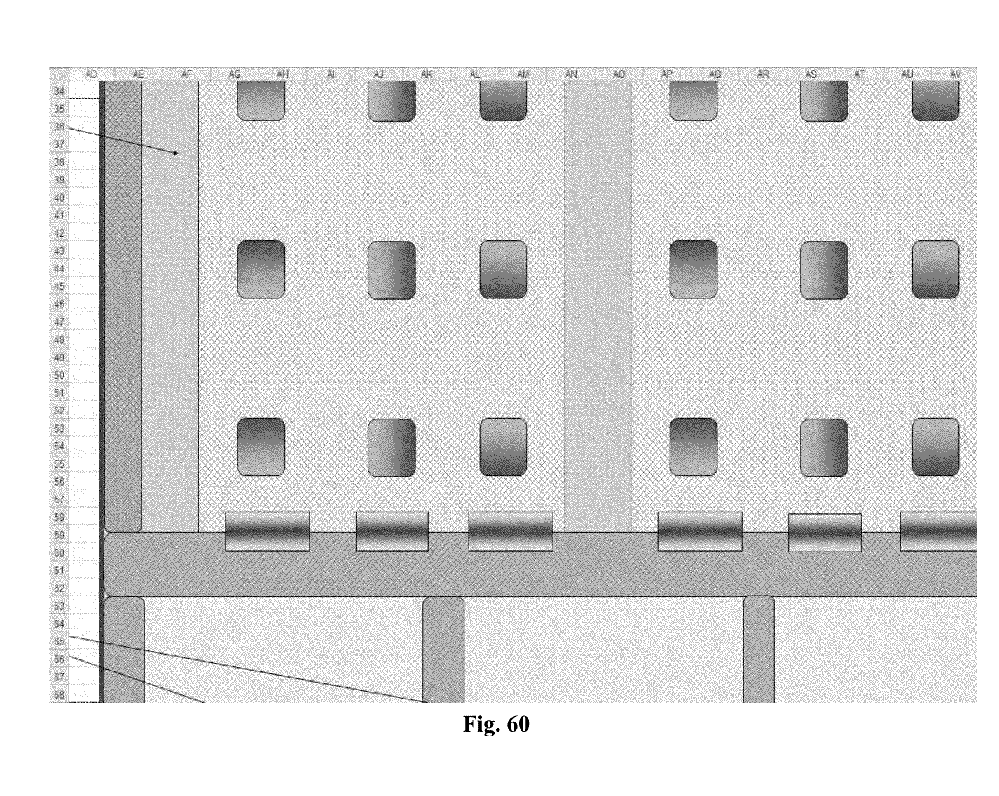

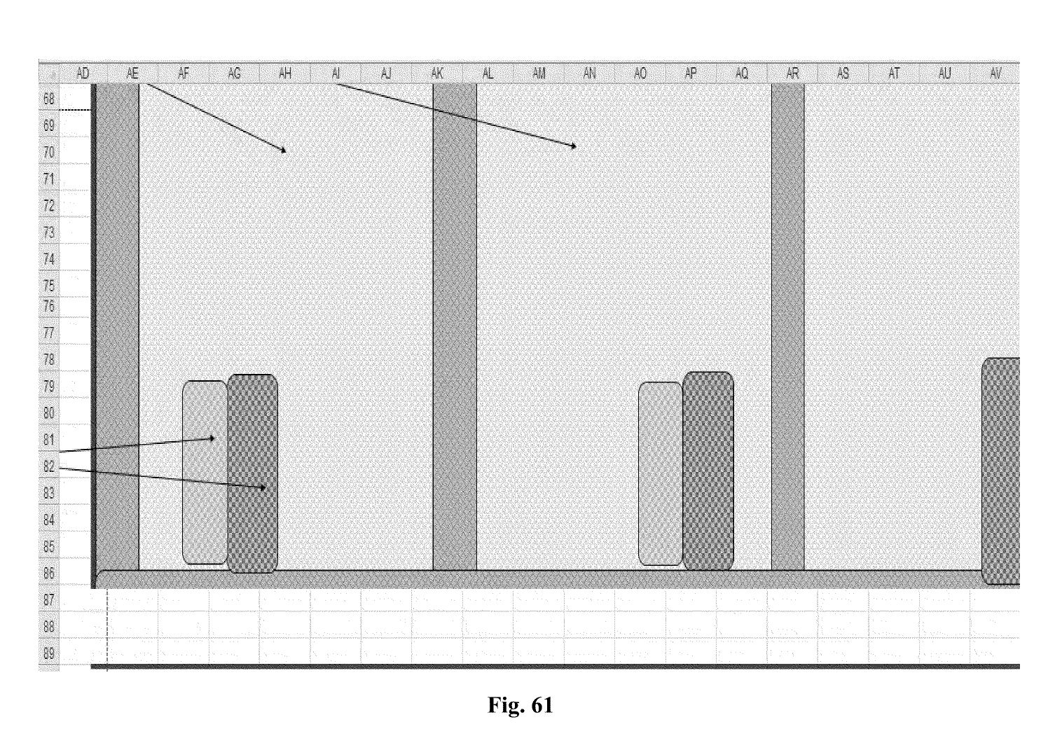

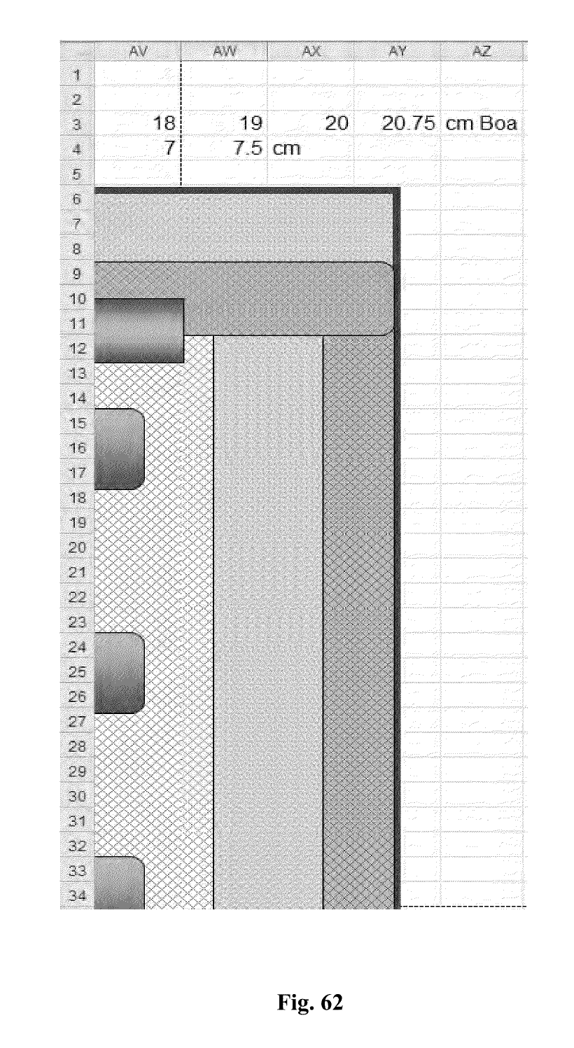

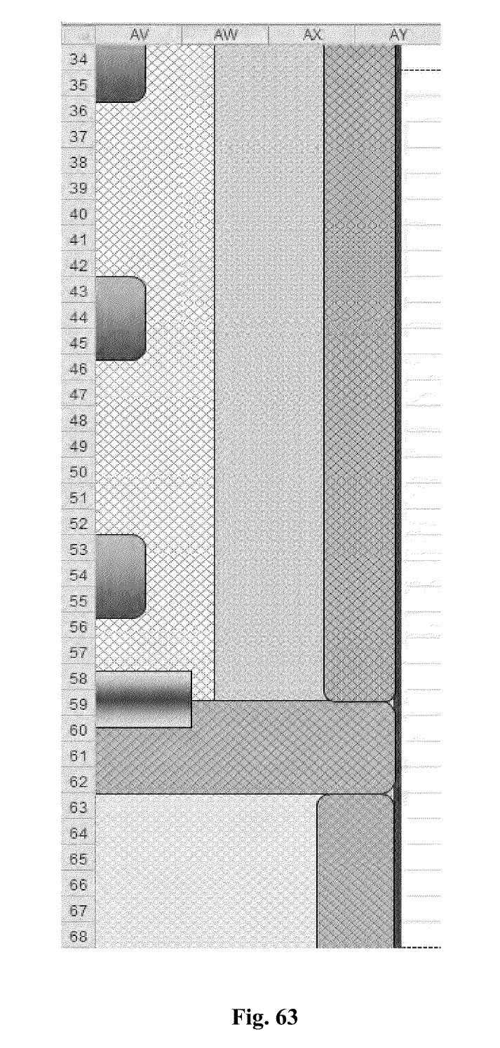

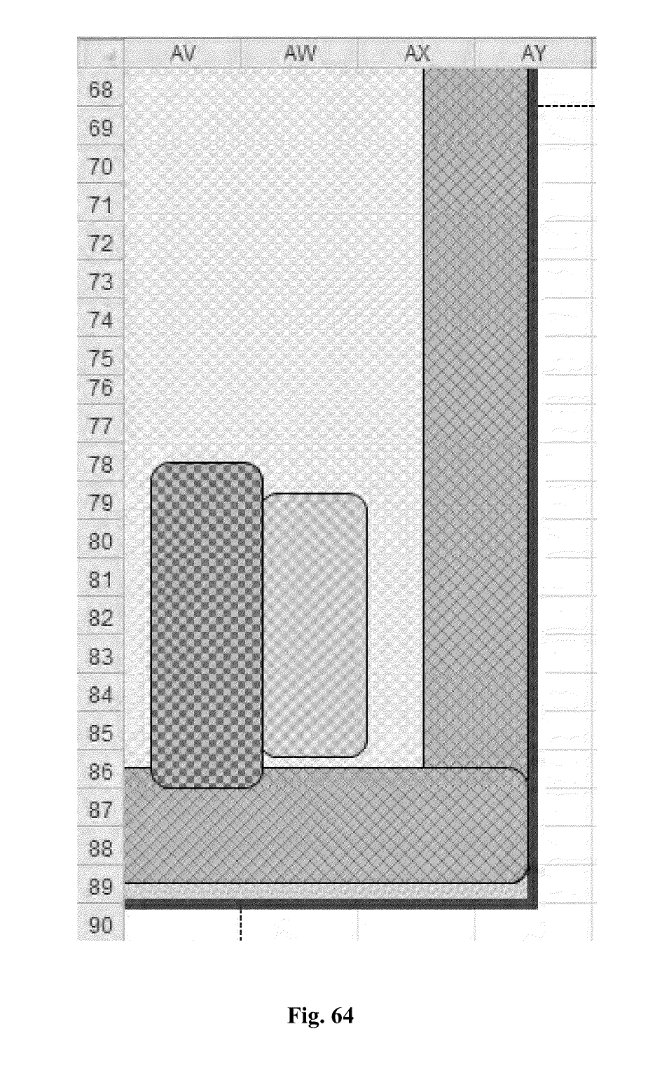

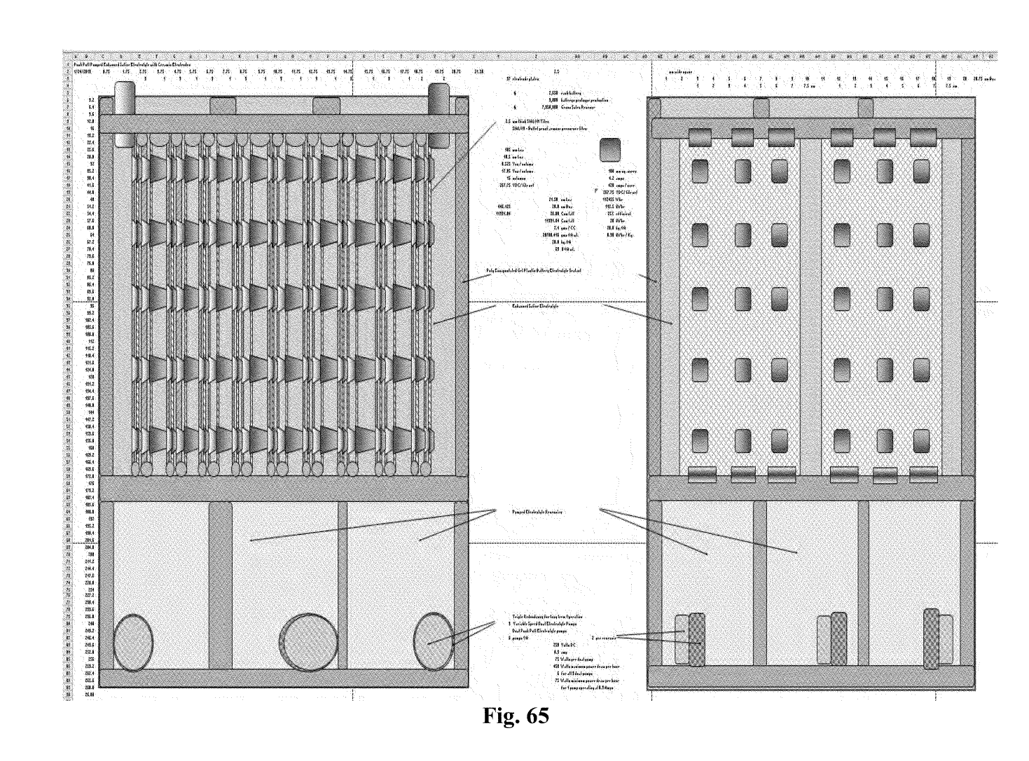

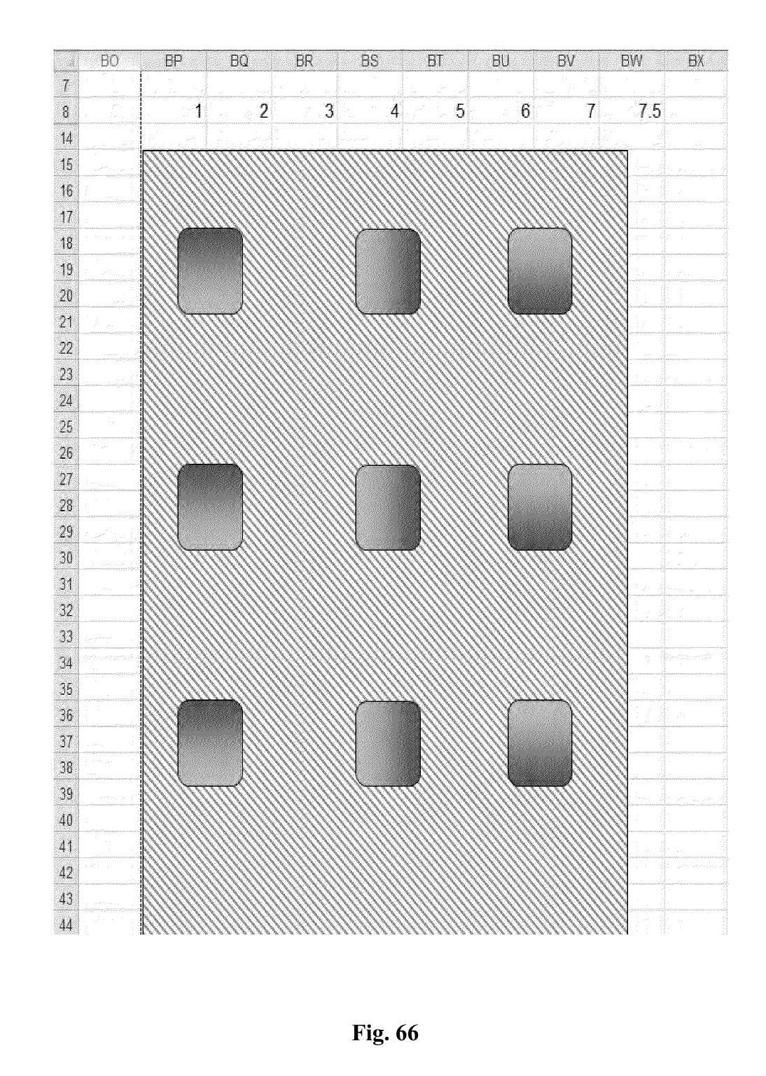

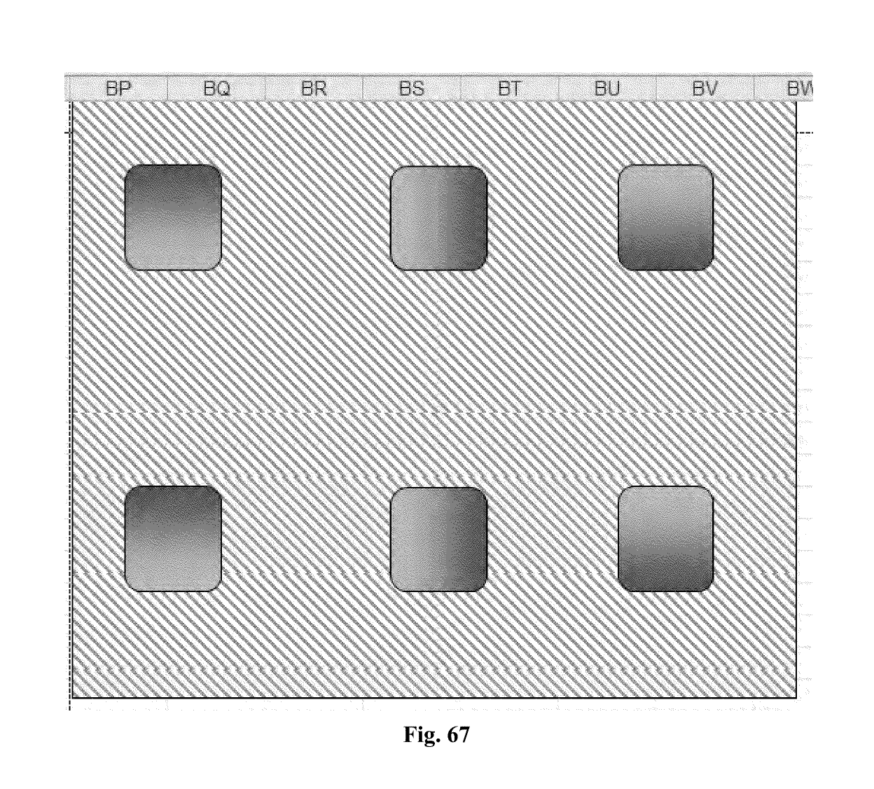

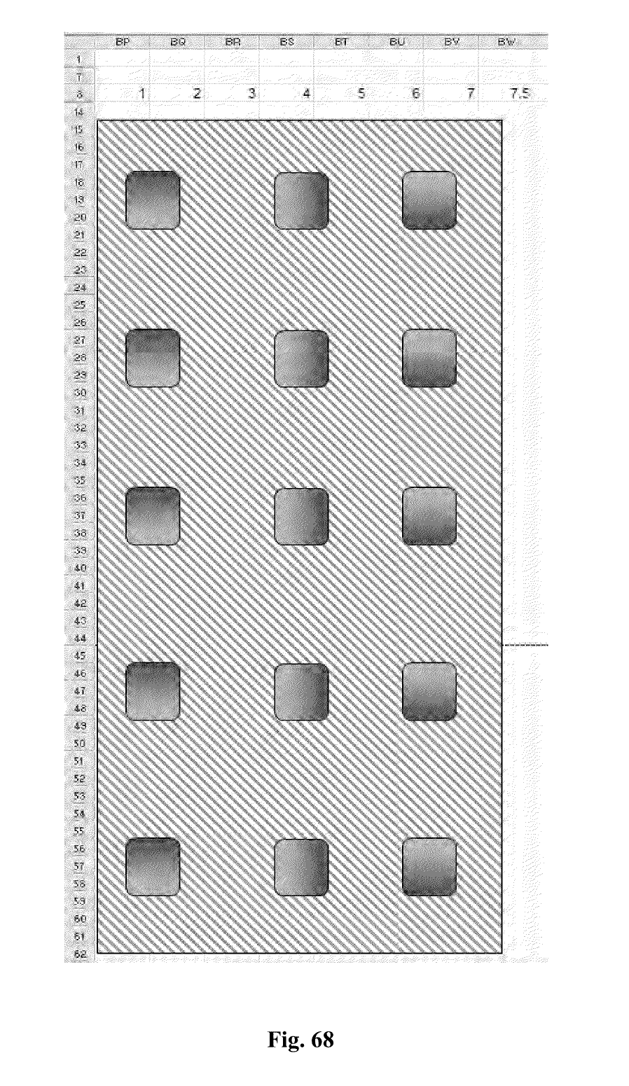

FIGS. 59-64 provide pictorial representations of the configuration of the battery shown on the left hand side of FIG. 65. The battery includes electrode square cores surrounded by an enhanced saline electrolyte. The cores may be housed within a poly encapsulated gel plastic battery electrolyte sealant. One or more sialon tiles may be included along the rows or columns of the square electroplates for providing protection against an object such as a bullet, shrapnel or other high speed colliding mass. The battery also may be configured with one or more reservoirs and a pump for circulating or restoring lost solution to the battery. The reservoirs may also be used to repopulate solution within one or more cavities or cells of the battery housing the electrode blocks. The reservoirs may be used to pump fresh solution to the core of the battery whereby this solution is circulated and recharged within one of the reservoirs and redistributed back to the core of the battery. Further pictorial representations of the square electrodes are provided in FIGS. 66-68. Other configurations are contemplated as discussed and considered in the various constructs of the present invention.

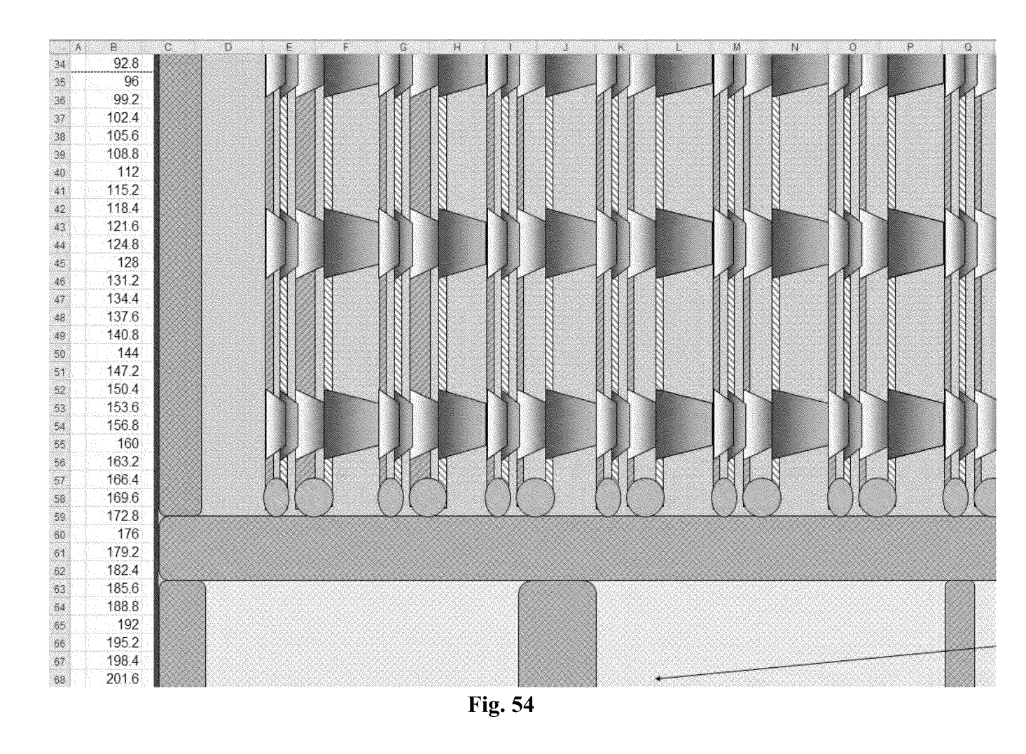

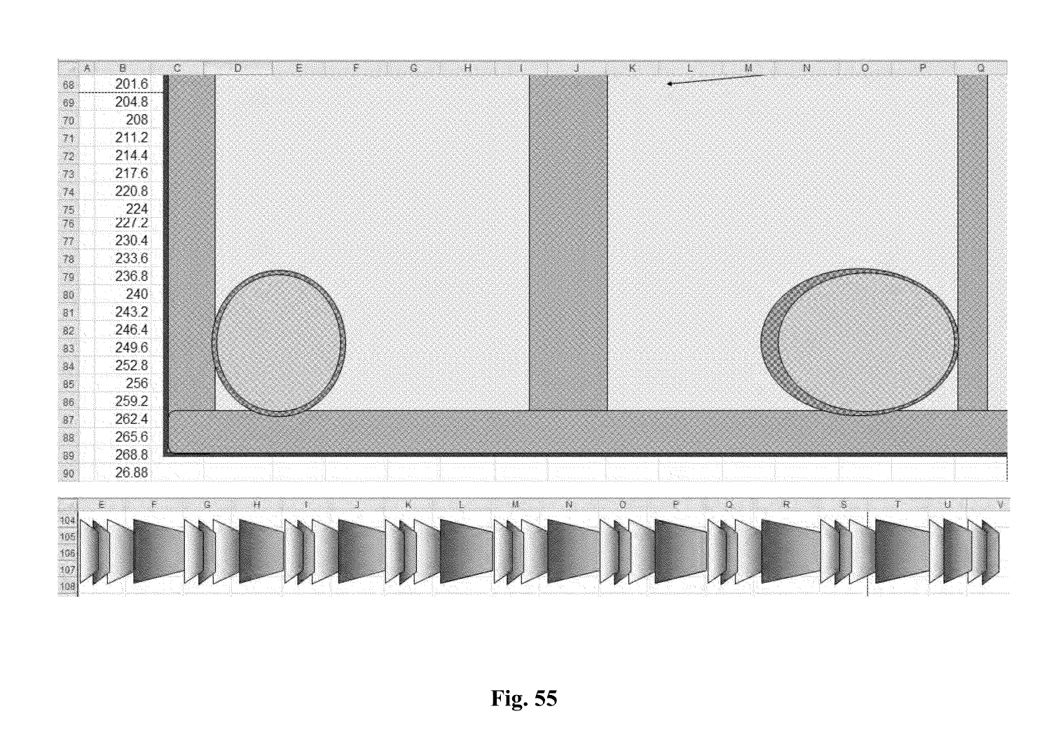

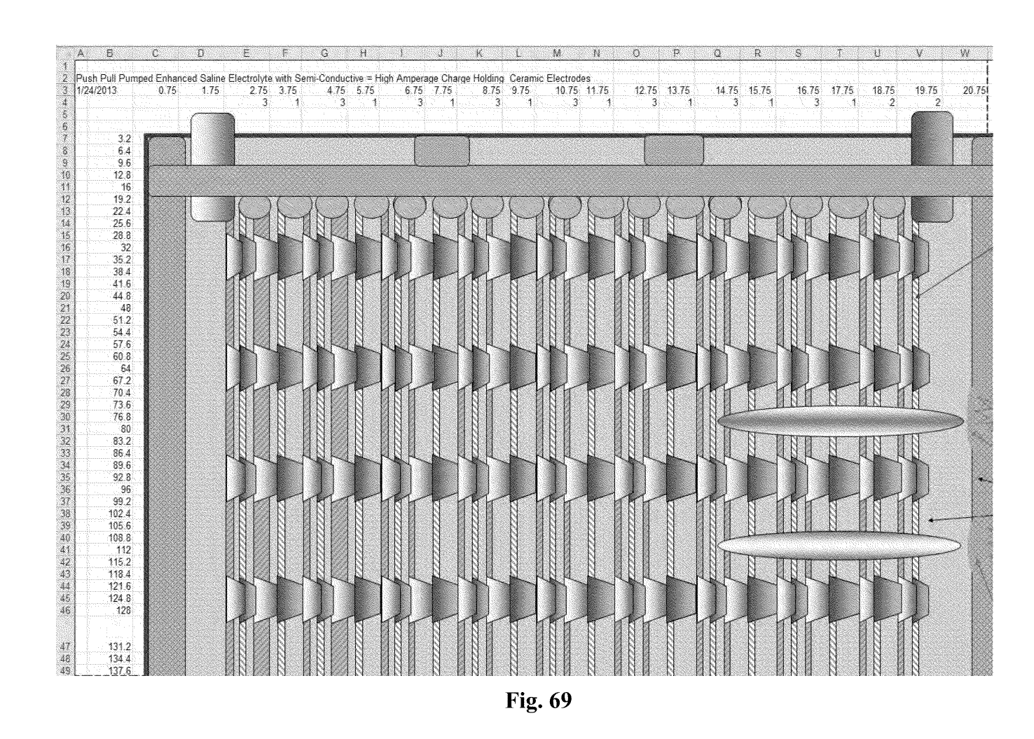

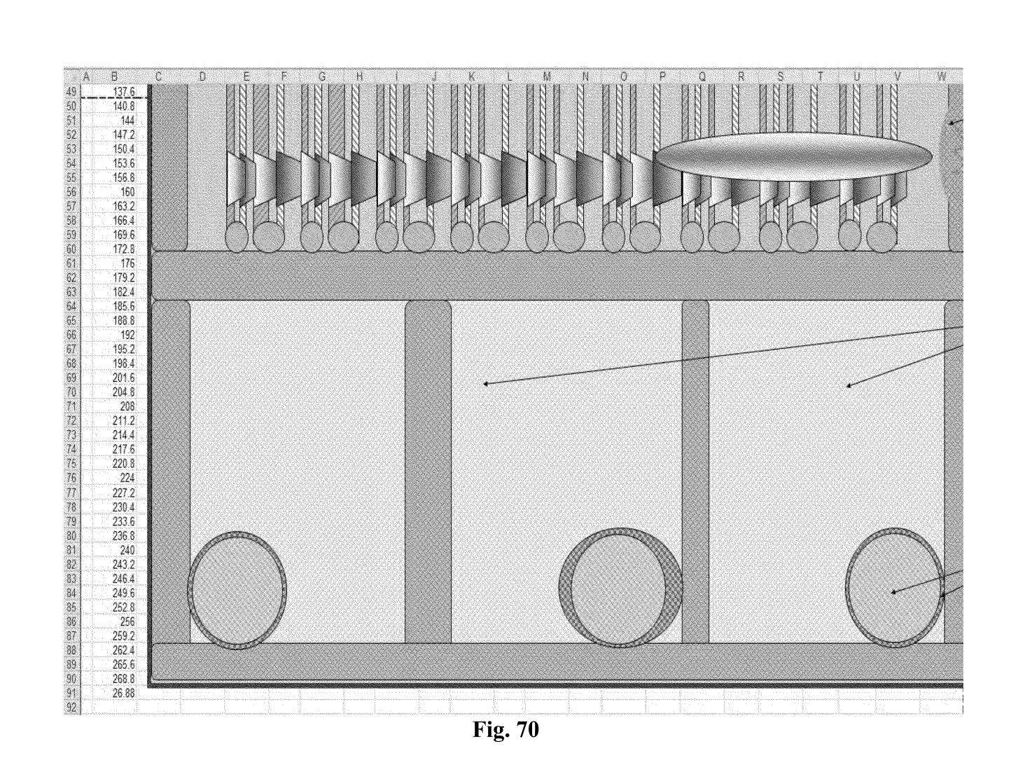

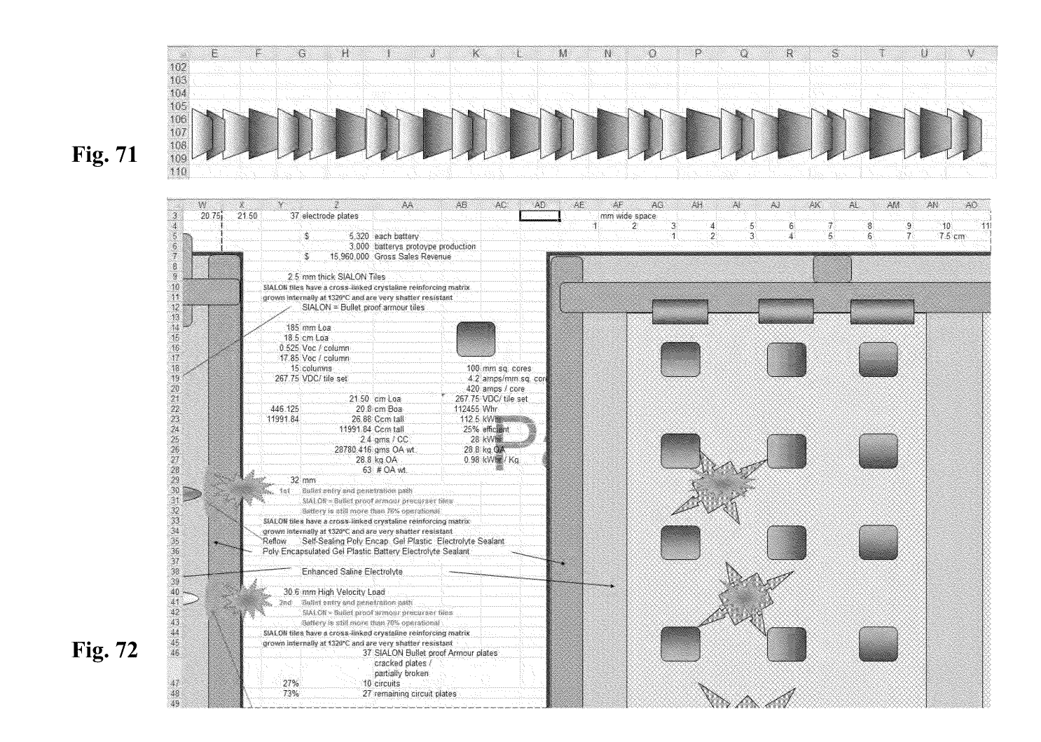

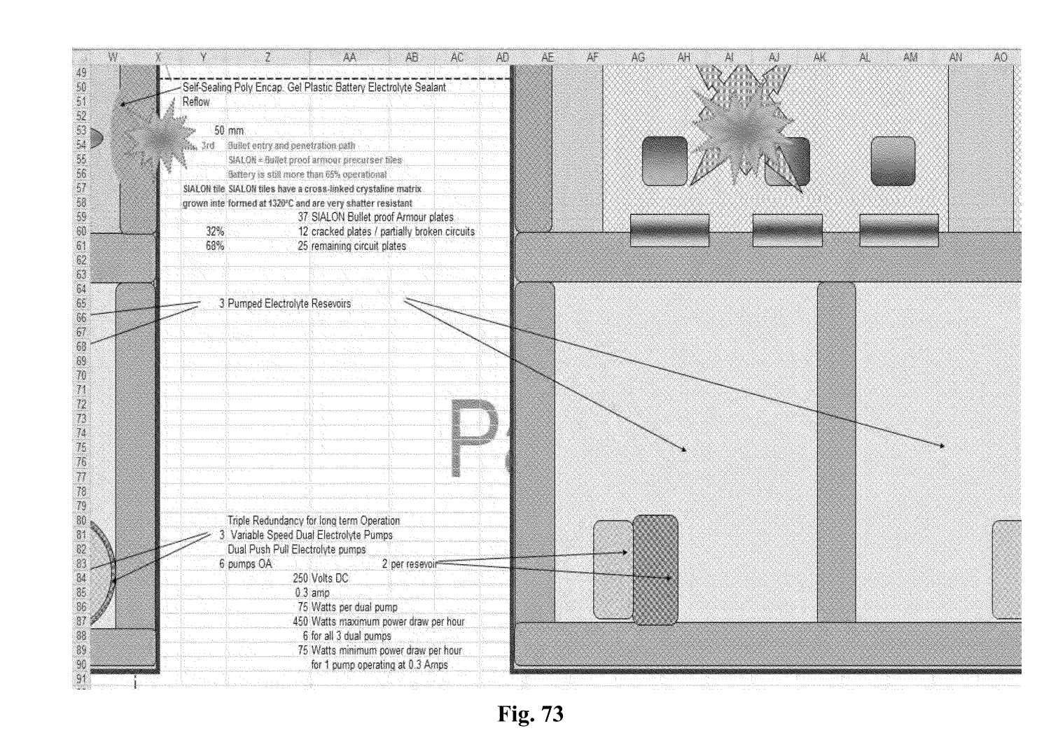

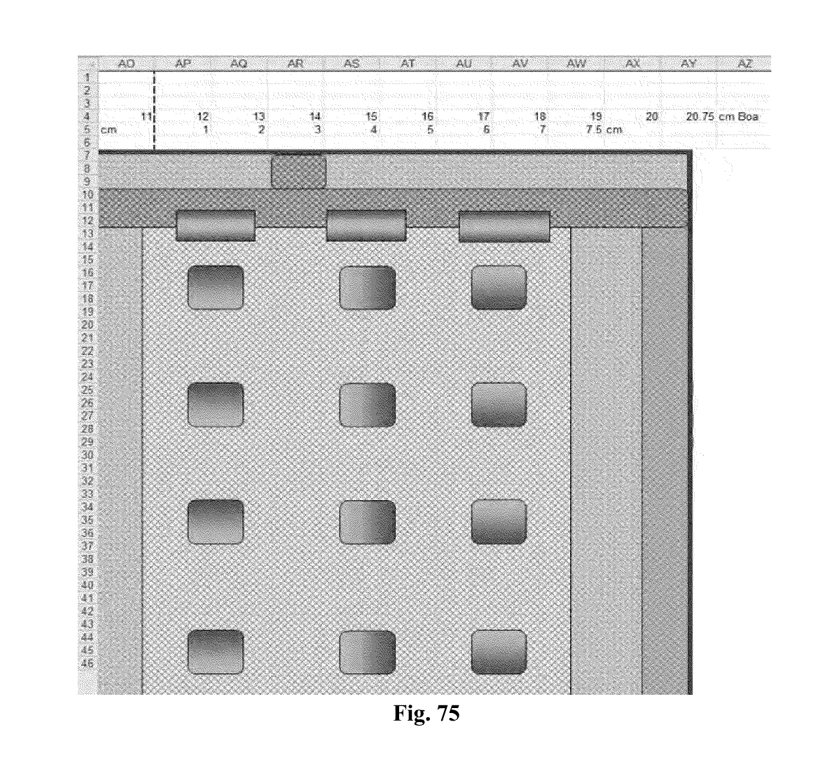

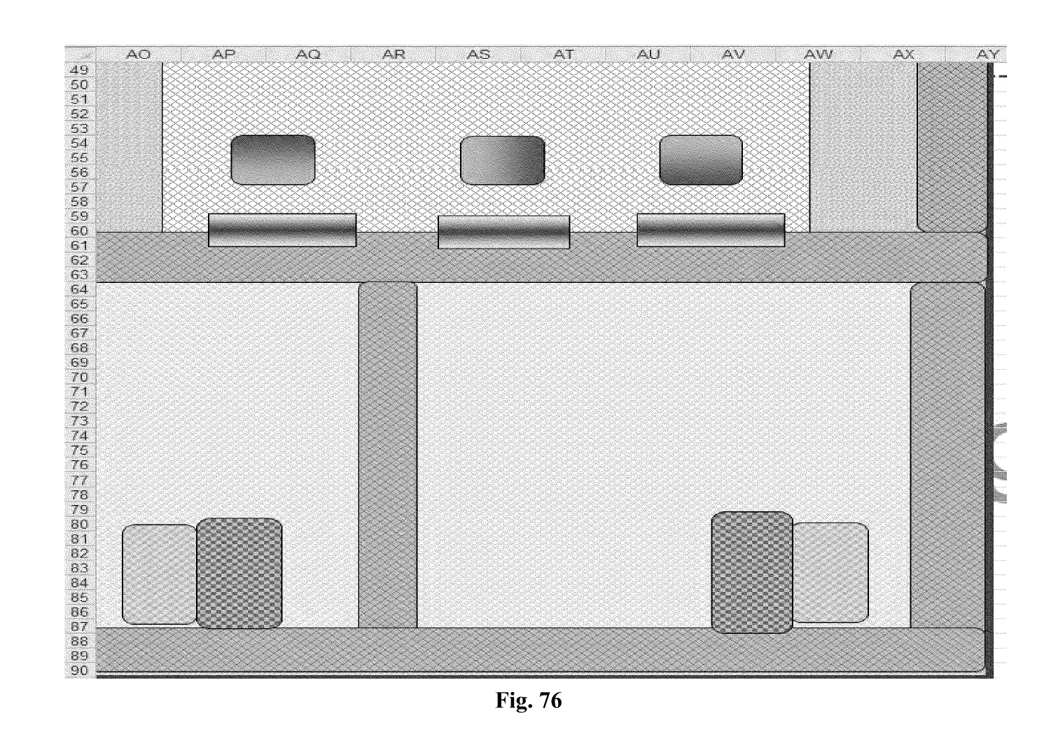

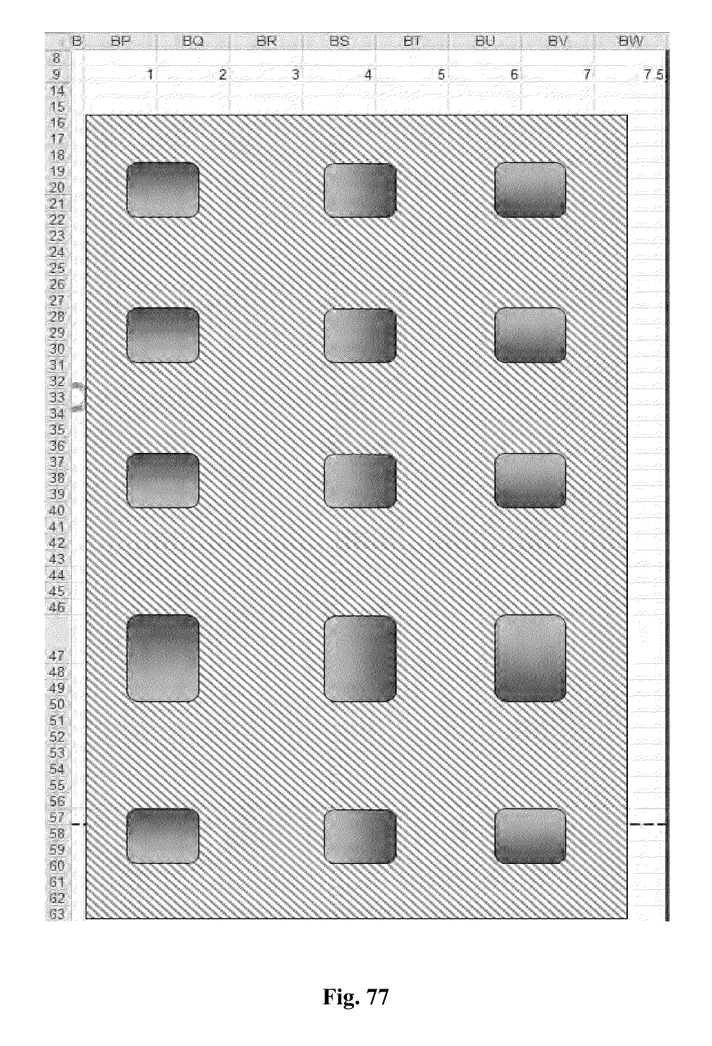

FIGS. 69-78 provide pictorial representations of a battery configured in accordance with an exemplary aspect of the invention. Like the battery illustrated by pictorial representations in FIGS. 53-68, the battery in FIGS. 69-78 includes stacked electrodes configured in rows and columns within housing or core of a battery as best shown in FIG. 69. FIGS. 69 and 70 illustrate pictorially a projectile piercing the wall of the battery and entering into the core where the stacked electrodes are housed. As previously indicated, the battery also includes sialon tiles having cross-linked crystalline reinforcing matrix grown internally at an operating temperature (e.g. 1320° C.) and are generally shatter resistant, acting like bulletproof armor tiles. Upon potential interruption of the operation of the battery by a projectile traveling along a bullet entry and penetration path, the battery still may be at least 75% operational. This is accomplished as the battery is encased in a self-sealing poly encapsulated gel plastic electrolyte sealant that flows freely to the breach and seals the breach for preventing failure of the battery. These batteries, as shown in FIG. 73 and represented by datastrative embodiments, may include one or more reservoirs for providing, such as by pumping, electrolyte to the core of the battery upon breach. Thus, the breach is repaired by this self-sealing poly encapsulated gel plastic battery electrolyte sealant reflow and the lost solution is replaced from one or more of the reservoirs using a pump as previously discussed.

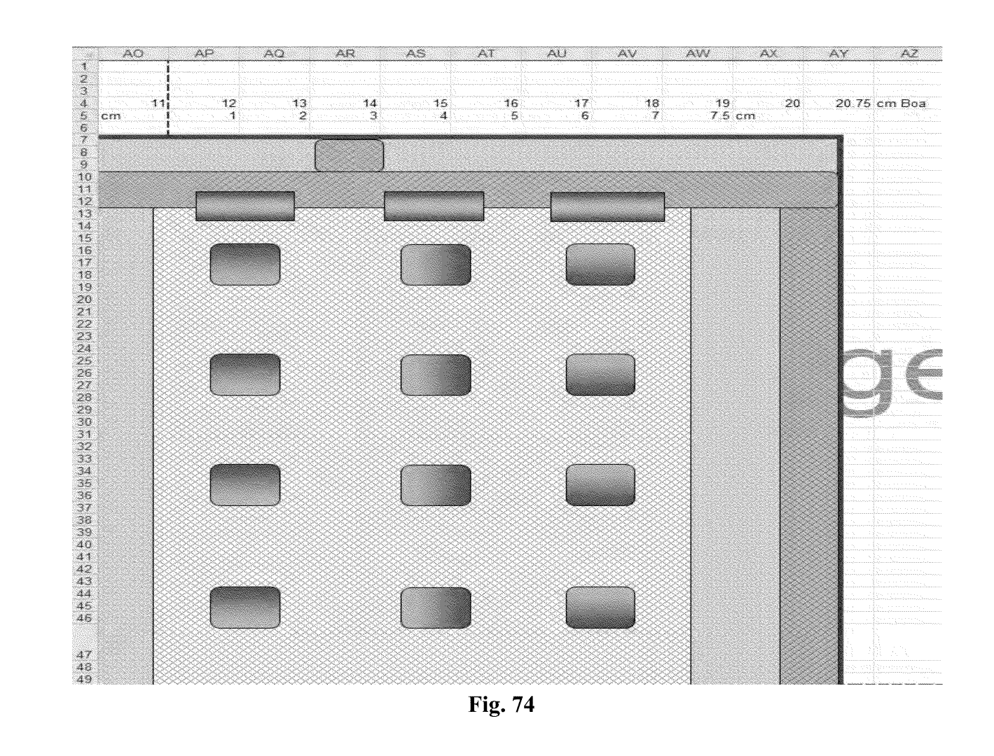

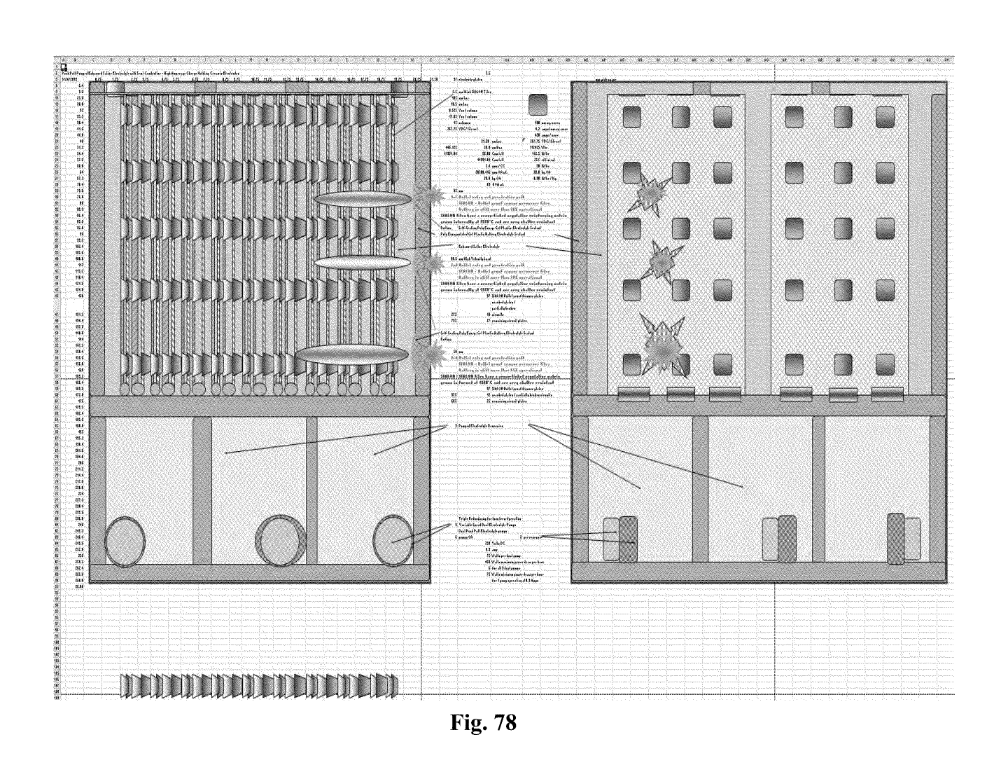

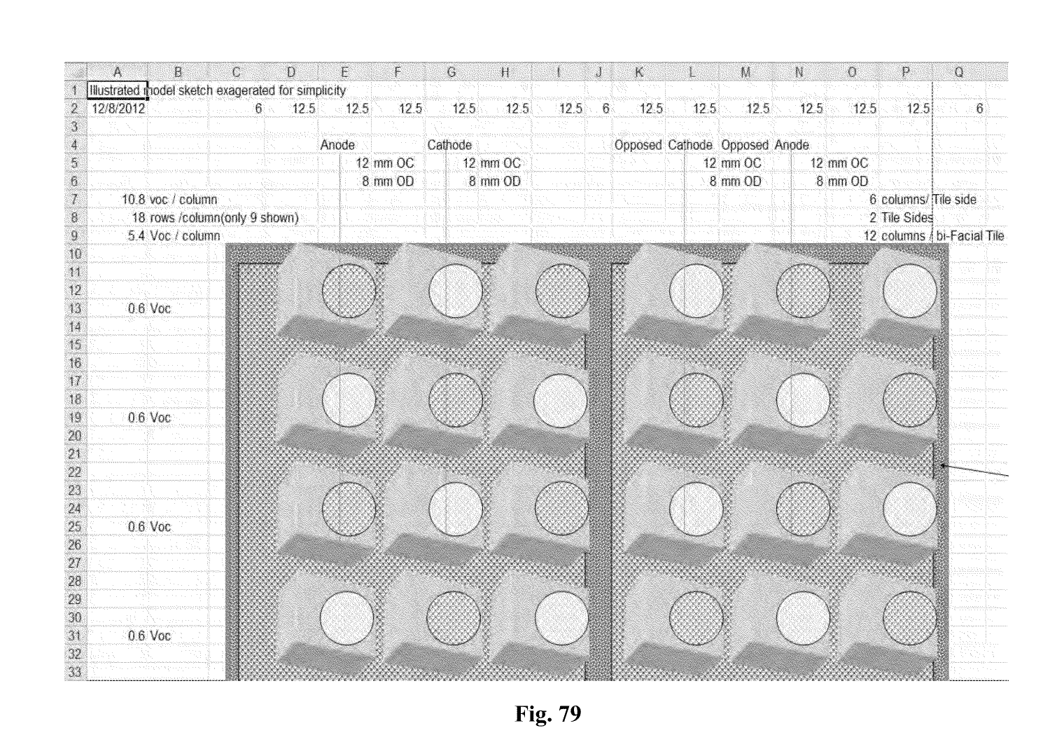

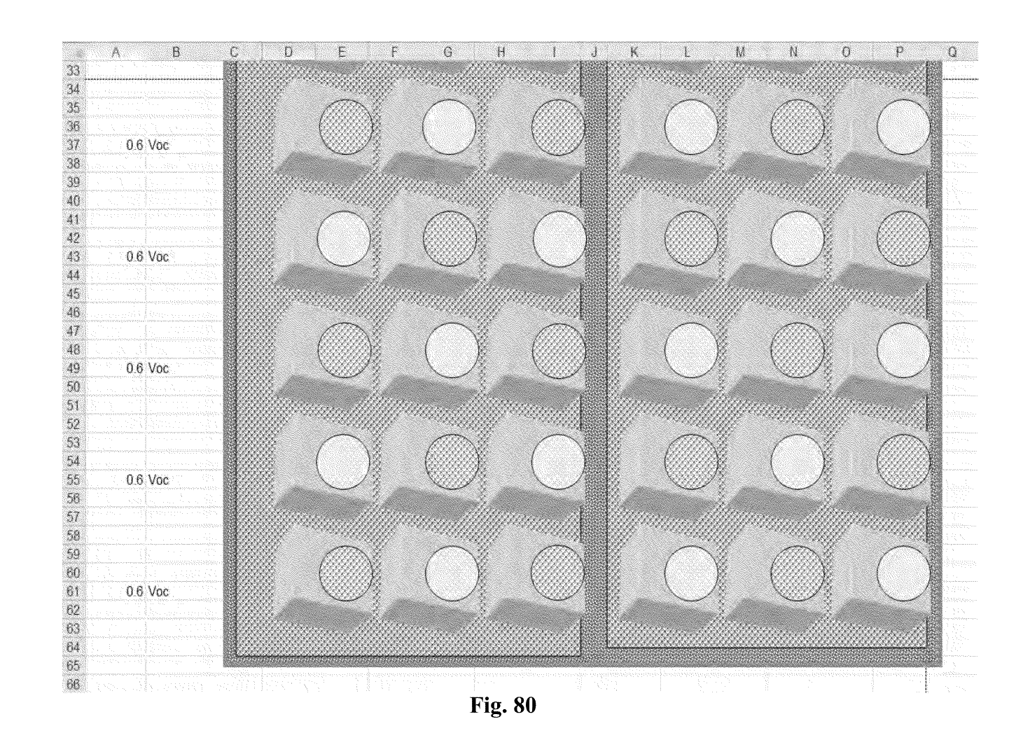

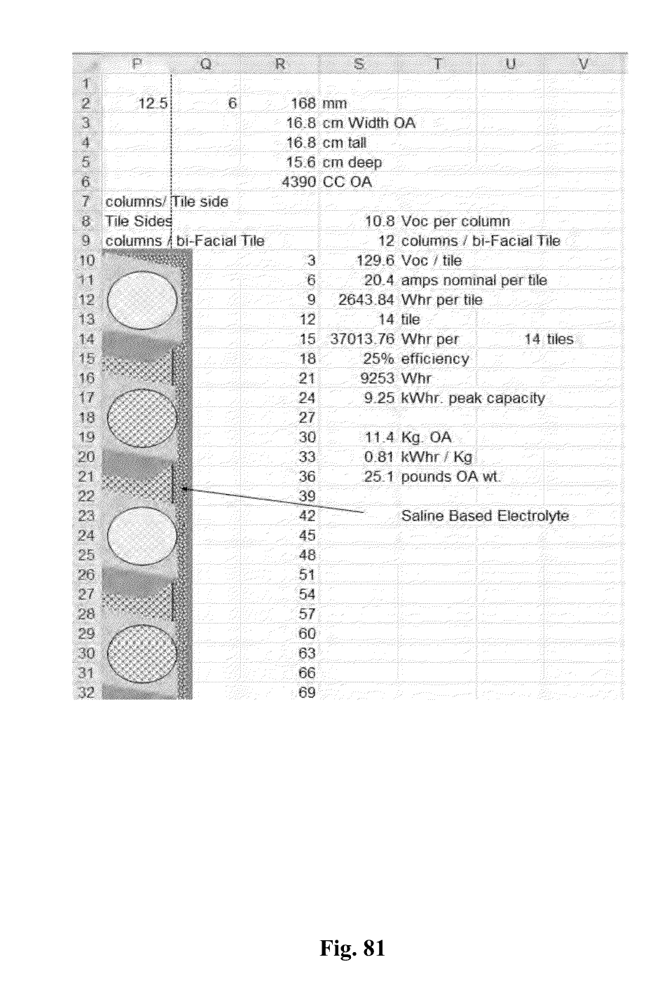

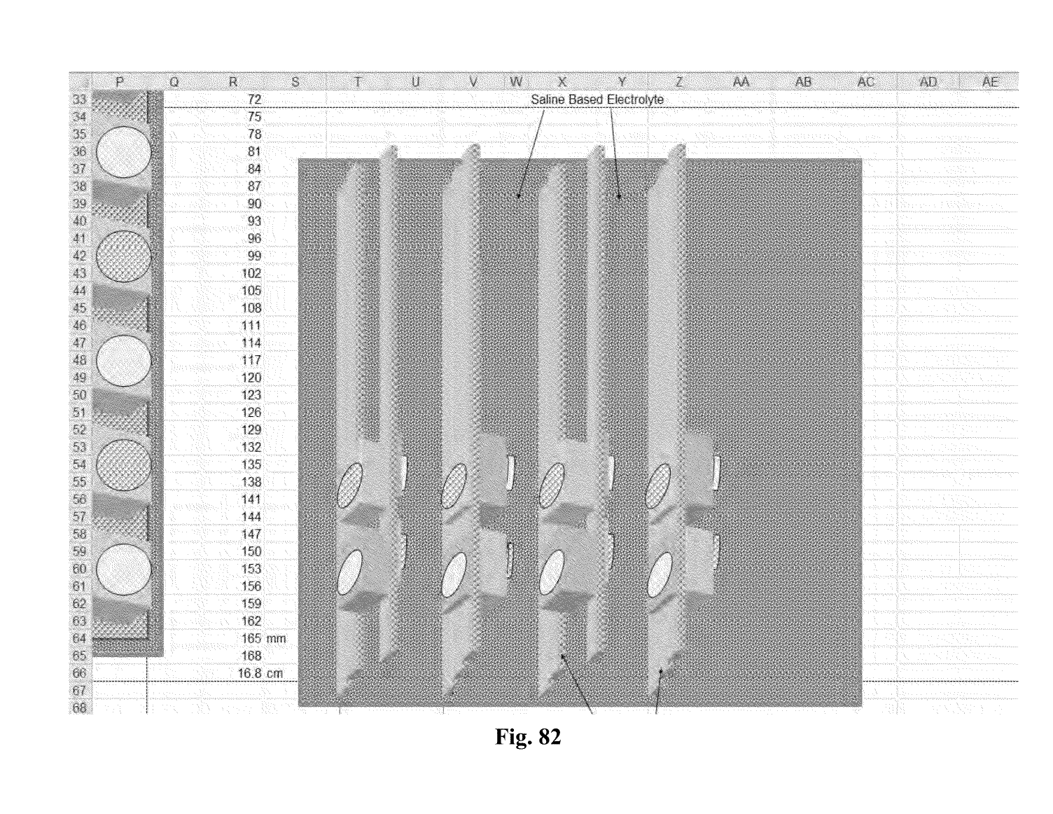

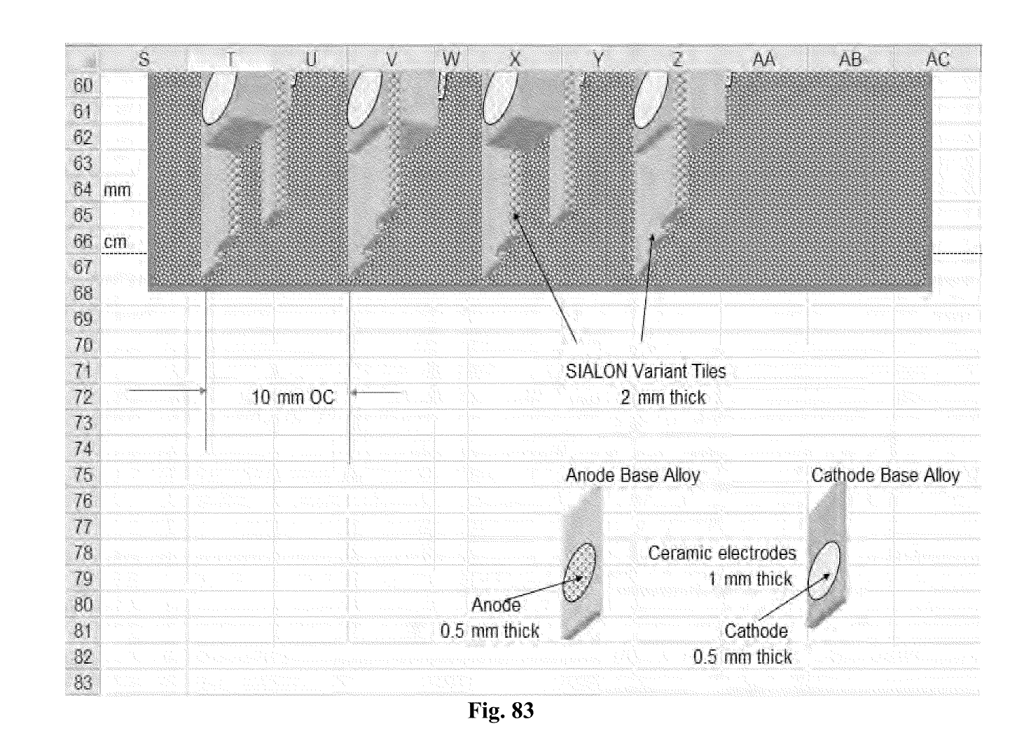

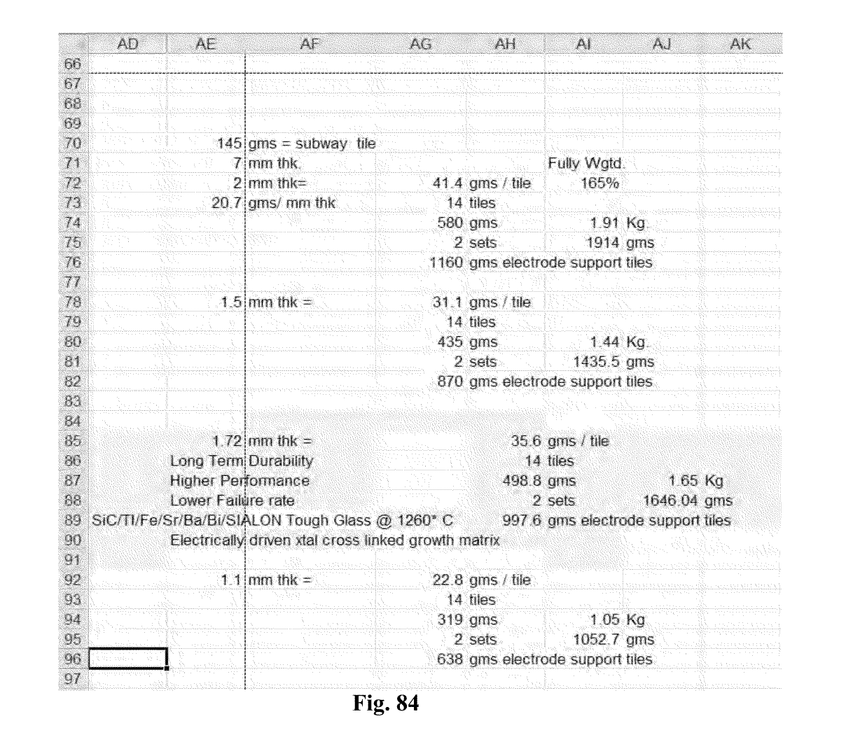

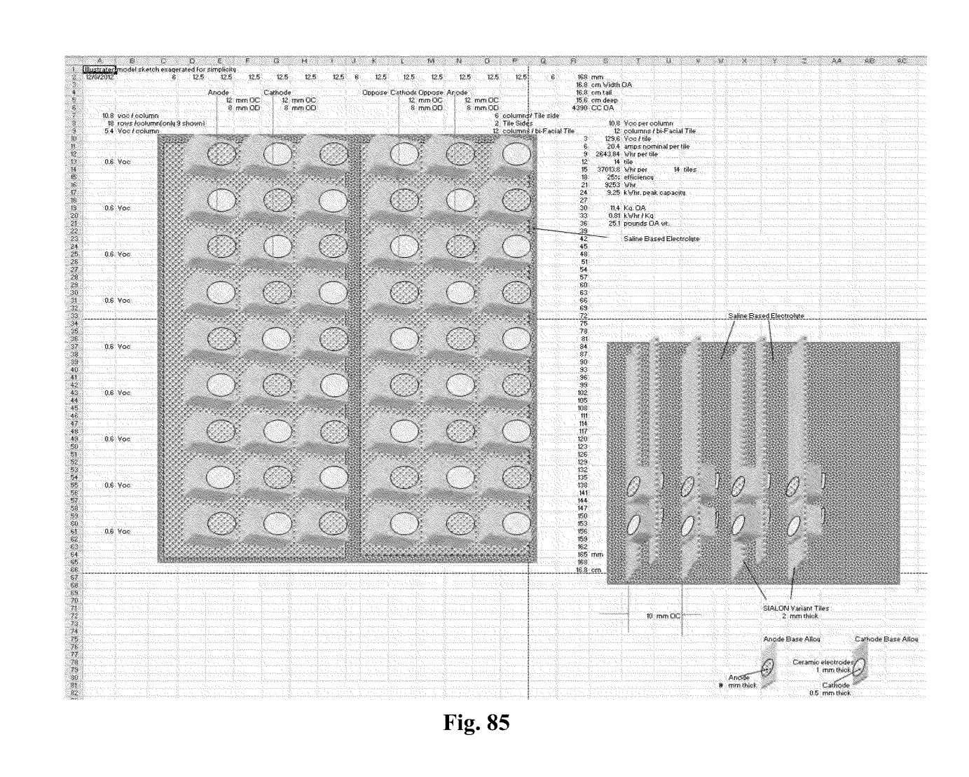

FIGS. 74-77 provide pictorial representations of square electrode blocks housed within the core of the battery according to one embodiment of the invention. FIG. 78 provides pictorial representations of a battery configured according to an exemplary aspect of the invention and provided by snippets in FIGS. 69-77. FIGS. 79-85 are pictorial representations of a battery configuration in accordance with both illustrative and datastrative embodiments of the invention. Pictorial representations are provided in these figures showing configurations of anode and cathode arrays and opposed anode in the cathode arrays. The anode and cathode arrays are housed within the core of the battery and submersed in a sealant based electrolyte. Datastrative properties according to an embodiment of the electrode tiles are provided in FIG. 81. Spacing and configuration of the columns of anode and cathode arrays and opposed cathode and opposed anode arrays are best illustrated in FIG. 82. These arrays may be arranged in column or row formation and submersed in saline based electrolyte as illustrated pictorially. The sialon tile arrays may be printed using a sialon printing technology known in the art. The anode and cathode tile arrays and opposed cathode and opposed anode tile arrays may be configured in rows and columns using one or more sialon variant tiles. An anode based alloy and a cathode based alloy may be included in the respective arrays as best illustrated in FIG. 83. Datastrative representations of the printed sialon tile electrodes are provided in FIG. 84. One or more parameters for the sialon tile electrode columns are provided indicative of performance of a configuration of the tiles according to an embodiment of the present invention. FIG. 85 provides an overview pictorial representation of the anode and cathode printed sialon tiles arranged within the core of a battery and submersed in a saline based electrolyte on saline variant tiles as illustrated.

Embodiments of the present invention have been set forth in the drawings and the specification and although specific terms are employed, these are used in the generically descriptive sense only and are not used for the purpose of limitation. Changes in the form proportion of parts as well as substitution of equivalents are contemplated as circumstances may suggest or are rendered expedient without departing from the spirit or scope of the invention as further defined in the following claims.

What is claimed is:

1. A saline battery, comprising:
a base structure having electrode alloys;
an inter-connective matrix formed between the electrode alloys;
a cathode side and an anode side integrated within the base structure to exhibit a voltage pyramid;
a high amperage output configured to have a low gain in resistance and to have a minimized loss across the inter-connective matrix between the electrode alloys to provide a synergistic gain in excess of entropic losses.

2. The battery of claim 1 further comprising an electrolyte occupying spaces within the inter-connective matrix.

3. The battery of claim 2 wherein the electrolyte comprises a saline solution containing a constituent selected from an amount of potassium hydroxide.

4. The battery of claim 2 wherein the electrolyte comprises an enhanced sea water solution.

5. The battery of claim 1 wherein the base structure comprises a containment system configured of recycled polycarbonate.

6. The battery of claim 1 wherein the electrode alloy comprises a non-corrosive, semi-conductive, ceramic alloy-based electrode.

7. The battery of claim 1 wherein the anode comprises a composition of porous ceramic alloy selected from a group comprising Ca, Ba, Bi, Al, Si, and S plus a modifier alloy.

8. The battery of claim 1 wherein the anode comprises a conductive carbon coated with a constituent selected from Ti, Fe, and S, and a barrier layer comprising Na₂O₃.

9. The battery of claim 1 wherein the cathode comprises a conductive carbon coated with a constituent selected from Ti, Fe and P, and a barrier layer comprising Na₂O₃.

10. The battery of claim 1 wherein the electrode alloys comprise an inkjet-printed electrode composition on a substrate comprising a SIALON tile.

11. A method of fabricating a saline battery, comprising:
providing a base structure having electrode alloys;
forming an inter-connective matrix between the electrode alloys;
integrating a cathode side and an anode side within the base structure to exhibit a voltage pyramid;
configuring a high amperage output to have a low gain in resistance and to have a minimized loss across the inter-connective matrix between the electrode alloys to provide a synergistic gain in excess of entropic losses.

12. The method of claim 11 further comprising filling unoccupied space within the inter-connective matrix with an electrolyte.

13. The method of claim 12 further comprising enhancing the electrolyte with a constituent selected from an amount of potassium hydroxide.

14. The method of claim 11 further comprising forming the electrode alloy out of a non-corrosive, semi-conductive, ceramic alloy-based electrode

15. The method of claim 11 further comprising preparing the anode from a composition of porous ceramic alloy selected from a group comprising Ca, Ba, Bi, Al, Si, and S plus a modifier alloy.

16. The method of claim 11 further comprises coating the anode with a conductive carbon having a constituent selected from Ti, Fe, and S with a barrier layer.

17. The method of claim 11 further comprising coating the cathode with a conductive carbon having a constituent selected from Ti, Fe and P with a barrier layer comprising Na₂O₃.

18. The method of claim 11 further comprising inkjet printing the electrode alloys onto a substrate comprising a SIALON tile

19. The method of claim 11 further comprising operating the voltage pyramid at a power to weight density of 792 W·hr/Kg or greater.

20. The method of claim 11 further comprising operating at a capacity to weight structure of 9.25 kW·hr per 11.4 Kg or greater.
